(19) United States
(12) Patent Application Publication
(10) Pub. No.: US 2023/0200405 A1
(43) Pub. Date: Jun. 29, 2023

(54) METHODS FOR ISOLATING ANTIMICROBIAL MICROORGANISMS FROM AGRICULTURAL PRODUCTS AND USES THEREOF

(71) Applicant: Apeel Technology, Inc., Goleta, CA (US)

(72) Inventors: Matthew Kahlscheuer, Goleta, CA (US); Benjamin Gordon, Goleta, CA (US)

(21) Appl. No.: 18/146,199

(22) Filed: Dec. 23, 2022

Related U.S. Application Data
(60) Provisional application No. 63/293,405, filed on Dec. 23, 2021.

(51) Int. Cl. A23B 7/155; A23B 7/16; A23L 3/3517

(52) U.S. Cl. CPC A23B 7/155; A23B 7/16; A23L 3/3517

(57) ABSTRACT

Provided herein are compositions comprising one or more antimicrobial microorganism and methods of use thereof for inhibiting spoilage of agricultural products.

### CLAIM OF PRIORITY

This application claims the benefit of U.S. Provisional Patent Application No. 63/293,405, filed on Dec. 23, 2021, which is incorporated by reference herein in its entirety.

### SEQUENCE LISTING

This application contains a Sequence Listing that has been submitted electronically as an XML file named 42175-0095001_SL_ST26.xml. The XML file, created on Dec. 22, 2022, is 123,787 bytes in size. The material in the XML file is hereby incorporated by reference in its entirety.

### TECHNICAL FIELD

The present disclosure relates to using antimicrobial microorganisms for inhibiting spoilage of agricultural products.

### BACKGROUND

Many common agricultural products are susceptible to degradation and decomposition, also known as spoilage, when exposed to the environment. Such degradation can occur via biotic stressors, such as bacterial, fungal, or viral infection, and/or pest infestation, or abiotic stressors, such as evaporative moisture loss from an external surface of the products to the atmosphere.

Conventional approaches to prevent degradation, maintain quality, and increase the life of agricultural products include special packaging and/or refrigeration. These approaches can be expensive and may require active management. There exists a need for new approaches to prevent degradation, maintain quality, and increase the shelf life of agricultural products. Such approaches may require, for example, edible barrier coatings or coatings with antimicrobial properties. Edible barrier coatings on agricultural products can, for example, shield the products from threats such as fungi, bacteria, viruses, and the like, and can prevent water loss from the products and/or oxidation of the products. Altering compositions to better inhibit microbial growth while limiting water loss would be beneficial, but it can be challenging to find compatible solutions that perform both functions.

### SUMMARY

This document is based, at least in part, on the discovery that antimicrobial microorganisms can be applied to agricultural products (e.g., fruits and/or vegetables) to prevent, inhibit, slow, or delay growth of biotic stressors such as fungi (e.g., mold), bacteria, or other microorganisms that cause food spoilage or decay. Agricultural products can be coated with one or more antimicrobial microorganisms (e.g., one or more antifungal microorganisms), one or more lysed antimicrobial microorganisms, and/or conditioned media or supernatants of one or more antimicrobial microorganisms. Antimicrobial microorganisms can be combined with one or more fatty acid derivatives (e.g., one or more fatty acids, fatty acid esters, or a combination thereof and one or more fatty acid salts) in a composition that can be used as an edible barrier coating. Applying such coatings can, for example, extend the shelf life, delay ripening, prevent moisture loss or oxygen diffusion (which leads to oxidation), and prevent or limit surface scratching or damage of agricultural products.

Provided herein are compositions including a) a plurality of antimicrobial microorganisms, or conditioned media of a plurality of cultured antimicrobial microorganisms; and b) one or more fatty acid derivatives.

In some embodiments, the one or more fatty acid derivatives comprise one or more fatty acids, fatty acid esters, or a combination thereof and one or more fatty acid salts. In some embodiments, the composition comprises from about 60% to about 99.99% by weight of the one or more fatty acids, fatty acid esters, or a combination thereof. In some embodiments, the composition comprises from about 0.01% to about 40% by weight of the one or more fatty acid salts. In some embodiments, the composition comprises from about 60% to about 99.99% by weight of one fatty acid or fatty acid ester; and from about 0.01% to about 40% by weight of one fatty acid salt. In some embodiments, the composition comprises from about 60% to about 99.99% by weight of two fatty acids, fatty acid esters, or a combination thereof; and from about 0.01% to about 40% by weight of one fatty acid salt. In some embodiments, the composition comprises from about 60% to about 99.99% by weight of one fatty acid or fatty acid ester; and from about 0.01% to about 40% by weight of two fatty acid salts. In some embodiments, the composition comprises from about 60% to about 99.99% by weight of two fatty acids, fatty acid esters, or a combination thereof, and from about 0.01% to about 40% by weight of two fatty acid salts.

In some embodiments, each of the one or more fatty acids, fatty acid esters, or a combination thereof is an independently selected compound of Formula IA as disclosed herein. In some embodiments, each compound of Formula I is an independently selected compound of Formula IA-A as disclosed herein. In some embodiments, each fatty acid salt is an independently selected compound of Formula IIA, as disclosed herein.

In some embodiments, the plurality of antimicrobial microorganisms contains one or more different genera of antimicrobial microorganisms. In some embodiments, the plurality of antimicrobial microorganisms are from a genera selected from: Arthrobacter, Bacillus, Curtobacterium, Frigoribacterium, Kocuria, Mucilaginibacter, Niallia, Pantoea, Pseudoarthrobacter, Pseudomonas, Streptomyces, and Thermothelomyces. In some embodiments, the plurality of antimicrobial microorganisms comprises a strain from a species selected from: Arthrobacter agilis, Bacillus thuringiensis, Bacillus toyonensis, Bacillus subtilis, Bacillus aryanhattai, Bacillus aerophilus, Bacillus stratosphericus, Curtobacterium pusillum, Frigoribacterium endophyticum, Kocuria dechangensis, Kocuria rosea, Mucilaginibacter terrae, Niallia nealsonii, Pantoea allii, Pseudoarthrobacter phenanthrenivorans, Pseudomonas moraviensis, Pseudomonas fluorescens, Streptomyces thermocarboxydus, and Thermothelomyces thermophilus. In some embodiments, the plurality of antimicrobial microorganisms contains two or more different strains of antimicrobial microorganisms. In some embodiments, the plurality of antimicrobial microorganisms comprises Bacillus strain 22. In some embodiments, the plurality of antimicrobial microorganisms comprises Pseudomonas strain 1. In some embodiments, the plurality of antimicrobial microorganisms comprises Bacillus strain 12. In some embodiments, the plurality of antimicrobial microorganisms comprises Bacillus strain 15. In some embodiments, the plurality of antimicrobial microorganisms comprises Bacillus strain 23. In some embodiments, the plurality of antimicrobial microorganisms comprises Bacillus strain 24. In some embodiments, the plurality of antimicrobial microorganisms comprises Bacillus strain 35. In some embodiments, the plurality of antimicrobial microorganisms comprises Streptomyces strain 33. In some embodiments, the plurality of antimicrobial microorganisms comprises Pantoea strain 37. In some embodiments, the plurality of antimicrobial microorganisms comprises strain 17. In some embodiments, the plurality of antimicrobial microorganisms comprises strain 34. In some embodiments, the plurality of antimicrobial microorganisms comprises strain 38.

In some embodiments, the plurality of antimicrobial microorganisms comprise a microorganism having a 16S rRNA gene with at least 95% sequence identity to one or more of SEQ ID NOs: 1-57.

In some embodiments, the composition comprises 10³ to 10¹⁰ CFU of antimicrobial microorganisms per milliliter.

Also provided herein are methods of identifying an antimicrobial microorganism from a plurality of agricultural products including a) storing the plurality of agricultural products until at least 90% of the agricultural products show detectable signs of spoilage; and b) isolating the antimicrobial microorganism from the agricultural products that have the least detectable signs of spoilage.

In some embodiments, the plurality of agricultural products are treated with a food-spoilage pathogen prior to storage. In some embodiments, the food-spoilage pathogen is a fungus or a bacterial species. In some embodiments, the method further comprises assaying the antimicrobial microorganism for antimicrobial activity after isolating the antimicrobial microorganism. In some embodiments, the detectable signs of spoilage are selected from: a color change, a change in the ratio of starch to soluble sugar, a loss of mass, a change in texture, a visible sign of growth of a biological stressor, a development of an off-odor, a development of an off-flavor, and a combination thereof. In some embodiments, the color change is selected from: browning, yellowing, blackening, and a combination thereof. In some embodiments, the change in texture is selected from: softening, wrinkling, increasing fibrousness, increasing sliminess, and combination thereof. In some embodiments, the biological stressor is selected from: a fungi, a bacterium, and a combination thereof.

In some embodiments, the development of an off-odor comprises an increase in production of one or more spoilage metabolites. In some embodiments, the development of an off-flavor comprises an increase in production of one or more spoilage metabolites. In some embodiments, the one or more spoilage metabolites are selected from: an organic acid, a thiol, a sulfide, a thioester, ammonia or salt thereof, indole, scatole, a biogenic amine or salt thereof, a pyridine or salt thereof, a pyrazine or salt thereof, gluconate or a derivative thereof, a ketone, an aldehyde, an alcohol, an ester, and geosmin. In some embodiments, the one or more organic acids are selected from: lactic acid, acetic acid, butyric acid, propionic acid, and formic acid.

Also provided herein are methods of reducing microbial growth on an agricultural product including coating the agricultural product with a first composition comprising a plurality of antimicrobial microorganisms or conditioned media of a plurality of antimicrobial microorganisms.

Also provided herein are methods of delaying the onset of microbial growth on an agricultural product including coating the agricultural product with a first composition comprising a plurality of antimicrobial microorganisms or conditioned media of a plurality of antimicrobial microorganisms.

Also provided herein are methods of improving the shelf life of an agricultural product including coating the agricultural product with a first composition comprising a plurality of antimicrobial microorganisms or conditioned media of a plurality of antimicrobial microorganisms.

Also provided herein are methods of reducing desiccation of an agricultural product including coating the agricultural product with a first composition comprising a plurality of antimicrobial microorganisms or conditioned media of a plurality of antimicrobial microorganisms.

In some embodiments, the first composition further comprises a fatty acid derivative. In some embodiments, the method further comprises coating the agricultural product with a second composition comprising a fatty acid derivative. In some embodiments, the one or more fatty acid derivatives comprise one or more fatty acids, fatty acid esters, or a combination thereof and one or more fatty acid salts.

In some embodiments, the coating with the second composition occurs simultaneously with the coating with the first composition.

In some embodiments, the agricultural product is coated pre-harvest. In some embodiments, the agricultural product is coated post-harvest.

In some embodiments, coating the agricultural product comprises spraying or misting the composition onto the agricultural product. In some embodiments, coating the agricultural product comprises dipping the agricultural product in the composition. In some embodiments, coating the agricultural product comprises brushing the composition onto the agricultural product. In some embodiments, the brushing is performed using a brush bed.

In some embodiments, the agricultural product comprises a fruit, a vegetable, a plant, or a flower.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of a method for isolating antimicrobial microorganisms (e.g., antifungal microorganisms) from agricultural products. In step 1, agricultural products can be either infected with pathogens, or agricultural products can be allowed to spoil naturally. In step 2, agricultural products are selected that are slow or resistant to developing pathogens or to spoiling and microbes are extracted from the external surface of the agricultural products. In step 3, microbes are isolated from the extraction supernatant and tested for antimicrobial (e.g., antifungal) properties. In step 4, efficacy of the antimicrobial (e.g., antifungal) microbial isolate is tested by treating infected agricultural products.

FIG. 2 is a depiction of a Botrytis cinerea (Bc) in vitro antifungal assay. The left plate is a representative control plate with an axenic Bc culture growing on it. The right plate is a test plate with a growth inhibition assay. Pseudomonas sp. 0001 was inoculated on the left side of the plate and Bc on the right side of the plate.

FIG. 3 is a depiction of a Colletotrichum gloeosporioides (Cg) in vitro antifungal assay. The left plate is a representative control plate with axenic Cg culture. The right plate is a test plate with a growth inhibition assay. Cg was inoculated on the left side of the test plate and Pseudomonas sp. 0001 on the right.

FIG. 4 is a depiction of a Penicillium digitatum (Pd) in vitro antifungal assay. The left plate is a representative control plate with an axenic Pd culture. The right plate shows a growth inhibition assay. Pseudomonas sp. 0001 was inoculated on the left side of the plate and Pd on the right side of the plate.

FIG. 5 is a depiction of a Penicillium italicum (Pi) in vitro antifungal assay. The left plate is a representative control plate with an axenic Pi culture. The right plate shows a growth inhibition assay. Pseudomonas sp. 0001 was inoculated on the left side of the plate and Pi on the right side of the plate. b

FIG. 6 is a graph of the disease index of grapes infected with Botrytis cinerea at 5 days (left bar), 6 days (middle bar), or 7 days (right bar) post infection following various treatments, including treatment with the Bacillus strain 0012 (12 Treated).

FIG. 7 is a phylogenetic tree inferred using the 16S rDNA sequences described herein.

FIG. 8 is a depiction of the volatile organic compound (VOC) assay scale. 0—no inhibition (top left); 1—some inhibition (top right); 2—significant inhibition of (b, c); 2—significant inhibition of (d); and 3—complete inhibition. Each plate includes, clockwise from top, a—B. cinerea; b—P. italicum; c—P. digitatum; and d—C. gloeosporioides.

### DETAILED DESCRIPTION

Compositions described herein can be applied to plant or agricultural products to form a protective coating, or to enhance or modify existing coatings (either naturally occurring or deposited coatings) which are on the outer surface of the products. The applied coatings can, for example, serve to protect the products from biotic stressors such as bacteria, fungi, viruses, archaea, protists, pathogens, and/or pests, or can alter the physical and/or chemical environment of the surface of agricultural products or of the soil, making the conditions unfavorable for biotic stressors to grow.

Exemplary methods and materials are described herein. Methods and materials similar or equivalent to those described herein can also be used in the practice or testing of the various aspects and embodiments. The materials, methods, and examples are illustrative only and not intended to be limiting. Each embodiment of this disclosure may be taken alone or in combination with one or more other embodiments of this disclosure.

### Definitions

In order for the disclosure to be more readily understood, certain terms are first defined. These definitions should be read in light of the remainder of the disclosure as understood by a person of ordinary skill in the art. Additional definitions are set forth throughout the detailed description. Unless otherwise defined herein, scientific, and technical terms used in this application shall have the meanings that are commonly understood by those of ordinary skill in the art. In case of conflict, the present specification, including definitions, will control.

As used herein, the term “microorganism” refers to any bacteria, fungi, archaea, or protists. As used herein, the term “antimicrobial microorganism” refers to any microorganism that kills, inhibits, delays, or prevents another microorganism's growth, including fungal growth, such as mold growth.

As used herein, the term “agricultural product-spoilage associated microorganism” refers to any microorganism, including any bacteria, fungi, archaea, or protist, that is associated with spoilage of agricultural products. Spoilage can include softening, wrinkling, increasing fibrousness, increasing sliminess, and combination thereof of the agricultural product.

As used herein, the term “conditioned medium” refers to the liquid portion of spent fermentation or growth medium after the cells are removed by, for example, centrifugation. Conditioned medium can also be called a supernatant, a cultured supernatant, or a microbial supernatant.

As used herein, the term “alkyl” refers to saturated linear or branched-chain monovalent hydrocarbon radicals, containing the indicated number of carbon atoms. For example, “C₁₋₆ alkyl” refers to saturated linear or branched-chain monovalent hydrocarbon radicals of one to six carbon atoms. Non-limiting examples of alkyl include methyl, ethyl, 1-propyl, isopropyl, 1-butyl, isobutyl, sec-butyl, tert-butyl, 2-methyl-2-propyl, pentyl, neopentyl, and hexyl.

As used herein, the term “alkenyl” refers to a linear or branched mono-unsaturated hydrocarbon chain, containing the indicated number of carbon atoms. For example, “C₂₋₆ alkenyl” refers a linear or branched monounsaturated hydrocarbon chain of two to six carbon atoms. Non-limiting examples of alkenyl include ethenyl, propenyl, butenyl, or pentenyl.

As used herein, the term “alkoxy” refers to an —O-alkyl radical, wherein the radical is on the oxygen atom. For example, “C₁₋₆ alkoxy” refers to an —O—(C₁₋₆ alkyl) radical, wherein the radical is on the oxygen atom. Examples of alkoxy include methoxy, ethoxy, propoxy, isopropoxy, butoxy and tert-butoxy.

As used herein, the term “cycloalkyl” refers to a saturated or partially saturated cyclic hydrocarbon, containing the indicated number of carbon atoms. For example, “C₃-C₆ cycloalkyl” refers to a saturated or partially saturated cyclic hydrocarbon having three to six ring carbon atoms. Non-limiting examples of cycloalkyl include cyclopropyl, cyclobutyl, cyclopentyl, and cyclohexyl.

As used herein, the term “heterocycle” refers to a monocyclic nonaromatic ring system containing indicated number of ring atoms (e.g., 3-6 membered heterocycle) having 1-3 heteroatoms, said heteroatoms selected from O, N, or S. Examples of heterocyclic groups include oxiranyl, piperazinyl, pyrrolidinyl, dioxanyl, morpholinyl, and tetrahydrofuranyl.

As used herein, “fatty acid derivative” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acid derivatives include fatty acids, fatty acid esters (e.g., monoglycerides), and fatty acid salts.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

The term “about” when referring to a measurable value such as an amount, a temporal duration, and the like, refers to variations of 10%, or in some instances ±2%, or in some instances ±1% from the specified value, as such variations are appropriate to perform the present disclosures.

Throughout this specification and embodiments, the word “comprise,” or variations such as “comprises” or “comprising,” will be understood to imply the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting.

Unless otherwise required by context, singular terms shall include pluralities and plural terms shall include the singular.

The articles “a”, “an” and “the” are used herein to refer to one or to more than one (i.e., to at least one) of the grammatical object of the article.

### Compositions

Described herein are compositions, for example, edible barrier coatings, that can be used to improve the shelf life of agricultural products, for example, by preventing, inhibiting, delaying or slowing the onset of growth of microorganisms. Compositions can include antimicrobial (e.g., antifungal) microorganisms, including viable or non-viable antimicrobial microorganisms (e.g., lysed antimicrobial microorganisms), and/or conditioned media or supernatants thereof, and can be combined with one or more fatty acid derivatives (e.g., one or more fatty acids, fatty acid esters, or a combination thereof and one or more fatty acid salts) to prepare edible barrier coatings.

Embodiments of the antimicrobial (e.g., antifungal) compositions described herein provide several advantages, including, for example: (1) formation of agricultural coating formulations that can protect the agricultural products from biotic stressors (e.g., bacteria, viruses, fungi, archaea, protists, pathogens, and/or pests); (2) formation of agricultural coating formulations that can prevent evaporation of water and/or diffusion of oxygen and/or other gaseous species (e.g., carbon dioxide and ethylene); (3) extension of the shelf life of agricultural products, for example, pre-harvest or post-harvest agricultural products, without refrigeration; (4) introduction of mechanical stability to the surface of the agricultural products, helping to prevent the types of bruising and surface rupture that accelerate spoilage; (5) reduction of photodegradation of the agricultural products; and (6) use in place of pesticides to protect plants against biotic and abiotic stressors, thereby minimizing the harmful impact of pesticides to human health and the environment.

In any of the embodiments described herein, the compositions can include a plurality of antimicrobial (e.g., antifungal) microorganisms, and/or conditioned media thereof. Antimicrobial microorganisms can be bacterial, fungal, archaeal, or protozoan. Such antimicrobial microorganisms can prevent, inhibit, delay, or slow the growth of fungi or other food-spoilage associated microorganisms, including food-spoilage associated bacteria. Without wishing to be bound by theory, antimicrobial microorganisms can actively prevent, inhibit, delay, or slow the growth of microorganisms by secreting a component—such as a peptide or molecule—that directly interferes with microorganism growth. Alternatively, antimicrobial microorganisms can prevent, inhibit, delay, or slow the growth of microorganisms by competing with the microorganism for nutrients or other essential compounds required for growth, such as macronutrients, micronutrients or carbon sources.

In some embodiments, the plurality of antimicrobial microorganisms comprises bacteria. In some embodiments, the plurality of antimicrobial microorganisms include gram-positive bacteria, gram-negative bacteria, or a combination thereof. In some embodiments, the plurality of antimicrobial microorganisms are of the class Actinomycetes, Bacilli, or Gammaproteobacteria. In some embodiments, the plurality of antimicrobial microorganisms are of the genera Lactobacillus, Leuconostoc, Pediococcus, Arthrobacter, Bacillus, Curtobacterium, Frigoribacterium, Kocuria, Mucilaginibacter, Niallia, Pantoea, Pseudoarthrobacter, Pseudomonas, Streptomyces, and Thermothelomyces. In some embodiments, the plurality of antimicrobial microorganisms comprises a strain from a species selected from: Bacillus thuringiensis, Bacillus toyonensis, Bacillus subtilis, Bacillus aryanhattai, Bacillus aerophilus, Bacillus stratosphericus, Pantoea allii, Pseudomonas moraviensis, Pseudomonas fluorescens, Streptomyces thermocarboxydus, Lactobacillus spp., Lactobacillus rossiae, Lactobacillus amylovorus, Lactobacillus harbinensis, Lactobacillus brevis, Lactobacillus spicheri, Lactobacillus rhamnosus, Lactobacillus casei, Lactobacillus paracasie, Lactobacillus sanfranciscensis, Lactobacillus fermentum, Lactobacillus helveticus, Lactobacillus sakei, Leuconostoc carnosum, Leuconostoc citreum, Leuconostoc durionis, Leuconostoc fallax, Leuconostoc falkenbergense, Leuconostoc ficulneum, Leuconostoc fructosum, Leuconostoc garlicum, Leuconostoc gasicomitatum, Leuconostoc gelidum, Leuconostoc inhae, Leuconostoc kimchi, Leuconostoc lactis, Leuconostoc mesenteroides, Leuconostoc miyukkimchii, Leuconostoc palmae, Leuconostoc pseudoficulneum, Leuconostoc pseudomesenteroides, Leuconostoc rapi, Leuconostoc suionicum, Pediococcus acidilactici, Pediococcus cellicola, Pediococcus claussenii, Pediococcus damnosus, Pediococcus ethanolidurans, Pediococcus inopinatus, Pediococcus parvulus, Pediococcus pentosaceus, Pediococcus stilesii, Arthrobacter agilis, Curtobacterium pusillum, Frigoribacterium endophyticum, Kocuria dechangensis, Kocuria rosea, Mucilaginibacter terrae, Niallia nealsonii, Pseudoarthrobacter phenanthrenivorans, and Thermothelomyces thermophilus.

In some embodiments, the plurality of antimicrobial microorganisms comprises fungi. In some embodiments, the plurality of antimicrobial microorganisms comprise yeasts or molds. For example, fungi included in the plurality of antimicrobial microorganisms can be of the genera Cryptococcus, Aureobasidium, Candida, Sporidiobolus, Saccharomyces, Debaryomyces, Dekkera, Issatchenikia, Kluyveromyces, Pichia, Sporobolomyces, Torulaspora, Epichloë, or Neotyphodium. Fungal species included in the plurality of antimicrobial microorganisms can be Cryptococcus magnus, Aureobasidium pullulans, Candida zeylanoides, C. sake, Sporidiobolus pararoseus, Saccharomyces cervisiae, S. chevalieri, S. kluyveri, Epichloë, amarillans, E. baconii, E. brachyelytri, E. bromicola, E. clarkia, E. elymi, E. festucae, E. glyceriae, E. sylvatica, E. typhina, E. yangzii, Neotyphodium aotearoae, N. australiense, N. chisosum, N. soenophialum, N. huerfanum, N. gansuense, N. inebrians, N. occultans, N. lohi, N. melicicola, N. siegeli, N. starrii, N. tembladerae, N. typhinum, and N. uncinatum.

Antimicrobial microorganisms that are bacteria can be identified using sequence identity to the 16S rRNA gene, for example, at least 90% sequence identity (e.g., 95%, 96%, 97%, 98%, 99%, 99.5%, or 100%). Antimicrobial microorganisms that are fungi, such as molds, can be identified using sequence identity to the nuclear ribosomal Internal Transcribed Spacer regions 1 or 2 (ITS1 or ITS2).

In some embodiments, the antimicrobial microorganisms described herein are identified utilizing 16S rRNA gene sequences. The primary structure of major rRNA subunit 16S comprises a particular combination of conserved, variable, and hypervariable regions that evolve at different rates and enable the resolution of both very ancient lineages such as domains, and more modem lineages such as genera. The secondary structure of the 16S subunit includes approximately 50 helices which result in base pairing of about 67% of the residues. The hypervariable regions can provide species/strain-specific signature sequences useful for bacterial identification.

Antimicrobial microorganisms can be distinguished into a genus based on polyphasic taxonomy, which incorporates all available phenotypic and genotypic data into a consensus classification (Vandamme et al., 1996, Microbiol Rev, 60:407-438). In some embodiments, sequence identity of 94.5% or lower for two 16S rRNA genes is strong evidence for distinct genera, 86.5% or lower is strong evidence for distinct families, 82% or lower is strong evidence for distinct orders, 78.5% is strong evidence for distinct classes, and 75% or lower is strong evidence for distinct phyla. Also, populations that share greater than 90%, 91%, 92%, 93%, 94%, 95%, 96%, 97%, 98%, 99%, or 99.9% identity can be considered to be variants of the same species. Another accepted genotypic method for defining species is to isolate marker genes of the present disclosure, sequence these genes, and align these sequenced genes from multiple isolates or variants.

Another accepted genotypic method for defining species is based on overall genomic relatedness, such that strains which share approximately 70% or more relatedness using DNA-DNA hybridization, with 5° C. or less ΔTₘ (the difference in the melting temperature between homologous and heterologous hybrids), under standard conditions, are considered to be members of the same species.

The antimicrobial microorganism described herein and variants thereof may be characterized in part or in whole by comparing at least one 16S rRNA sequence with a corresponding 16S rRNA sequence of a reference strain genomic sequence. Generally, a bacterial strain genomic sequence will contain multiple copies of 16S rRNA sequences. The 16S rRNA gene sequence has been determined for a large number of strains. Comparison of the bacterial 16S rRNA gene sequence allows for new strains to be identified by comparison of sequences with known bacterial DNA sequences using, e.g., BLAST (blast.ncbi.nlm.nih.gov/Blast.cgi). In short, the comparison of the 16S rRNA sequence allows differentiation between organisms at the genus level across all major phyla of bacteria, in addition to classifying strains at multiple levels, including species and sub-species level.

The terms “percent sequence identity” or “identity” in the context of two or more nucleic acids or polypeptides, refers to the measurement of the similarity between the two or more sequences. The percent identity can be measured by any method known to one of skill in the art including using a sequence comparison software, an algorithm, and by visual inspection. In general, the percent identity for two or more sequences (e.g., a nucleic acid or amino acid sequence), also referred to as the “percent sequence identity,” is calculated by determining the number of matched positions in the aligned nucleic acid or amino acid sequences, dividing the number of matched positions by the total number of aligned nucleotides or amino acids, respectively, and multiplying by 100. A matched position refers to a position in which identical nucleotides or amino acids occur at the same position in the aligned sequences.

As an example, the total number of aligned nucleotides can refer to the minimum number of the 16S rRNA gene nucleotides that are necessary to align the second sequence, and does not include alignment (e.g., forced alignment) with non-16S rRNA gene sequences. The total number of aligned nucleotides may correspond to the entire 16S rRNA gene sequence or may correspond to fragments of the full-length 16S rRNA gene sequence.

Sequences can be aligned using an algorithm, for example, the algorithm as described by Altschul et al. (Nucleic Acids Res, 25:3389-3402, 1997) and incorporated into BLAST (basic local alignment search tool) programs, which are available at ncbi.nlm.nih.gov. BLAST searches or alignments can be performed to determine percent sequence identity between a 16S rRNA gene nucleic acid and any other sequence or portion thereof using the Altschul et al. algorithm. BLASTN can be used to align and compare the identity between nucleic acid sequences, while BLASTP can be used to align and compare the identity between amino acid sequences. When utilizing a BLAST program to calculate the percent identity between a 16S rRNA gene sequence and another sequence, the default parameters of the program are used. Generally, a bacterial strain genomic sequence will contain multiple copies of 16S rRNA gene sequences. The 16S rRNA gene sequences can be used for making distinctions between species and strains. For example, if one or more of the 16S rRNA gene sequences shares less than 97% sequence identity from a reference sequence, then the two organisms from which the sequences were obtained can be of different species or strains.

A composition can comprise a plurality of antimicrobial microorganisms, e.g., 1, 2, 3, 4, 5, 6, 7, 8, 9, 10, or more antimicrobial microorganisms. In some embodiments, the composition comprises a plurality of antimicrobial microorganisms selected from strain 1-116 (see Table 4). In some embodiments, the antimicrobial microorganism in the plurality of antimicrobial microorganisms comprises a 16S rRNA sequence that is at least 75%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% identical to any one of SEQ ID NOs: 1-57 (see Table 1 and Table 4).

TABLE 1
16S rRNA sequences

| SEQ | | |
|---|---|---|
| ID NO | ORGANISM | SEQUENCE |
| 1 | Pseudomonas | TGAAGAGTTTGATCATGGCTCAGATTGAACGCTGGCGGCAGGCCTAACACATGCAAGTCGAGCGGATGAAA |
| | spp. | GGAGCTTGCTCCTGGATTCAGCGGCGGACGGGTGAGTAATGCCTAGGAATCTGCCTGGTAGTGGGGGACAA |
| | | CGTTTCGAAAGGAACGCTAATACCGCATACGTCCTACGGGAGAAAGCAGGGGACCTTCGGGCCTTGCGCTA |
| | | TCAGATGAGCCTAGGTCGGATTAGCTAGTTGGTGAGGTAATGGCTCACCAAGGCGACGATCCGTAACTGGT |
| | | CTGAGAGGATGATCAGTCACACTGGAACTGAGACACGGTCCAGACTCCTACGGGAGGCAGCAGTGGGGAAT |
| | | ATTGGACAATGGGCGAAAGCCTGATCCAGCCATGCCGCGTGTGTGAAGAAGGTCTTCGGATTGTAAAGCAC |
| | | TTTAAGTTGGGAGGAAGGGTTGTAGATTAATACTCTGCAATTTTGACGTTACCGACAGAATAAGCACCGGC |
| | | TAACTCTGTGCCAGCAGCCGCGGTAATACAGAGGGTGCAAGCGTTAATCGGAATTACTGGGCGTAAAGCGC |
| | | GCGTAGGTGGTTCGTTAAGTTGGATGTGAAATCCCCGGGCTCAACCTGGGAACTGCATCCAAAACTGGCGA |
| | | GCTAGAGTATGGTAGAGGGTGGTGGAATTTCCTGTGTAGCGGTGAAATGCGTAGATATAGGAAGGAACACC |
| | | AGTGGCGAAGGCGACCACCTGGACTGATACTGACACTGAGGTGCGAAAGCGTGGGGAGCAAACAGGATTAG |
| | | ATACCCTGGTAGTCCACGCCGTAAACGATGTCAACTAGCCGTTGGGAGCCTTGAGCTCTTAGTGGCGCAGC |
| | | TAACGCATTAAGTTGACCGCCTGGGGAGTACGGCCGCAAGGTTAAAACTCAAATGAATTGACGGGGGCCCG |
| | | CACAAGCGGTGGAGCATGTGGTTTAATTCGAAGCAACGCGAAGAACCTTACCAGGCCTTGACATCCAATGA |
| | | ACTTTCCAGAGATGGATTGGTGCCTTCGGGAGCATTGAGACAGGTGCTGCATGGCTGTCGTCAGCTCGTGT |
| | | CGTGAGATGTTGGGTTAAGTCCCGTAACGAGCGCAACCCTTGTCCTTAGTTACCAGCACGTTATGGTGGGC |
| | | ACTCTAAGGAGACTGCCGGTGACAAACCGGAGGAAGGTGGGGATGACGTCAAGTCATCATGGCCCTTACGG |
| | | CCTGGGCTACACACGTGCTACAATGGTCGGTACAAAGGGTTGCCAAGCCGCGAGGTGGAGCTAATCCCATA |
| | | AAACCGATCGTAGTCCGGATCGCAGTCTGCAACTCGACTGCGTGAAGTCGGAATCGCTAGTAATCGCGAAT |
| | | CAGAATGTCGCGGTGAATACGTTCCCGGGCCTTGTACACACCGCCCGTCACACCATGGGAGTGGGTTGCAC |
| | | CAGAAGTAGCTAGTCTAACCTTCGGGAGGACGGTTACCACGGTGTGATTCATGACTGGGGTGAAGTCGTAA |
| | | CAAGGTAGCCGTAGGGGAACCTGCGGCTGGATCACCTCCTT |
| 2 | Bacillus spp. | TCGGAGAGTTTGATCCTGGCTCAGGACGAACGCTGGCGGCGTGCCTAATACATGCAAGTCGAGCGGACAGA |
| | | TGGGAGCTTGCTCCTGATGTTAGCGGCGGACGGGTGAGTAACACGTGGGTAACCTGCCTGTAAGACTGGGA |
| | | TAACTCCGGGAAACCGGGGCTAATACCGGATGCTTGTTTGAACCGCATGGTTCAAACATAAAAGTGGCTTC |
| | | GGCTACCACTTACAGATGGACCCGCGGCGCATTAGCTAGTTGGTGAGGTAACGGCTCACCAAGGCAACGAT |
| | | GCGTAGCCGACCTGAGAGGGTGATCGGCCACACTGGGACTGAGACACGGCCCAGACTCCTACGGGAGGCAG |
| | | CAGTAGGGAATCTTCCGCAATGGACGAAAGTCTGACGGAGCAACGCCGCGTGAGTGATGAAGGTTTTCGGA |
| | | TCGTAAAGCTCTGTTGTTAGGGAAGAACAAGTGCCGTTCAAATAGGGCGGCACCTTGACGGTACCTAACCA |
| | | GAAAGCCACGGCTAACTACGTGCCAGCAGCCGCGGTAATACGTAGGTGGCAAGCGTTGTCCGGAATTATTG |
| | | GGCGTAAAGGGCTCGCAGGCGGTTTCTTAAGTCTGATGTGAAAGCCCCGGCTCAACCGGGGAGGGTCATTG |
| | | GAAACTGGGGAACTTGAGTGCAGAAGAGGAGAGTGGAATTCCACGTGTAGCGGTGAAATGCGTAGAGATGT |
| | | GGAGGAACACCAGTGGCGAAGGCGACTCTCTGGTCTGTAACTGACGCTGAGGAGCGAAAGCGTGGGGAGCG |
| | | AACAGGATTAGATACCCTGGTAGTCCACGCCGTAAACGATGAGTGCTAAGTGTTAGGGGTTTCCGCCCCTT |
| | | AGTGCTGCAGCTAACGCATTAAGCACTCCGCCTGGGAGTACGGTCGCAAGACTGAAACTCAAAGGAATTGA |
| | | CGGGGGCCCGCACAAGCGGTGGAGCATGTGGTTTAATTCGAAGCAACGCGAAGAACCTTACCAGGTCTTGA |
| | | CATCCTCTGACAATCCTAGAGATAGGACGTCCCCTTCGGGGGCAGAGTGACAGGTGGTGCATGGTTGTCGT |
| | | CAGCTCGTGTCGTGAGATGTTGGGTTAAGTCCCGCAACGAGCGCAACCCTTGATCTTAGTTGCCAGCATTC |
| | | AGTTGGGCACTCTAAGGTGACTGCCGGTGACAAACCGGAGGAAGGTGGGGATGACGTCAAATCATCATGCC |
| | | CCTTATGACCTGGGCTACACACGTGCTACAATGGACAGAACAAAGGGCAGCGAAACCGCGAGGTTAAGCCA |
| | | ATCCCACAAATCTGTTCTCAGTTCGGATCGCAGTCTGCAACTCGACTGCGTGAAGCTGGAATCGCTAGTAA |
| | | TCGCGGATCAGCATGCCGCGGTGAATACGTTCCCGGGCCTTGTACACACCGCCCGTCACACCACGAGAGTT |
| | | TGTAACACCCGAAGTCGGTGAGGTAACCTTTATGGAGCCAGCCGCCGAAGGTGGGACAGATGATTGGGGTG |
| | | AAGTCGTAACAAGGTAGCCGTATCGGAAGGTGCGGCTGGATCACCTCCTTT |
| 3 | Bacillus spp. | TCGGAGAGTTTGATCCTGGCTCAGGATGAACGCTGGCGGCGTGCCTAATACATGCAAGTCGAGCGAACTGA |
| | | TTAGAAGCTTGCTTCTATGACGTTAGCGGCGGACGGGTGAGTAACACGTGGGCAACCTGCCTGTAAGACTG |
| | | GGATAACTTCGGGAAACCGAAGCTAATACCGGATAGGATCTTCTCCTTCATGGGAGATGATTGAAAGATGG |
| | | TTTCGGCTATCACTTACAGATGGGCCCGCGGTGCATTAGCTAGTTGGTGAGGTAACGGCTCACCAAGGCCA |
| | | CGATGCATAGCCGACCTGAGAGGGTGATCGGCCACACTGGGACTGAGACACGGCCCAGACTCCTACGGGAG |
| | | GCAGCAGTAGGGAATCTTCCGCAATGGACGAAAGTCTGACGGAGCAACGCCGCGTGAGTGATGAAGGCTTT |
| | | CGGGTCGTAAAACTCTGTTGTTAGGGAAGAACAAGTACAAGAGTAACTGCTTGTACCTTGACGGTACCTAA |
| | | CCAGAAAGCCACGGCTAACTACGTGCCAGCAGCCGCGGTAATACGTAGGTGGCAAGCGTTATCCGGAATTA |
| | | TTGGGCGTAAAGCGCGCGCAGGCGGTTTCTTAAGTCTGATGTGAAAGCCCACGGCTCAACCGTGGAGGGTC |
| | | ATTGGAAACTGGGGAACTTGAGTGCAGAAGAGAAAAGCGGAATTCCACGTGTAGCGGTGAAATGCGTAGAG |
| | | ATGTGGAGGAACACCAGTGGCGAAGGCGGCTTTTTGGTCTGTAACTGACGCTGAGGCGCGAAAGCGTGGGG |
| | | AGCAAACAGGATTAGATACCCTGGTAGTCCACGCCGTAAACGATGAGTGCTAAGTGTTAGAGGGTTTCCGC |
| | | CCTTTAGTGCTGCAGCTAACGCATTAAGCACTCCGCCTGGGGAGTACGGTCGCAAGACTGAAACTCAAAGG |
| | | AATTGACGGGGGCCCGCACAAGCGGTGGAGCATGTGGTTTAATTCGAAGCAACGCGAAGAACCTTACCAGG |
| | | TCTTGACATCCTCTGACAACTCTAGAGATAGAGCGTTCCCCTTCGGGGACAGAGTGACAGGTGGTGCATGG |
| | | TTGTCGTCAGCTCGTGTCGTGAGATGTTGGGTTAAGTCCCGCAACGAGCGCAACCCTTGATCTTAGTTGCC |
| | | AGCATTTAGTTGGGCACTCTAAGGTGACTGCCGGTGACAAACCGGAGGAAGGTGGGGATGACGTCAAATCA |
| | | TCATGCCCCTTATGACCTGGGCTACACACGTGCTACAATGGATGGTACAAAGGGCTGCAAGACCGCGAGGT |
| | | CAAGCCAATCCCATAAAACCATTCTCAGTTCGGATTGTAGGCTGCAACTCGCCTACATGAAGCTGGAATCG |
| | | CTAGTAATCGCGGATCAGCATGCCGCGGTGAATACGTTCCCGGGCCTTGTACACACCGCCCGTCACACCAC |
| | | GAGAGTTTGTAACACCCGAAGTCGGTGGAGTAACCGTAAGGAGCTAGCCGCCTAAGGTGGGACAGATGATT |
| | | GGGGTGAAGTCGTAACAAGGTAGCCGTATCGGAAGGTGCGGCTGGATCACCTCCTTT |
| 4 | Bacillus spp. | ATTGGAGAGTTCGATCCTGGCTCAGGATGAACGCTGGCATGTGCCTAATACATGCAAGTCGAGCGAATGGA |
| | | TTGAGAGCTTGCTCTCAAGAAGTTAGCATGGACGGGTGAGTAACACGTGGGTAACCTGCCCATAAGACTGG |
| | | GATAACTCCGGGAAACCGGGGCTAATACCGGATAATATTTTGAACTGCATGGTTCGAAATTGAAAGGCGAC |
| | | TTCGGCTGTCACTTATGGATGGACCCGCGTCGCATTAGCTAGTTGGTGAGGTAACGGCTCACCAAGGCAAC |
| | | GATGCGTAGCCGACCTGAGAGGGCGATCGGCCACACTGGGACTGAGACACGGCCCAGACTCCTACGGGAGG |
| | | CAAGCAGTAGGGAATCTTCCGCAATGGACGAAAGTCTGACGGAGCAACGCCGCGTGAGTGATGAAGGCTTT |
| | | CGGGTCGTAAAACTCTGTTGTTAGGGAAGAACAAGTGCTAGTTGAATAAGCTGGCACCTTGACGGTACCTA |
| | | ACCAGAAAGCCACGGCTAACTACGTGCCAGCGTACCGCGGTAATACGTAGGTGGCAAGCGTTATCCGGAAT |
| | | TATTGGGCGTAAAGCGCGCGCAGGTGGTTTCTTAAGTCTGATGTGAAAGCCCACGGCTCAACCGTGGAGGG |
| | | TCATTGGAAACTGGGAGACTTGAGTGCAGAAGAGGAAAGTGGAATTCCATGTGTAGCGGTGAAATGCGTAG |
| | | AGATATGGAGGAACACCAGTGGCGAAGGCGACTTTCTGGTCTGTAACTGACACTGAGGCGCGAAAGCGTGG |
| | | GGAGCAAACAGGATTAGATACCCTGGTAGTCCACGCCGTAAACGATGAGTGCTAAGTGTTAGAGGGTTTCC |
| | | GCCCTTTAGTGCTGAAGTTAACGCATTAAGCACTCCGCCTGGGGAGTACGGCCGCAAGGCTGAAACTCAAA |
| | | GGAATTGACGGGGCCCGCACAAGCGGTGGAGCATGTGGTTTAATTCGAAGCAACGCGAAGAACCTTACCAG |
| | | GTCTTGACATCCTCTGAAAACCCTAGAGATAGGGCTTCTCCTTCGGGAGCAGAGTGACAGGTGGTGCATGG |
| | | TTGTCGTCAGCTCGTGTCGTGAGATGTTGGGTTAAGTCCCGCAACGAGCGCAACCCTCGATCTTAGTTGCC |
| | | ATCATTAAGTTGGGCACTCTAAGGTGACTGCCGGTGACAAACCGGAGGAAGGTGGGGATGACGTCAAATCA |
| | | TCATGCCCCTTATGACCTGGGCTACACACGTGCTACAATGGACGGTACAAAGAGCCGCAAGACCGCGAGGT |
| | | GGAGCTAATCTCATAAAACCGTTCTCAGTTCGGATTGTAGGTCGCAACTCGCCTACATGAAGCTGGAATCG |
| | | CTAGTAATCGCGATCAGCATGCCGCGGTGAATACGTTCCCGGGCCTTGTACACACCGCCCGTCACACCACG |
| | | AGAGTTTGTAACACCCGAAGTCGGTGGGGTAACCTTTGGAGCCAGCCGCCTAAGGTGGGACAGATGATTGG |
| | | GGTGAAGTCGTAACAAGGTAGCCGTATCGGAAGGTGCACTGGATCACCTCCTTT |
| 5 | Bacillus spp. | TTCGGAGAGTTTGATCCTGGCTCAGGACGAACGCTGGCGGCGTGCCTAATACATGCAAGTCGAGCGGACAG |
| | | AAGGAGCTTGCTCCCGGATGTTAGCGGCGGACGGGTGAGTAACACGTGGGTAACCTGCCTGTAAGACTGGG |
| | | ATAACTCCGGGAAACCGGAGCTAATACCGGATAGTTCCTTGAACCGCATGGTTCAAGGATGAAAGACGGTT |
| | | TCGGCTGTCACTTACAGATGGACCCGCGGCGCATTAGCTAGTTGGTGAGGTAACGGCTCACCAAGGCGACG |
| | | ATGCGTAGCCGACCTGAGAGGGTGATCGGCCACACTGGGACTGAGACACGGCCCAGACTCCTACGGAGGCA |
| | | GCAGTAGGGAATCTTCCGCAATGGACGAAAGTCTGACGGAGCAACGCCGCGTGAGTGATGAAGGTTTTCGG |
| | | ATCGTAAAGCTCTGTTGTTAGGGAAGAACAAGTGCAAGAGTAACTGCTTGCACCTTGACGGTACCTAACCA |
| | | GAAAGCCACGGCTAACTACGTGCCAGCAGCCGCGGTAATACGTAGGTGGCAAGCGTTGTCCGGAATTATTG |
| | | GGCGTAAAGGGCTCGCAGGCGGTTTCTTAAGTCTGATGTGAAAGCCCCCGGCTCAACCGGGAGGGTCATTG |
| | | GAAACTGGGAAACTTGAGTGCAGAAGAGGAGAGTGGAATTCCACGTGTAGCGGTGAAATGCGTAGAGATGT |
| | | GGAGGAACACCAGTGGCGAAGGCGACTCTCTGGTCTGTAACTGACGCTGAGGAGCGAAAGCGTGGGGAGCG |
| | | AACAGGATTAGATACCCTGGTAGTCCACGCCGTAAACGATGAGTGCTAAGTGTTAGGGGTTTCCGCCCCTT |
| | | AGTGCTGCAGCTAACGCATTAAGCACTCCGCCTGGGAGTACGGTCGCAAGACTGAAACTCAAAGGAATTGA |
| | | CGGGGCCCGCACAAGCGGTGGAGCATGTGGTTTAATTCGAAGCAACGCGAAGAACCTTACCAGGTCTTGAC |
| | | ATCCTCTGACAACCCTAGAGATAGGGCTTTCCTTCGGGGACAGAGTGACAGGTGGTGCATGGTTGTCGTCA |
| | | GCTCGTGTCGTGAGATGTTGGGTTAAGTCCCGCAACGAGGCGCAACCCTTGATCTTAGTTGCCAGCATTTA |
| | | GTTGGGCACTCTAAGGTGACTGCCGGTGACAAACCGGAGGAAGGTGGGGATGACGTCAAATCATCATGCCC |
| | | CTTATGACCTGGGCTACACACGTGCTACAATGGACAGAACAAAGGGCTGCGAGACCGCAAGGTTTAGCCAA |
| | | TCCCACAAATCTGTTCTCAGTTCGGATCGCAGTCTGCAACTCGACTGCGTGAAGCTGGAATCGCTAGTAAT |
| | | CGCGGATCAGCATGCCGCGGTGAATACGTTCCCGGGCCTTGTACACACCGCCCGTCACACCACGAGAGTTT |
| | | GCAACACCCGAAGTCGGTGAGGTAACCTTTATGGAGCCAGCCGCCGAAGGTGGGGCAGATGATTGGGGTGA |
| | | AGTCGTAACAAGGTAGCCGTATCGGAAGGTGCGGCTGGATCACCTCCTTT |
| 6 | Bacillus spp. | TCGGAGAGTTTGATCCTGGCTCAGGACGAACGCTGGCGGCGTGCCTAATACATGCAAGTCGAGCGGACAGA |
| | | TGGGAGCTTGCTCCCTGATGTTAGCGGCGGACGGGTGAGTAACACGTGGGTAACCTGCCTGTAAGACTGGG |
| | | ATAACTCCGGGAAACCGGGGCTAATACCGGATGCTTGTTTGAACCGCATGGTTCAAACATAAAGGTGGCTT |
| | | CGGCTACCACTTACAGATGGACCCGCGGCGCATTAGCTAGTTGGTGAGGTAATGGCTCACCAAGGCAACGA |
| | | TGCGTAGCCGACCTGAGAGGGGTGATCGGCCACACTGGGACTGAGACACGGCCCAGACTCCTACGGGAGGC |
| | | GGCAGTAGGGAATCTTCCGCAATGGACGAAAGTCTGACGGAGCAACGCCGCGTGAGTGATGAAGGTTTTCG |
| | | GATCGTAAAGCTCTGTTGTTAGGGAAGAACAAGTACCGTTCGAATAGGGCGGTACCTTGACGGTACCTAAC |
| | | CAGAAAGCCACGGCTAACTACGTGCCAGCGACCGCGGTAATACGTAGGTGGCAAGCGTTGTCCGGAATTAT |
| | | TGGGCGTAAAGGGCTCGCAGGCGGTTTCTTAAGTCTGATGTGAAAGCCCCCGGCTCAACCGGGGAGGGTCA |
| | | TTGGAAACTGGGGAACTTGAGTGCAGAAGAGGAGAGTGGAATTCCACGTGTAGCGGTGAAATGCGTAGAGA |
| | | TGTGGAGGAACACCAGTGGCGAAGGCGACTCTCTGGTCTGTAACTGACGCTGAGGAGCGAAAGCGTGGGGA |
| | | GCGAACAGGATTAGATACCCTGGTAGTCCACGCCGTAAACGATGAGTGCTAAGTGTTAGGGGTTTCCGCCC |
| | | CTTAGTGCCGCAGCTAACGCATTAAGCACTCCGCCTGGGGAGTACGGTCGCAAGACTGAAACTCAAAGGAA |
| | | TTGACGGGGGCCCGCACAAGCGGTGGAGCATGTGGTTTAATTCGAAGCAACGCGAAGAACCTTACCAGGTC |
| | | TTGACATCCTCTGACAATCCTAGAGATGGGACGTCCCCTTCGGGGCAGAGTGACAGGTGGTGCATGGTTGT |
| | | CGTCAGCTCGTGTCGTGAGATGTTGGGTTAAGTCCCGCAACGAGCGCAACCCTTGATCTTAGTTGCCAGCA |
| | | TTCAGTTGGGCACTCTAAGGTGACTGCCGGTGACAAACCGGAGGAAGGTGGGGATGACGTCAAATCATCAT |
| | | GCCCCTTATGACCTGGGCTACACACGTGCTACAATGGACAGAACAAGAGGCGGCGAAACCGCGAGTTAAGC |
| | | CAATCCCACAAATCTGTTCTCAGTTCGGATCGCAGTCTGCAACTCGACTGCGTGAAGCTGGAATCGCTAGT |
| | | AATCGCGGATCAGCATGCCGCGGTGAATACGTTCCCGGGCCTTGTACACACCGCCCGTCACACCACGAGAG |
| | | TTTGTAACACCCGAAGTCGGTGAGGTAACCTTTTAGGAGCCAGCCGCCGAAGGTGGGACAGATGATTGGGG |
| | | TGAAGTCGTAACAAGGTAGCCGTATCGGAAGGTGCGGCTGGATCACCTCCTTT |
| 7 | Streptomyces | ACGGAGAGTTTGATCCTGGCTCAGGACGAACGCTGGCGGCGTGCTTAACACATGCAAGTCGAACGATGAAG |
| | spp. | CCCTTCGGGGTGGATTAGTGGCGAACGGGTGAGTAACACGTGGGCAATCTGCCCTGCACTCTGGGACAAGC |
| | | CCTGGAAACGGGGTCTAATACCGGATACTGATCGCCTTGGGCATCCTTGGTGATCGAAAGCTCCGGCGGTG |
| | | CAGGATGAGCCCGCGGCCTATCAGCTTGTTGGTGAGGTAATGGCTCACCAAGGCGACGACAGGTAGCCGGC |
| | | CTGAGAGGGCGACCGGCCACACTGGGACTGAGACACGGCCCAGACTCCTACGGGAGGCAGCAGTGGGGAAT |
| | | ATTGCACAATGGGCGAAAGCCTGATGCAGCGACGCCGCGTGAGGGATGACGGCCTTCGGGTTGTAAACCTC |
| | | TTTCAGCAGGGAAGAAGCGAAAGTGACGGTACCTGCAGAAGAAGCGCCGGCTAACTACGTGCCAGCAGCCG |
| | | CGGTAATACGTAGGGCGCGAGCGTTGTCCGGAATTATTGGGCGTAAAGAGCTCGTAGGCGGCTTGTCGCGT |
| | | CGGTTAGAAAGCCCGGGGCTTAACCCCGGGTCTGCAGTCGATACGGGCAGGCTAGAGTTCGGTAGGGGAGA |
| | | TCGGAATTCCTGGTGTAGCGGTGAAATGCGCAGATATCAGGAGGAACACCGGTGGCGAAGGCGGATCTCTG |
| | | GGCCGATACTGACGCTGAGGAGCGAAAGCGTGGGGAGCGAACAGGATTAGATACCCTGGTAGTCCACGCCG |
| | | TAAACGGTGGGCACTAGGTGTGGGCGACATTCCACGTCGTCCGTGCCGCAGCTAACGCATTAAGTGCCCCG |
| | | CCTGGGGAGTACGGCCGCAAGGCTAAAACTCAAAGGAATTGACGGGGCCCGCACAAGCGGCGGAGCATGTG |
| | | GCTTAATTCGACGCAACGCGAAGAACCTTACCAAGGCTTGACATACACCGGAAACGTCCAGAGATGGGCGC |
| | | CCCTTGTGGTCGGTGTACAGGTGGTGCATGGCTGTCGTCAGCTCGTGTCGTGAGATGTTGGGTTAAGTCCC |
| | | GCAACGAGCGCAACCCTTGTCCCGTGTTGCCAGCAGGCCCTTGTGGTGCTGGGGACTCACGGGAGACCGCC |
| | | GGGGTCAACTCGGAGGAAGGTGGGGACGACGTCAAGTCATCATGCCCCTTATGTCTTGGGCTGCACACGTG |
| | | CTACAATGGCCGGTACAATGAGCTGCGATACCGCGAGGTGGAGCGAATCTCAAAAAGCCGGTCTCAGTTCG |
| | | GATTGGGGTCTGCAACTCGACCCCATGAAGTCGGAGTCGCTAGTAATCGCAGATCAGCATTGCTGCGGTGA |
| | | ATACGTTCCCGGGCCTTGTACACACCGCCCGTCACGTCACGAAAGTCGGTAACACCCGAAGCCGGTGGCCC |
| | | AACCCCTTGTGGGGAGGGAGCTGTCGAAGGTGGGACTGGCGATTGGGACGAAGTCGTAACAAGGTAGCCGT |
| | | ACCGGAAGGTGCGGCTGGATCACCTCCTTT |
| 8 | Bacillus spp. | TTCGGAGAGTTTGATCCTGGCTCAGGACGAACGCTGGCGGCGTGCCTAATACATGCAAGTCGAGCGGACAG |
| | | AAGGAGCTTGCTCCCGGATGTTAGCGGCGGACGGGTGAGTAACACGTGGGTAACCTGCCTGTAAGACTGGG |
| | | ATAACTCCGGGAAACCGGAGCTAATACCGGATAGTTCCTTGAACCGCATGGTTCAAGGATGAAAGACGGTT |
| | | TCGGCTGTCACTTACAGATGGACCCGCGGCGCATTAGCTAGTTGGTGGGGTAATGGCTCACCAAGGCGACG |
| | | ATGCGTAGCCGACCTGAGAGGGTGATCGGCCACACTGGGACTGAGACACGGCCCAGACTCCTACGGGAGGC |
| | | AGCAGTAGGGAATCTTCCGCAATGGACGAAAGTCTGACGGAGCAACGCCGCGTGAGTGATGAAGGTTTTCG |
| | | GATCGTAAAGCTCTGTTGTTAGGGAAGAACAAGTGCGAGAGTAACTGCTCGCACCTTGACGGTACCTAACC |
| | | AGAAAGCCACGGCTAACTACGTGCCAGCAGCCGCGGTAATACGTAGGTGGCAAGCGTTGTCCGGAATTATT |
| | | GGGCGTAAAGGGCTCGCAGGCGGTTTCTTAAGTCTGATGTGAAAGCCCCGGCTCAACCGGGGAGGGTCATT |
| | | GGAAACTGGGAAACTTGAGTGCAGAAGAGGAGAGTGGAATTCCACGTGTAGCGGTGAAATGCGTAGAGATG |
| | | TGGAGGAACACCAGTGGCGAAGGCGACTCTCTGGTCTGTAACTGACGCTGAGGAGCGAAAGCGTGGGGAGC |
| | | GAACAGGATTAGATACCCTGGTAGTCCACGCCGTAAACGATGAGTGCTAAGTGTTAGGGGTTTCCGCCCCT |
| | | TAGTGCTGCAGCTAACGCATTAAGCACTCCGCCTGGGGAGTACGGTCGCAAGACTGAAACTCAAAGGAATT |
| | | GACGGGGCCCGCACAAGCGGTGGAGCATGTGGTTTAATTCGAAGCAACGCGAAGAACCTTACCAGGTCTTG |
| | | ACATCCTCTGACAACCCTAGAGATAGGGCTTTCCTTCGGGGACAGAGTGACAGGTGGTGCATGGTTGTCGT |
| | | CAGCTCGTGTCGTGAGATGTTGGGTTAAGTCCCGCAACGAGCGCAACCCTTGATCTTAGTTGCCAGCATTC |
| | | AGTTGGGCACTCTAAGGTGACTGCCGGTGACAAACCGGAGGAAGGTGGGGATGACGTCAAATCATCATGCC |
| | | CCTTATGACCTGGGCTACACACGTGCTACAATGGACAGAACAAAGGGCTGCAAGACCGCAAGGTTTAGCCA |
| | | ATCCCATAAATCTGTTCTCAGTTCGGATCGCAGTCTGCAACTCGACTGCGTGAAGCTGGAATCGCTAGTAA |
| | | TCGCGGATCAGCATGCCGCGGTGAATACGTTCCCGGGCCTTGTACACACCGCCCGTCACACCACGAGAGTT |
| | | TGCAACACCCGAAGTCGGTGAGGTAACCTTTATGGAGCCAGCCGCCGAAGGTGGGGCAGATGATTGGGGTG |
| | | AAGTCGTAACAAGGTAGCCGTATCGGAAGGTGCGGCTGGATCACCTCCTTT |
| 9 | Pantoea spp. | TTGAAGAGTTTGATCATGGCTCAGATTGAACGCTGGCGGCAGGCCTAACACATGCAAGTCGGACGGTAGCA |
| | | CAGAGAGCTTGCTCTCGGGTGACGAGTGGCGGACGGGTGAGTAATGTCTGGGGATCTGCCCGATAGAGGGG |
| | | ATAACCACTGGAAACGGTGGCTAATACCGCATAACGTCGCAAGACCAAAGAGGGGACCTTCGGGCCTCTCA |
| | | CTATCGGATGAACCCAGATGGGATTAGCTAGTAGGCGGGGTAACGGCCCACCTAGGCGACGATCCTAGCTG |
| | | GTCTGAGAGGATGACCAGCCACACTGGAACTGAGACACGGTCCAGACTCCTACGGGAGGCAGCAGTGGGGA |
| | | ATATTGCACAATGGGCGCAAGCCTGATGCAGCCATGCCGCGTGTATGAAGAAGGCCTTCGGGTTGTAAAGT |
| | | ACTTTCAGCGGGGAGGAAGGCGATGTGGTTAATAACCGCGTCGATTGACGTTACCCGCAGAAGAAGCACCG |
| | | GCTAACTCCGTGCCAGCAGCCGCGGTAATACGGAGGGTGCAAGCGTTAATCGGAATTACTGGGCGTAAAGC |
| | | GCACGCAGGCGGTCTGTTAAGTCAGATGTGAAATCCCCGGGCTTAACCCGGGAACTGCATTTGAAACTGGC |
| | | AGGCTTGAGTCTCGTAGAGGGGTAGAATTCAGGTGTAGCGGTGAAATGCGTAGAGATCTGGAGGAATACCG |
| | | GTGGCGAAGGCGGCCCCTGGACGAAGACTGACGCTCAGGTGCGAAAGCGTGGGAGCAAACAGGATTAGATA |
| | | CCCTGGTAGTCCACGCCGTAAACGATGTCGACTTGGAGGTTGTTCCCTTGAGGAGTGGCTTCCGGAGCTAA |
| | | CGCGTTAAGTCGACCGCCTGGGGAGTACGGCCGCAAGGTTAAAACTCAAATGAATTGACGGGGGCCCGCAC |
| | | AAGCGGTGGAGCATGTGGTTTAATTCGATGCAACGCGAAGAACCTTACCTACTCTTGACATCCACGGAATT |
| | | TGGCAGAGATGCCTTAGTGCCTTCGGGAACCGTGAGACAGGTGCTGCATGGCTGTCGTCAGCTCGTGTTGT |
| | | GAAATGTTGGGTTAAGTCCCGCAACGAGCGCAACCCTTATCCTTTGTTGCCAGCGATTCGGTCGGGAACTC |
| | | AAAGGAGACTGCCGGTGATAAACCGGAGGAAGGTGGGGATGACGTCAAGTCATCATGGCCCTTACGAGTAG |
| | | GGCTACACACGTGCTACAATGGCGCATACAAAGAGAAGCGACCTCGCGAGAGCAAGCGGACCTCATAAAGT |
| | | GCGTCGTAGTCCGGATCGGAGTCTGCAACTCGACTCCGTGAAGTCGGAATCGCTAGTAATCGTGGATCAGA |
| | | ATGCCACGGTGAATACGTTCCCGGGCCTTGTACACACCGCCCGTCACACCATGGGAGTGGGTTGCAAAAGA |
| | | AGTAGGTAGCTTAACCTTCGGGAGGGCGCTTACCACTTTGTGATTCATGACTGGGGTGAAGTCGTAACAAG |
| | | GTAACCGTAGGGGAACCTGCGGTTGGATCACCTCCTT |
| 10 | Unknown | CAGCCGGGGGCATTAGTATTTGCACGCTAGAGGTGAAATTCTTGGATTGTGCAAAGACTTCCTACTGCGAA |
| | | AGCATTTGCCAAGAATGTTTTCATTAATCAAGAACGAAGGTTAGGGTATCGAAAACGATTAGATACCGTTG |
| | | TAGTCTTAACAGTAAACTATGCCGACTCCGAATCGGTCGATGCTCATTTCACTGGCTCGATCGGCGCGGTA |
| | | CGAGAAATCAAAGTTTTTGGGTTCTGGGGGAGTATGGTCGCAAGGCTGAAACTTAAAGAAATTGACGGAAG |
| | | GGCACCACCAGGAGTGGAGCCTGCGGCTTAATTTGACTCAACACGGGAAAACTCACCGGGTCCGGACATAG |
| | | TAAGGATTGACAGATTGATGGCGCTTTCATGATTCTATGGGTGGTGGTGCATGGCCGTTCTTAGTTGGTGG |
| | | AGTGATTTGTCTGGTTAATTCCGATAACGAACGAGACCTTGACCTGCTAAATAGACGGGTTGACATTTTGT |
| | | TGGCCCCTTATGTCTTCTTAGAGGGACTATCGACCGTCTAGGTGATGGAGGCAAAAGGCAATAACAGGTCT |
| | | GTGATGCCCTTAGATGTTCCGGGCTGCACGCGCGCTACACTGACAGAGACAACGAGTGGGGCCCCTTGTCC |
| | | GAAATGACTGGGTAAACTTGTGAAACTTTGTCGTGCTGGGGATGGAGCTTTGTAATTTTTGCTCTTCAACG |
| | | AGGAATTCCTAGTAAGCGCAAGTCATCAGCTTGCGTTGACTACGTCCCTGCCCTTTGTACACACCGCCCGT |
| | | CGCTACTACCGATTGAATGGCTTAGTGAGGACTTGGGAGAGTACATCGGGGAGCCAGCAATGGCACCCTGA |
| | | CGGCTCAAACTCTTACAAACTTGGTCATTTAGAGGAAGTAAAAGTCGTAACAAGGTATCTGTAGGTGAACC |
| | | TGCAGATGGATCATTTC |

In some embodiments, a composition contains two or more different genera (e.g., three or more, four or more, five or more, or six or more) of antimicrobial microorganisms. In some embodiments, a composition contains two or more different species (e.g., three or more, four or more, five or more, or six or more) of antimicrobial microorganisms. In some embodiments, a composition contains two or more different strains (e.g., three or more, four or more, five or more, or six or more) of antimicrobial microorganisms.

In some embodiments, the composition comprises about 10³ to about 10¹⁰ colony forming units (CFU) of antimicrobial microorganisms per milliliter.

The compositions described herein can include viable or non-viable antimicrobial microorganisms (e.g., lysed antimicrobial microorganisms), or conditioned media or supernatants, of any of the antimicrobial microorganisms described herein.

In some embodiments, the composition comprises an amount of the one or more viable or non-viable antimicrobial microorganisms, or conditioned media or supernatants thereof, that prevents, inhibits, delays, limits or slows microorganism growth on agricultural products compared to agricultural products that were not treated with the composition containing the one or more antimicrobial microorganisms. Microorganism growth assays can include culturing assays, transcriptomic analysis, proteomic analysis, or protein analysis. Culturing assays can, for example, include assessing growth of the microorganism to be inhibited in the presence or absence of the antimicrobial microorganism. Transcriptomic analysis can, for example, include whole transcriptomic analysis or targeted analysis, such as reverse-transcription PCR, quantitative PCR, northern blot, RNA blot, or other methods to assay the presence or abundance of RNA transcripts associated with the inhibition, prevention, delay, or slowing of microorganism growth. Proteomic analysis can, for example, include whole proteomic analysis or targeted protein analysis, such as western blot, liquid chromatography, or other methods to assay the presence or abundance of proteins associated with inhibition, prevention, delay, or slowing of microorganism growth.

In some embodiments, antimicrobial microorganisms can be non-viable. In some embodiments, antimicrobial microorganisms are lysed. Antimicrobial microorganisms can be lysed by chemical, acoustic, or mechanical methods. Chemical methods of cell lysis can include osmotic lysis and the use of chelating agents such as ethylenediaminetetraacetic acid (EDTA), surfactants, and chaotropic agents such as urea or guanidine. Acoustic methods of cell lysis can include sonication. Mechanical methods of cell lysis can include liquid-based homogenization by forcing the cell culture through a narrow space, such as a needle or French press, shearing the cell membranes, freeze-thaw cycles in which the expansion during freezing and formation of ice crystals lyse the cells.

In some embodiments, the composition comprises a plurality of antimicrobial microorganisms and one or more fatty acid derivatives (e.g., one or more fatty acids, one or more fatty acid esters, or combinations thereof, and one or more fatty acid salts), which can be applied to an agricultural product, e.g., as a coating. The antimicrobial microorganism and the fatty acid derivative can be applied to an agricultural product together or separately.

In some embodiments, the antimicrobial microorganism and the fatty acid derivative can be applied sequentially. For example, the antimicrobial microorganism can be applied to the agricultural product and then the fatty acid derivative can be applied to the agricultural product. In some embodiments, applying the antimicrobial microorganism separately from the fatty acid derivative may prevent damage to the antimicrobial organism in the blending process, such as damage due to heat, osmotic stress, mechanical damage, pH, or removal of required enzymatic cofactors.

Any of the antimicrobial microorganisms described herein and/or the fatty acid derivative described herein can be combined with additional coatings agents or coating components, for example, to increase composition stability, durability, ease of use, or effectiveness at preventing, inhibiting, delaying or slowing growth of food-spoilage microorganisms such as fungi.

In some embodiments, the compositions comprise one or more fatty acid derivatives. In some embodiments, the one or more fatty acid derivatives comprise one or more fatty acids, one or more fatty acid esters, or a combination thereof. In some embodiments, the one or more fatty acid derivatives comprise one or more fatty acid salts.

In some embodiments, the composition comprises one or more compounds of Formula IA, Formula IA-A, Formula IA-A-i, Formula IA-A-ii, Formula IA-B, Formula IIA, or any combination thereof.

In some embodiments, when the composition comprises two or more compounds of Formula IA, Formula IA-A, Formula IA-A-i, Formula IA-A-ii, Formula IA-B, and/or Formula IIA, the weight ratio of the two compounds is from about 1:1 to about 10:1.

In some embodiments, the composition comprises from about 40% to about 100% by weight of the one or more compounds of Formula IA, Formula IA-A, Formula IA-A-i, Formula IA-A-ii, and Formula IA-B.

In some embodiments, when the composition comprises two compounds of Formula IA, Formula IA-A, Formula IA-A-i, Formula IA-A-ii, and/or Formula IA-B (for example, two compounds of Formula IA-A-i, two compounds of Formula IA-A-ii, or one compound of Formula IA-A-i and one compound of Formula IA-A-i), each compound is independently from about 0.10% to about 99% by weight of the composition. In some embodiments, when the composition comprises two compounds of Formula IA, Formula IA-A, Formula IA-A-i, Formula IA-A-ii, and/or Formula IA-B (e.g., two compounds of Formula IA-A-i, two compounds of Formula IA-A-ii, or one compound of Formula IA-A-i and one compound of Formula IA-A-i), the molar ratio or weight ratio of the two compounds is from about 350:1 to about 1:10.

In some embodiments, the composition comprises from about 1% to about 50% by weight of the one or more compounds (e.g., one or two) of Formula IIA. In some embodiments, when the composition comprises two compounds of Formula IIA, the molar ratio or weight ratio of the two compounds is from about 1:20 to about 20:1.

In some embodiments, when the composition comprises two compounds of Formula IIA, each compound is independently from about 1% to about 49% by weight of the composition.

In some embodiments, when the composition comprises a compound of Formula IA-A-i and a compound of Formula IA-A-ii, the weight or molar ratio of the compound of Formula IA-A-i to the compound of Formula IA-A-ii is from about 1:10 to about 10:1. In some embodiments, the weight or molar ratio of the compound of Formula IA-A-ii to the compound of Formula IA-A-i is from about 1:10 to about 10:1.

In some embodiments, when the composition comprises two compounds of Formula IA-A-i, the weight or molar ratio of one of the compounds of Formula IA-A-i to the other of the compounds of Formula IA-A-i is from about 1:10 to about 10:1.

In some embodiments, when the composition comprises two compounds of Formula IA-A-ii, the weight or molar ratio of one of the compounds of Formula IA-A-ii to the other of the compounds of Formula IA-A-ii is from about 1:10 to about 10:1.

In some embodiments, the composition comprises a compound of Formula IA-A-i and a compound of Formula IIA. In some embodiments, the weight or molar ratio of the compound of Formula IA-A-i to the compound of Formula IIA is from about 30:1 to about 1:1. In some embodiments, the composition comprises about 40% to about 100% by weight of the compound of Formula IA-A-i. In some embodiments, the composition comprises about 1% to about 50% by weight of the compound of Formula IIA.

In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IA-A-i is 2,3-dihydroxypropan-1-yl octadecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IIA is sodium stearate. In some embodiments, the composition comprises about 70% 2,3-dihydroxypropan-1-yl octadecanoate and about 30% sodium stearate. In some embodiments, the composition comprises about 94% 2,3-dihydroxypropan-1-yl octadecanoate and about 6% sodium stearate. In some embodiments, the composition comprises 2,3-dihydroxypropan-1-yl octadecanoate and sodium stearate in a weight ratio of about 70:30 or about 94:6. In some embodiments, the composition further comprises citric acid, sodium bicarbonate, or both. In some embodiments, the composition comprises citric acid and sodium bicarbonate. In some embodiments, the molar ratio of the citric acid to sodium bicarbonate is from about 1:5 to about 1:1. In some embodiments, the weight percentage of citric acid in the composition is from about 0.2% to about 2. In some embodiments, the collective weight percentage of citric acid and sodium bicarbonate in the composition is from about 0.2% to about 2%.

In some embodiments, the composition comprises a compound of Formula IA-A-i and two compounds of Formula IIA. In some embodiments, the weight or molar ratio of the compound of Formula IA-A-i to both compounds of Formula IIA is from about 30:1 to about 1:1. In some embodiments, the weight or molar ratio of one compound of Formula IIA to the other compound of Formula IIA is from about 1:20 to about 20:1. In some embodiments, the composition comprises about 40% to about 100% by weight of the compound of Formula IA-A-i.

In some embodiments, the composition comprises about 1% to about 50% by weight of both compounds of Formula IIA. In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A} and R^{11B} is H; and the sum of o and p is from 11 to 13. For example, the compound of Formula IA-A-i is 2,3-dihydroxypropan-1-yl octadecanoate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. In some embodiments, the sum of o and p in one compound of Formula IIA is 13 and the sum of o and p in the other compound of Formula IIA is 11. For example, one compound of Formula IIA is sodium stearate and the other compound of Formula IIA is sodium palmitate. In some embodiments, the composition comprises about 70% 2,3-dihydroxypropan-1-yl octadecanoate and about 30% of sodium stearate and sodium palmitate in about a weight ratio of about 1:2 to about 2:1. In some embodiments, the composition comprises about 94% 2,3-dihydroxypropan-1-yl octadecanoate and about 6% sodium stearate and sodium palmitate about a 1:2 to about a 2:1 weight ratio. In some embodiments, the composition further comprises citric acid, sodium bicarbonate, sodium carbonate, or a combination thereof. In some embodiments, the molar ratio of the citric acid to sodium bicarbonate is from about 10:1 to about 1:2. In some embodiments, the molar ratio of the citric acid to sodium carbonate is from about 10:1 to about 1:2. In some embodiments, the weight percentage of citric acid in the composition is from about 0.2% to about 2%. In some embodiments, the weight percentage of sodium bicarbonate in the composition is from about 0.2% to about 2%. In some embodiments, the collective weight percentage of citric acid and sodium bicarbonate in the composition is from about 0.2% to about 2%.

In some embodiments, the composition comprises a first compound of Formula IA-A-i, a second compound of Formula IA-A-i, and one compound of Formula IIA. In some embodiments, the weight or molar ratio of the compound of both compounds of Formula IA-A-i to the compound of Formula IIA is from about 30:1 to about 1:1. In some embodiments, the weight or molar ratio of one compound of Formula IA-A-i to the other compound of Formula IA-A-i is from about 1:20 to about 20:1. In some embodiments, the composition comprises about 40% to about 100% by weight of both compounds of Formula IA-A-i. In some embodiments, the composition comprises about 1% to about 50% by weight of the compound of Formula IIA. In some embodiments, the composition comprises from about 25% to about 75% of the first compound of Formula IA-A-i, from about 25% to about 75% of the second compound of Formula IA-A-i, and from about 1% to about 40% of the compound of Formula IIA. In some embodiments, the composition comprises from about 75% to about 99% of the first compound of Formula IA-A-i, from about 0.1% to about 20% of the second compound of Formula IA-A-i, and about 1% to about 10% of the compound of Formula IIA. In some embodiments, in one compound of Formula IA-A-i, R^{A1} and R^{A2} are H; R¹, R², R³, R⁴, R⁵, R⁶, R⁷, R⁸, and R⁹ are independently selected from H and OH; each occurrence of R^{1A}, R^{10B}, R^{11A}, and R^{11B} is H; and the sum of o and p is from 11 to 13. In some embodiments, in the other compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 7 to 9. For example, one compound of Formula IA-A-i is 2,3-dihydroxypropan-1-yl octadecanoate and the other compound of Formula IA-A-i is 2,3-dihydroxypropan-1-yl dodecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IIA is sodium stearate. In some embodiments, the composition comprises about 70% 2,3-dihydroxypropan-1-yl octadecanoate and 2,3-dihydroxypropan-1-yl dodecanoate in a 1:1 weight ratio and about 30% of sodium stearate. In some embodiments, the composition comprises about 94% 2,3-dihydroxypropan-1-yl octadecanoate and 2,3-dihydroxypropan-1-yl dodecanoate in a 1:1 weight ratio and about 6% sodium stearate. In some embodiments, the composition comprises 2,3-dihydroxypropan-1-yl octadecanoate, 2,3-dihydroxypropan-1-yl dodecanoate, and sodium stearate in a weight ratio of about 35:35:30 or about 47:47:6. In some embodiments, the composition further comprises citric acid, sodium bicarbonate, or both. In some embodiments, the molar ratio of the citric acid to sodium bicarbonate is from about 1:5 to about 1:1. In some embodiments, the weight percentage of citric acid in the composition is from about 0.2% to about 2%. In some embodiments, the weight percentage of sodium bicarbonate in the composition is from about 0.2% to about 2%. In some embodiments, the collective weight percentage of citric acid and sodium bicarbonate in the composition is from about 0.2% to about 2%.

In some embodiments, the composition comprises a first compound of Formula IA-A-i, a second compound of Formula IA-A-i, a first compound of Formula IIA, and a second compound of Formula IIA. In some embodiments, the weight or molar ratio of the compound of both compounds of Formula IA-A-i to both compounds of Formula IIA is from about 30:1 to about 1:1. In some embodiments, the weight or molar ratio of one compound of Formula IA-A-i to the other compound of Formula IA-A-i is from about 1:20 to about 20:1. In some embodiments, the weight or molar ratio of one compound of Formula IIA to the other compound of Formula IIA is from about 1:20 to about 20:1. In some embodiments, the composition comprises about 40% to about 100% by weight of both compounds of Formula IA-A-i. In some embodiments, the composition comprises about 1% to about 50% by weight of both compounds of Formula IIA. In some embodiments, the composition comprises from about 25% to about 75% of the first compound of Formula IA-A-i, from about 25% to about 75% of the second compound of Formula IA-A-i, from about 1% to about 30% of the first compound of Formula IIA, and from about 1% to about 30% of the second compound of Formula IIA. In some embodiments, in each compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, one compound of Formula IA-A-i is 2,3-dihydroxypropan-1-yl octadecanoate and the other compound of Formula IA-A-i is 2,3-dihydroxypropan-1-yl palmitate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}R^{11A} and R^{11B} is H; and the sum of o and p is from 11 to 13. In some embodiments, the sum of o and p in one compound of Formula IIA is 13 and the sum of o and p in the other compound of Formula IIA is 11. For example, one compound of Formula IIA is sodium stearate and the other compound of Formula IIA is sodium palmitate. In some embodiments, the composition comprises about 70% 2,3-dihydroxypropan-1-yl octadecanoate and 2,3-dihydroxypropan-1-yl palmitate in an about 1:1 weight ratio and about 30% of sodium stearate and sodium palmitate in an about 1:1 weight ratio. In some embodiments, the composition comprises about 94% 2,3-dihydroxypropan-1-yl octadecanoate and 2,3-dihydroxypropan-1-yl palmitate in an about 1:1 weight ratio and about 6% of sodium stearate and sodium palmitate in an about 1:1 weight ratio. In some embodiments, the composition comprises 2,3-dihydroxypropan-1-yl octadecanoate, 2,3-dihydroxypropan-1-yl palmitate, sodium stearate, and sodium palmitate in a weight ratio of about 35:35:15:15 or about 47:47:3:3. In some embodiments, the composition further comprises citric acid, sodium bicarbonate, or both. In some embodiments, the molar ratio of the citric acid to sodium bicarbonate is from about 1:5 to about 1:1. In some embodiments, the weight percentage of citric acid in the composition is from about 0.2% to about 2%. In some embodiments, the weight percentage of sodium bicarbonate in the composition is from about 0.2% to about 2%. In some embodiments, the collective weight percentage of citric acid and sodium bicarbonate in the composition is from about 0.2% to about 2%.

In some embodiments, less than 10% by weight of the composition is diglycerides. In some embodiments, less than 10% by weight of the composition is triglycerides. In some embodiments, the composition does not comprise an acetylated monoglyceride (e.g., a monoglyceride wherein the hydroxyl groups of the glyceryl moiety are acetylated).

In some embodiments, the composition can be dissolved, mixed, dispersed, or suspended in a solvent to form a mixture (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water.

The concentration of the composition in the solution or mixture (e.g., solution, suspension, or colloid) is from about 1 mg/mL to about 200 mg/mL.

In order to improve the solubility of the coating agent in the solvent, or to allow the coating agent to be suspended or dispersed in the solvent, the coating agent can further include an emulsifier, as described below. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating.

Further, organic salts, such as the fatty acid salts as described herein, can increase the solubility of the coating agent or allow the coating agent to be suspended or dispersed in solvents having a substantial water content (e.g., solvents that are at least 50% water by volume), provided that the concentration of the salts is not too low relative to the fatty acids and/or esters thereof.

The coating solutions/suspensions/colloids can further include a wetting agent that serves to reduce the contact angle (e.g., an angle of the outer surface of a droplet of the liquid measured where the liquid-vapor interface meets the liquid-solid interface) between the solution/suspension/colloid and the surface of the substrate being coated. The wetting agent can be included as a component of the coating agent and therefore added to the solvent at the same time as other components of the coating agent. Alternatively, the wetting agent can be separate from the coating agent and can be added to the solvent either before, after, or at the same time as the coating agent. Alternatively, the wetting agent can be separate from the coating agent, and can be applied to a surface before the coating agent in order to prime the surface.

The wetting agent can be a fatty acid or salt or ester thereof, e.g., a compound of Formula I, Formula II, and all subformulas described herein. In particular, the wetting agent compounds can each have a carbon chain length of 13 or less. The wetting agent can also or alternatively be one or more of a phospholipid, a lysophospholipid, a glycoglycerolipid, a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatly alcohol derivative (e.g., an alkyl sulfate). In some embodiments, the wetting agents included in the mixtures herein are edible and/or safe for consumption.

In some embodiments, compounds used as wetting agents can also (or alternatively) be used as emulsifiers. For example, in some embodiments, a medium chain fatty acid (e.g., having a carbon chain length of 7 to 13) or salt or ester thereof is used as an emulsifier (and optionally also functions as a wetting agent) in the composition, thereby enabling the composition to be dissolved or suspended in the solvent. In some embodiments, the emulsifier is cationic. In some embodiments, the emulsifier is anionic, zwitterionic, or uncharged.

In some embodiments, the composition comprises one or more (e.g., 1, 2, or 3) wetting agents, surfactants, and/or emulsifiers. In some embodiments, the one or more wetting agents, surfactants, and/or emulsifiers comprise sodium bicarbonate, citric acid, cetyl trimethylammonium bromide, sodium lauryl sulfate, ammonium lauryl sulfate, sodium laureth sulfate, sodium myreth sulfate, docusate, sodium dodecyl sulfate, sodium stearate, sodium lauroyl sarcosinate, alkyl-aryl ether phosphates, alkyl ether phosphates, 2-[4-(2,4,4-trimethylpentan-2-yl)phenoxy]ethanol (Triton X-100), 3-[(3-Cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, cocamide diethanolamine, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, fatty acid esters of sucrose, alkyl polyglucosides, alkyl polyglycoside, decyl glucoside, lauryl glucoside, octyl glucoside, fatty acid esters of sucrose, sucrose monostearate, sucrose distearate, sucrose tristearate, sucrose polystearate, sucrose monopalmitate, sucrose dipalmitate, sucrose tripalmitate, sucrose polypalmitate, sucrose monomyristate, sucrose dimyristate, sucrose trimyristate, sucrose polymyristate, sucrose monolaurate, sucrose dilaurate, sucrose trilaurate, sucrose polylaurate, polysiloxane polyether copolymer (e.g., from Hi-Wett), polyethylene glycol, alcohol polyethylene glycol, or polyoxyethylene-polyoxypropylene copolymer. In some embodiments, one or more wetting agents, surfactants, and/or emulsifiers may comprise microbially-derived constituents or materials. For example, the one or more wetting agents, surfactants, and/or emulsifiers comprises sodium lauryl sulfate.

In some embodiments, the composition comprises a component for adjusting electrolyte concentration (e.g., sodium bicarbonate), a co-surfactant (e.g., citric acid), or both.

In some embodiments, the mixture or composition comprises from about 0.1% to about 40% by weight of the one or more wetting agents, surfactants, and/or emulsifiers.

In some embodiments, the mixture or composition comprises one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylatedhydroxyanisole (BHA), butylatedhydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzoic acid, sorbic acid, methyl paraben, propyl paraben, bronidol, propylene glycol, and siderophores.

In some embodiments, the mixture or composition comprises from about 0.1% to about 40% by weight of the one or more preservatives.

Any of the compositions described herein can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antimicrobials, time-released drugs, and/or an additional antimicrobial agents or microorganisms. The additional materials can be non-reactive with surface of the coated product and/or coating, or alternatively can be reactive with the surface and/or coating.

In some embodiments, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultraviolet (UV) light, for example to protect the agricultural product. In some embodiments, the additive can be configured to provide an intentional odor, for example a fragrance (e.g., smell of flowers, fruits, plants, freshness, scents, etc.). In some embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located on the World Wide Web at “accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be selected or configured to be washed off an edible agricultural product, for example, with water. In some embodiments, the coating can include an FDA approved drug ingredient, for example, any ingredient included in the FDA's database of approved drugs, which can be found on the World Wide Web at “accessdata.fda.gov/scripts/cder/drugsatfda/index.cfm”, the entire contents of which are hereby incorporated herein by reference. In some embodiments, the coating can include materials that satisfy FDA requirements to be used in drugs or are listed within the FDA's National Drug Discovery Code Directory, on the World Wide Web at “accessdata.fda.gov/scripts/cder/ndc/default.cfm”, the entire contents of which are hereby incorporated herein by reference. In some embodiments, the materials can include inactive drug ingredients of an approved drug product as listed within the FDA's database, on the World Wide Web at “accessdata.fda.gov/scripts/cder/ndc/default.cfm”, the entire contents of which are hereby incorporated herein by reference.

Any of the coating agents or coatings formed thereof that are described herein can be flavorless or have high flavor thresholds, e.g., above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

It can be desirable for the coatings to be undetectable to the human eye, and/or to not cause any detectable changes in the physical appearance of the coated agricultural product. For example, coatings that precipitate or crystallize upon formation, or otherwise leave a residue upon the surface of the coated agricultural product, can cause the coated agricultural product to appear soiled or damaged. The coated product may appear less desirable to a consumer as compared to a similar uncoated product. As such, in many cases it is further desirable that the coating also not leave a visible residue and/or alter the physical appearance, including the odor, of the coated product.

In some embodiments, the coating can include an additive configured, for example, to modify the viscosity, vapor pressure, surface tension, or solubility of the coating. In some embodiments, the additive can be configured to increase the chemical stability of the coating. For example, the additive can be an antioxidant configured to inhibit oxidation of the coating. In some embodiments the additive can be added to reduce or increase the melting temperature or the glass-transition temperature of the coating. In some embodiments, the additive can be configured to reduce the diffusivity of water vapor, oxygen, CO₂, or ethylene through the coating or enable the coating to absorb more ultraviolet (UV) light, for example to protect the agricultural product (e.g., any of the products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive. In some embodiments, the additives can include sweeteners, color additives, flavors, spices, flavor enhancers, fat replacers, and components of formulations used to replace fats, nutrients, emulsifiers, bulking agents, cleansing agents, stabilizers, emulsion stabilizers, thickeners, flavor or fragrance, an ingredient of a flavor or fragrance, binders, texturizers, humectants, pH control agents, acidulants, leavening agents, anti-caking agents, antifungal agents, antimicrobial agents, antioxidants, and/or UV filters. In some embodiments, the coating can include a photoinitiator, which can initiate crosslinking of the coating on exposure to an appropriate light source, for example, UV light.

In some embodiments, the composition further comprises one or more additives. For example, the additives can include water, a stabilizer, a buffer, an essential oil, a preservative, a vitamin, a mineral, a pigment, an aroma, an enzyme, a catalyst, an antioxidant, or a combination thereof. In some embodiments, the one or more additives alter the taste, look, texture, smell, or durability of the composition.

In some embodiments, the stabilizer is alginic acid, agar, carrageenan, gelatin, pectin, or combinations thereof.

In some embodiments, the buffer is a citrate salt, a phosphate salt, a tartrate salt, or combinations thereof.

In some embodiments, the essential oil is African basil, bishop's weed, cinnamon, clove, coriander, cumin, garlic, kaffir lime, lime, lemongrass, mustard oil, menthol, oregano, rosemary, savory, Spanish oregano, thyme, anise, ginger, bay leaf, sage, bergamot, eucalyptus, melaleuca, peppermint, spearmint, wintergreen, cannabis, marjoram, orange, rose, other plant-derived oils, or combinations thereof.

In some embodiments, the preservative is a nitrite derivative or salt thereof, a sulfite derivative or salt thereof, a benzoate derivative or salt thereof, or combinations thereof. In some embodiments, the preservative is butylated hydroxyanisole, butylated hydroxytoluene, or combinations thereof.

In some embodiments, the vitamin is vitamin A or derivatives thereof, vitamin B or derivatives thereof, vitamin C or derivatives thereof, vitamin D or derivatives thereof, vitamin E or derivatives thereof, or combinations thereof.

In some embodiments, the mineral is a macromineral, a trace mineral, or combinations thereof. In some embodiments the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof.

In some embodiments, the enzyme is an enzyme preparation such as a decarboxylase, an aminopeptidase, an amylase, an asparaginase, a carboxypeptidase, a catalase, a cellulase, a chymosin, a cyprosin, a ficin, a glucanase, an isomerase, a glutaminase, an invertase, a lactase, a lipase, a lyase, a lysozyme, a mannase, an oxidase, a pectinase, a peptidase, a peroxidase, a phospholipase, a protease, a trypsin, a urease, chitinase, or combinations thereof.

In some embodiments, the antioxidant is an antioxidant vitamin, a tocopherol, a gallate or derivative thereof, or combinations thereof. In some embodiments, the antioxidant is 4-hexylresorcinol ascorbic acid or a fatty acid ester thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the coatings are tasteless, colorless, and/or odorless. In some embodiments, the coating can be flavorless or have a high flavor threshold of below 500 ppm, are odorless or have a high odor threshold, and/or are substantially transparent.

In some embodiments, the coatings are made from the same chemical feedstocks that are naturally found in the plant cuticle (e.g., hydroxy and/or dihydroxy palmitic acids, and/or hydroxy or epoxy oleic and stearic acids) and can thus be organic and all-natural.

### Fatty Acid Derivatives

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the composition comprises from about 40% to about 100% by weight of the one or more fatty acids, fatty acid esters, or a combination thereof. For example, the composition comprises from about 40% to 50%, 50% to 60%, 60% to 70%, 70% to 80%, 80% to 90%, 90% to 100%, 65% to 99% by weight of the one or more fatty acids, fatty acid esters, or a combination thereof.

In some embodiments, the composition comprises from about 1% to about 50% by weight of the one or more fatty acid salts. In some embodiments, when the composition comprises two fatty acid salts, the molar ratio or weight ratio of the two fatty acid salts is from about 1:20 to about 20:1.

In some embodiments, the composition comprises from about 70% to about 99% by weight of the one or more fatty acids, fatty acid esters, or a combination thereof (e.g., one or two); and from about 1% to about 30% by weight of the one or more fatty acid salts (e.g., one or two). In some embodiments, the composition comprises one or more fatty acid esters (e.g., one or two) and one or more fatty acid salts (e.g., one or two) in a weight ratio of about 70:30 to about 94:6 (e.g., 70:30 or 94:6).

In some embodiments, the composition comprises from about 60% to about 99.99% by weight of the one or more fatty acids, fatty acid esters, or a combination thereof (e.g., one or two); and from about 0.01% to about 40% by weight of the one or more fatty acid salts (e.g., one or two). In some embodiments, the composition comprises one or more fatty acid esters (e.g., one or two) and one or more fatty acid salts (e.g., one or two) in a weight ratio of about 60:40 to about 99.99:0.01 (e.g., about 70:30 or about 94:6).

In some embodiments, each fatty acid and/or ester thereof is an independently selected compound of Formula IA:

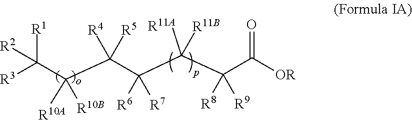

wherein:

R is selected from: H and C₁-C₆ alkyl optionally substituted with one or more of OH and C₁-C₆ alkoxy;

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R^{11A}, and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and

o is an integer from 0 to 17;

p is an integer from 0 to 17;

wherein the sum of o and p is from 0 to 17;

or a salt thereof when R is C₁-C₆ alkyl optionally substituted with one or more of OH and C₁-C₆ alkoxy.

In some embodiments, R is H.

In some embodiments, R is C₁-C₆ alkyl optionally substituted with one or more OH or C₁-C₆ alkoxy. In some embodiments, R is C₁-C₆ alkyl optionally substituted with one or more OH. In some embodiments, R is C₁-C₆ alkyl optionally substituted with two OH. In some embodiments, R is C₁-C₃ alkyl optionally substituted with one or more OH. In some embodiments, R is C₁-C₃ alkyl optionally substituted with two OH. In some embodiments, R is propyl optionally substituted with one or more OH. In some embodiments, R is propyl optionally substituted with two OH. In some embodiments, R is 1,3-dihydroxy-2-propyl. In some embodiments, R is 1,2-dihydroxy-1-propyl.

In some embodiments, R is C₁-C₆ alkyl optionally substituted with one or more C₁-C₆ alkoxy. In some embodiments, R is C₁-C₆ alkyl optionally substituted with two C₁-C₆ alkoxy. In some embodiments, R is C₁-C₃ alkyl optionally substituted with one or more C₁-C₆ alkoxy. In some embodiments, R is C₁-C₃ alkyl optionally substituted with two C₁-C₆ alkoxy.

In some embodiments, the compound of Formula IA is a compound of Formula IA-A:

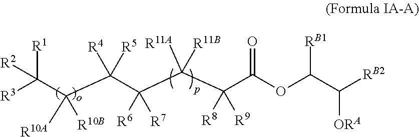

or a salt thereof,

wherein:

one of R^{B1} and R^{B2} is H, and the other of R^{B1} and R^{B2} is —CH₂OR^{A};

each occurrence of R^{A} is independently selected from H and C₁-C₆ alkyl;

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R^{11A}, and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{B1} is H and R^{B2} is —CH₂OR^{A}.

In some embodiments, R^{B1} is —CH₂OR^{A} and R^{B2} is H.

In some embodiments, each R^{A} is H. In some embodiments, one R^{A} is H and the other R^{A} is C₁-C₆ alkyl. In some embodiments, each R^{A} is C₁-C₆ alkyl. In some embodiments, each R^{A} is C₁-C₆ alkyl.

In some embodiments, the compound of Formula IA-A is a compound of Formula IA-A-i:

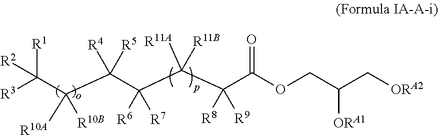

or a salt thereof,

wherein:

R^{A1} and R^{A2} are independently selected from H and C₁-C₆ alkyl;

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R^{11A}, and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{A1} is H and R^{A2} is C₁-C₆ alkyl. In some embodiments, R^{A1} is C₁-C₆ alkyl and R^{A2} is H. In some embodiments, R^{A1} and R^{A2} are H.

In some embodiments, the compound of Formula IA-A is a compound of Formula IA-A-ii:

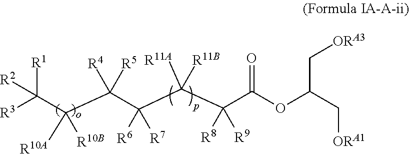

or a salt thereof,

wherein:

R^{A1} and R^{A3} are independently selected from H and C₁-C₆ alkyl;

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R^{11A} and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{A1} is H and R^{A3} is C₁-C₆ alkyl. In some embodiments, R^{A1} is C₁-C₆ alkyl and R^{A3} is H. In some embodiments, R^{A1} and R^{A3} are H.

In some embodiments, the compound of Formula IA is a compound of Formula IA-B:

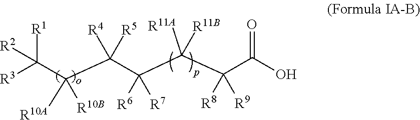

wherein:

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R_{11A}, and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, the compounds of Formula (IA) comprise C₁₄-C₂₂ monoacylglycerols. Examples include glyceryl laurate, glyceryl monostearate, glyceryl palmitate, glyceryl monooleate, and glyceryl hydroxystearate. In some embodiments, the compound of Formula (IA) is glyceryl monostearate.

In some embodiments, each fatty acid salt is an independently selected compound of Formula II:

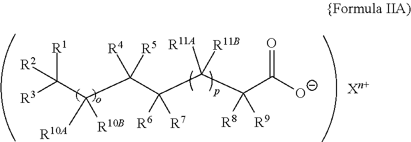

wherein:

R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;

each occurrence of R^{10A}, R^{10B}, R^{11A}, and R^{11B} is independently selected from: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17;

wherein the sum of o and p is from 0 to 17;

Xⁿ⁺ is a cationic moiety having formal charge n; and

each occurrence of R′ is selected from H and C₁-C₆ alkyl.

In some embodiments, Xⁿ⁺ is selected from Na⁺, K⁺, Ag⁺, Ca²⁺, Mg²⁺, Zn²⁺, Cu²⁺, and (R′)₄N⁺.

In some embodiments, each R′ is an independently selected C₁-C₆ alkyl. In some embodiments, one R′ is H and the other three R′ are independently selected C₁-C₆ alkyl. In some embodiments, two R′ are H and the other two R′ are independently selected C₁-C₆ alkyl. In some embodiments, three R′ are H and the other R′ is C₁-C₆ alkyl. In some embodiments, each R′ is H. In some embodiments, each R′ is benzyl trimethyl ammonium.

In some embodiments, at least one R′ is a cyclic amine (e.g., substituted or unsubstituted heterocyclic amines, including heteroalkyl amines and heteroaromatic amines). Examples include morpholine, pyridine, aziridine, and piperidine.

In some embodiments, Xⁿ⁺ is selected from Na⁺, K⁺, Ag⁺, Ca²⁺, Mg²⁺, and Zn²⁺. In some embodiments, Xⁿ⁺ is selected from Na⁺, K⁺, Ca²⁺, Mg²⁺, and Zn²⁺. In some embodiments, Xⁿ⁺ is Na⁺. In some embodiments, Xⁿ⁺ is K⁺. In some embodiments, Xⁿ⁺ is Ca²⁺. In some embodiments, Xⁿ⁺ is Mg²⁺. In some embodiments, Xⁿ⁺ is Zn².

In some embodiments, R¹, R², R³, R⁴, R⁵, R⁶, R⁷, R⁸, and R⁹ are independently selected from: H, OH, C₁-C₆ alkyl, and C₁-C₆ alkoxy. In some embodiments, R¹, R², R³, R⁴, R⁵, R⁶, R⁷, R⁸, and R⁹ are independently selected from: H, OH, and C₁-C₆ alkyl. In some embodiments, R¹, R², R³, R⁴, R⁵, R⁶, R⁷, R⁸, and R⁹ are independently selected from: H and OH. In some embodiments, R¹, R², R³, R⁴, R⁵, R⁶, R⁷, R⁸, and R⁹ are each H. In some embodiments, one of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H. In some embodiments, two of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H.

In some embodiments, R⁴ is OH. In some embodiments, R⁵ is OH. In some embodiments, R⁶ is OH. In some embodiments, R⁷ is OH.

In some embodiments, each occurrence of R^{10A}, R^{10B}, R^{11A}, and R^{11B} is independently selected from: H, OH, C₁-C₆ alkyl, and C₁-C₆ alkoxy. In some embodiments, each occurrence of R^{10A}, R^{10B}, R^{11A}, and R^{11B} is independently selected from: H, OH, and C₁-C₆ alkyl. In some embodiments, each occurrence of R^{10A}, R^{10B}, R^{11A}, and R^{11B} is independently selected from: H and OH. In some embodiments, each occurrence of R^{10A}, R^{10B}, R^{11A}, and R^{11B} is each H. In some embodiments, one of each occurrence of R^{10A}, R^{10B}, R^{11A} and R^{11B} is OH and the remaining occurrences of R^{10A}, R^{10B}, R^{11A}, and R^{11B} are each H. In some embodiments, two of each occurrence of R^{10A}, R^{10B}, R^{11A}, and R^{11B} is OH and the remaining occurrences of R^{10A}, R^{10B}, R^{11A} and R^{11B} are each H.

In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond. In some embodiments, any two pairs of R¹, R², R³, R⁴, R⁵, R⁶, R⁷, R⁸, R⁹, R^{10A}, R^{10B}, R^{11A}, and R^{11B} on adjacent carbon atoms are each taken together with the carbon atoms to which they are attached to form two double bonds. In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, and any two remaining R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, the 3- to 6-membered ring heterocycle is oxiranyl.

In some embodiments, R⁴ is taken together with R⁶ and the carbon atoms to which they are attached to form a double bond. In some embodiments, R⁴ is taken together with R⁶ and the carbon atoms to which they are attached to form a 3- to 6-membered ring heterocycle.

In some embodiments, one of R¹, R², R³, R⁴, R⁵, R⁶, R⁷, R⁸, R⁹, and each occurrence of R^{10A}, R^{10B}, R^{11A}, and R^{11B} is OH; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxiranyl; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxiranyl.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond.

In some embodiments, the sum of o and p is from 0 to 13. In some embodiments, the sum of o and p is 1, 2, 3, 4, 5, 6, 7, 8, 9, 10, 11, 12, 13, 14, 15, 16, or 17. Without wishing to be bound by theory, it is believed that compounds of Formula IA-A wherein the sum of o and p is 0 to 9 are able to function as wetting agents when included in the compositions (e.g., mixtures, coatings, and coating agents) described herein, thus increasing the aptitude of the compositions (e.g., mixtures, coatings, and coating agents) to spread over the surface of an agricultural product or plant to form a coating of substantially uniform thickness.

In some embodiments, the compound of Formula IA is selected from heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid, 9-hydroxyhexadecanoic acid, 10-hydroxyhexadecanoic acid, 9,10-dihydroxyhexadecanoic acid, 16-hydroxyhexadecanoic acid, 9,16-dihydroxyhexadecanoic acid, 10,16-dihydroxyhexadecanoic acid, 9,10,16-trihydroxyhexadecanoic acid, 9,10-epoxyhexadecanoic acid, (9Z)-hexadec-9-enoic acid, (9E)-hexadec-9-enoic acid, 9,10-epoxy-16-hydroxyhexadecanoic acid, 16-hydroxy-(9Z)-hexadec-9-enoic acid, 16-hydroxy-(9E)-hexadec-9-enoic acid, 9-hydroxyoctadecanoic acid, 10-hydroxyoctadecanoic acid, 9,10-dihydroxyoctadecanoic acid, 18-hydroxyoctadecanoic acid, 9,18-dihydroxyoctadecanoic acid, 10,18-dihydroxyoctadecanoic acid, 9,10,18-trihydroxyoctadecanoic acid, 9,10-epoxyoctadecanoic acid, (9Z)-octadec-9-enoic acid, (9E)-octadec-9-enoic acid, 18-hydroxy-9,10-dihydroxyoctadecanoic acid, 18-hydroxy-(9Z)-octadec-9-enoic acid, 18-hydroxy-(9E)-octadec-9-enoic acid, (13Z)-docos-13-enoic acid, (13E)-docos-13-enoic acid, and any salt thereof.

In some embodiments, the compound of Formula IIA is selected from methyl heptanoate, methyl octanoate, methyl nonanoate, methyl decanoate, methyl undecanoate, methyl dodecanoate, methyl tridecanoic, methyl tetradecanoate, methyl pentadecanoate, methyl hexadecanoate, methyl heptadecanoate, methyl octadecanoate, methyl nonadecanoate, methyl eicosanoate, methyl heneicosanoate or docosanoate, methyl 9-hydroxyhexadecanoate, methyl 10-hydroxyhexadecanoate, methyl 9,10-dihydroxyhexadecanoate, methyl 16-hydroxyhexadecanoate, methyl 9,16-dihydroxyhexadecanoate, methyl 10,16-dihydroxyhexadecanoate, methyl 9,10,16-trihydroxyhexadecanoate, methyl 9,10-epoxyhexadecanoate, methyl (9Z)-hexadec-9-enoate, methyl (9E)-hexadec-9-enoate, methyl 9,10-epoxy-16-hydroxyhexadecanoate, methyl 16-hydroxy-(9Z)-hexadec-9-enoate, methyl 16-hydroxy-(9E)-hexadec-9-enoate, methyl 9-hydroxyoctadecanoate, methyl 10-hydroxyoctadecanoate, methyl 9,10-dihydroxyoctadecanoate, methyl 18-hydroxyoctadecanoate, methyl 9,18-dihydroxyoctadecanoate, methyl 10,18-dihydroxyoctadecanoate, methyl 9,10,18-trihydroxyoctadecanoate, methyl 9,10-epoxyoctadecanoate, methyl (9Z)-octadec-9-enoate, methyl (9E)-octadec-9-enoate, methyl 18-hydroxy-9,10-dihydroxyoctadecanoate, methyl 18-hydroxy-(9Z)-octadec-9-enoate, methyl 18-hydroxy-(9E)-octadec-9-enoate, methyl (13Z)-docos-13-enoate, and methyl (13E)-docos-13-enoate.

In some embodiments, the compound of Formula IIA is selected from ethyl heptanoate, ethyl octanoate, ethyl nonanoate, ethyl decanoate, ethyl undecanoate, ethyl dodecanoate, ethyl tridecanoic, ethyl tetradecanoate, ethyl pentadecanoate, ethyl hexadecanoate, ethyl heptadecanoate, ethyl octadecanoate, ethyl nonadecanoate, ethyl eicosanoate, ethyl heneicosanoate or docosanoate, ethyl 9-hydroxyhexadecanoate, ethyl 10-hydroxyhexadecanoate, ethyl 9,10-dihydroxyhexadecanoate, ethyl 16-hydroxyhexadecanoate, ethyl 9,16-dihydroxyhexadecanoate, ethyl 10,16-dihydroxyhexadecanoate, ethyl 9,10,16-trihydroxyhexadecanoate, ethyl 9,10-epoxyhexadecanoate, ethyl (9Z)-hexadec-9-enoate, ethyl (9E)-hexadec-9-enoate, ethyl 9,10-epoxy-16-hydroxyhexadecanoate, ethyl 16-hydroxy-(9Z)-hexadec-9-enoate, ethyl 16-hydroxy-(9E)-hexadec-9-enoate, ethyl 9-hydroxyoctadecanoate, ethyl 10-hydroxyoctadecanoate, ethyl 9,10-dihydroxyoctadecanoate, ethyl 18-hydroxyoctadecanoate, ethyl 9,18-dihydroxyoctadecanoate, ethyl 10,18-dihydroxyoctadecanoate, ethyl 9,10,18-trihydroxyoctadecanoate, ethyl 9,10-epoxyoctadecanoate, ethyl (9Z)-octadec-9-enoate, ethyl (9E)-octadec-9-enoate, ethyl 18-hydroxy-9,10-dihydroxyoctadecanoate, ethyl 18-hydroxy-(9Z)-octadec-9-enoate, ethyl 18-hydroxy-(9E)-octadec-9-enoate, ethyl (13Z)-docos-13-enoate, and ethyl (13E)-docos-13-enoate.

In some embodiments, the compound of Formula IIA is selected from 2,3-dihydroxypropan-1-yl heptanoate, 2,3-dihydroxypropan-1-yl octanoate, 2,3-dihydroxypropan-1-yl nonanoate, 2,3-dihydroxypropan-1-yl decanoate, 2,3-dihydroxypropan-1-yl undecanoate, 2,3-dihydroxypropan-1-yl dodecanoate, 2,3-dihydroxypropan-1-yl tridecanoic, 2,3-dihydroxypropan-1-yl tetradecanoate, 2,3-dihydroxypropan-1-yl pentadecanoate, 2,3-dihydroxypropan-1-yl hexadecanoate, 2,3-dihydroxypropan-1-yl heptadecanoate, 2,3-dihydroxypropan-1-yl octadecanoate, 2,3-dihydroxypropan-1-yl nonadecanoate, 2,3-dihydroxypropan-1-yl eicosanoate, 2,3-dihydroxypropan-1-yl heneicosanoate or docosanoate, 2,3-dihydroxypropan-1-yl 9-hydroxyhexadecanoate, 2,3-dihydroxypropan-1-yl 10-hydroxyhexadecanoate, 2,3-dihydroxypropan-1-yl 9,10-dihydroxyhexadecanoate, 2,3-dihydroxypropan-1-yl 16-hydroxyhexadecanoate, 2,3-dihydroxypropan-1-yl 9,16-dihydroxyhexadecanoate, 2,3-dihydroxypropan-1-yl 10,16-dihydroxyhexadecanoate, 2,3-dihydroxypropan-1-yl 9,10,16-trihydroxyhexadecanoate, 2,3-dihydroxypropan-1-yl 9,10-epoxyhexadecanoate, 2,3-dihydroxypropan-1-yl (9Z)-hexadec-9-enoate, 2,3-dihydroxypropan-1-yl (9E)-hexadec-9-enoate, 2,3-dihydroxypropan-1-yl 9,10-epoxy-16-hydroxyhexadecanoate, 2,3-dihydroxypropan-1-yl 16-hydroxy-(9Z)-hexadec-9-enoate, 2,3-dihydroxypropan-1-yl 16-hydroxy-(9E)-hexadec-9-enoate, 2,3-dihydroxypropan-1-yl 9-hydroxyoctadecanoate, 2,3-dihydroxypropan-1-yl 10-hydroxyoctadecanoate, 2,3-dihydroxypropan-1-yl 9,10-dihydroxyoctadecanoate, 2,3-dihydroxypropan-1-yl 18-hydroxyoctadecanoate, 2,3-dihydroxypropan-1-yl 9,18-dihydroxyoctadecanoate, 2,3-dihydroxypropan-1-yl 10,18-dihydroxyoctadecanoate, 2,3-dihydroxypropan-1-yl 9,10,18-trihydroxyoctadecanoate, 2,3-dihydroxypropan-1-yl 9,10-epoxyoctadecanoate, 2,3-dihydroxypropan-1-yl (9Z)-octadec-9-enoate, 2,3-dihydroxypropan-1-yl (9E)-octadec-9-enoate, 2,3-dihydroxypropan-1-yl 18-hydroxy-9,10-dihydroxyoctadecanoate, 2,3-dihydroxypropan-1-yl 18-hydroxy-(9Z)-octadec-9-enoate, 2,3-dihydroxypropan-1-yl 18-hydroxy-(9E)-octadec-9-enoate, 2,3-dihydroxypropan-1-yl (13Z)-docos-13-enoate, and 2,3-dihydroxypropan-1-yl (13E)-docos-13-enoate.

In some embodiments, the compound of Formula IIA is selected from 1,3-dihydroxypropan-2-yl heptanoate, 1,3-dihydroxypropan-2-yl octanoate, 1,3-dihydroxypropan-2-yl nonanoate, 1,3-dihydroxypropan-2-yl decanoate, 1,3-dihydroxypropan-2-yl undecanoate, 1,3-dihydroxypropan-2-yl dodecanoate, 1,3-dihydroxypropan-2-yl tridecanoic, 1,3-dihydroxypropan-2-yl tetradecanoate, 1,3-dihydroxypropan-2-yl pentadecanoate, 1,3-dihydroxypropan-2-yl hexadecanoate, 1,3-dihydroxypropan-2-yl heptadecanoate, 1,3-dihydroxypropan-2-yl octadecanoate, 1,3-dihydroxypropan-2-yl nonadecanoate, 1,3-dihydroxypropan-2-yl eicosanoate, 1,3-dihydroxypropan-2-yl heneicosanoate or docosanoate, 1,3-dihydroxypropan-2-yl 9-hydroxyhexadecanoate, 1,3-dihydroxypropan-2-yl 10-hydroxyhexadecanoate, 1,3-dihydroxypropan-2-yl 9,10-dihydroxyhexadecanoate, 1,3-dihydroxypropan-2-yl 16-hydroxyhexadecanoate, 1,3-dihydroxypropan-2-yl 9,16-dihydroxyhexadecanoate, 1,3-dihydroxypropan-2-yl 10,16-dihydroxyhexadecanoate, 1,3-dihydroxypropan-2-yl 9,10,16-trihydroxyhexadecanoate, 1,3-dihydroxypropan-2-yl 9,10-epoxyhexadecanoate, 1,3-dihydroxypropan-2-yl (9Z)-hexadec-9-enoate, 1,3-dihydroxypropan-2-yl (9E)-hexadec-9-enoate, 1,3-dihydroxypropan-2-yl 9,10-epoxy-16-hydroxyhexadecanoate, 1,3-dihydroxypropan-2-yl 16-hydroxy-(9Z)-hexadec-9-enoate, 1,3-dihydroxypropan-2-yl 16-hydroxy-(9E)-hexadec-9-enoate, 1,3-dihydroxypropan-2-yl 9-hydroxyoctadecanoate, 1,3-dihydroxypropan-2-yl 10-hydroxyoctadecanoate, 1,3-dihydroxypropan-2-yl 9,10-dihydroxyoctadecanoate, 1,3-dihydroxypropan-2-yl 18-hydroxyoctadecanoate, 1,3-dihydroxypropan-2-yl 9,18-dihydroxyoctadecanoate, 1,3-dihydroxypropan-2-yl 10,18-dihydroxyoctadecanoate, 1,3-dihydroxypropan-2-yl 9,10,18-trihydroxyoctadecanoate, 1,3-dihydroxypropan-2-yl 9,10-epoxyoctadecanoate, 1,3-dihydroxypropan-2-yl (9Z)-octadec-9-enoate, 1,3-dihydroxypropan-2-yl (9E)-octadec-9-enoate, 1,3-dihydroxypropan-2-yl 18-hydroxy-9,10-dihydroxyoctadecanoate, 1,3-dihydroxypropan-2-yl 18-hydroxy-(9Z)-octadec-9-enoate, 1,3-dihydroxypropan-2-yl 18-hydroxy-(9E)-octadec-9-enoate, 1,3-dihydroxypropan-2-yl (13Z)-docos-13-enoate, and 1,3-dihydroxypropan-2-yl (13E)-docos-13-enoate.

### Methods of Use

Any of the coatings described herein can be used to protect any agricultural product or plant, including various portions of the plants such as, for example, plant stems, shoots, flowers, fruits, leaves, seeds, roots, etc. In some embodiments, the coating can be coated on an edible agricultural product, for example, fruits, vegetables, edible seeds and nuts, herbs, spices, produce, meat, eggs, dairy products, seafood, grains, or any other consumable item. In some embodiments, coating can be coated on agricultural products selected from: an apple, an asparagus, an apricot, an avocado, a banana, a blueberry, a bayberry, a cherry, a clementine mandarin, a cucumber, a custard apple, a fig, a grape, a grapefruit, a guava, a kiwifruit, a lime, a lychee, a mamey sapote, a mango, a melon, a nectarine, an orange, a papaya, a peach, a pear, a pepper, a persimmon, a pineapple, a plum, a strawberry, a tomato, a watermelon, and the like, and combinations thereof. In some embodiments, the coating can be coated on an asparagus, an avocado, a blueberry, a grape, a mandarin, or a strawberry. In some embodiments, the coating can be coated on an asparagus. In some embodiments, the coating can be coated on an avocado. In some embodiments, the coating can be coated on a blueberry. In some embodiments, the coating can be coated on a grape. In some embodiments, the coating can be coated on a mandarin. In some embodiments, the coating can be coated on a strawberry.

In some embodiments, the agricultural products can be organic and/or unwaxed. In such embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located on the world wide web at “.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be configured to be washed off an edible agricultural product, for example, with water.

In some embodiments, the coating described herein can be coated on an inedible agricultural product. Such inedible agricultural products can include, for example, inedible flowers, seeds, shoots, stems, leaves, whole plants, and the likes. In such embodiments, the coating can include components that are non-toxic but the threshold level for non-toxicity can be higher than that prescribed for edible products. In such embodiments, the coating can include an FDA approved food contact substance, an FDA approved food additive, or an FDA approved drug ingredient, for example, any ingredient included in the FDA's database of approved drugs, which can be found on the world wide web at “accessdata.fda.gov/scripts/cder/drugsatfda/index.cfm”, the entire contents of which are hereby incorporated herein by reference. In some embodiments, the coating can include materials that satisfy FDA requirements to be used in drugs or are listed within the FDA's National Drug Discovery Code Directory on the world wide web, “accessdata.fda.gov/scripts/cder/ndc/default.cfm”, the entire contents of which are hereby incorporated herein by reference. In some embodiments, the materials can include inactive drug ingredients of an approved drug product as listed within the FDA's database on the world wide web, “.accessdata.fda.gov/scripts/cder/ndc/default.cfm”, the entire contents of which are hereby incorporated herein by reference.

In some embodiments, the compositions described herein can be applied to an agricultural product pre-harvest. In some embodiments, the pre-harvest above-ground biomass of a plant is contacted with a composition as described herein at least one time before the plant product is harvested. In some embodiments, the pre-harvest above-ground biomass of a plant is contacted with a composition as described herein between 1 and 20 times before the plant product is harvested. For example, in some embodiments, the pre-harvest above-ground biomass of a plant is contacted with a composition as described herein from 1 to 20 times before the plant product is harvested.

In some embodiments, the plant product is harvested from a treated pre-harvest plant 1 day to about 1 month after the pre-harvest plant was treated with a composition as described herein. In some embodiments, the plant product is harvested from a treated pre-harvest plant 1 to 31 days after the pre-harvest plant was treated with a composition as described herein.

In some embodiments, the compositions described herein can be applied to an agricultural product post-harvest.

The methods of the disclosure are also useful for identifying antimicrobial microorganisms from a plurality of agricultural products. Identifying antimicrobial microorganisms can include isolating antimicrobial microorganisms from agricultural products or through bioinformatic analysis of microbial genomes.

In one aspect, the disclosure is directed to a method of identifying an antimicrobial microorganism comprising storing the plurality of agricultural products until at least 90%, at least 80%, at least 70%, at least 60%, at least 50%, at least 40%, at least 30%, at least 20%, or at least 10% of the agricultural products show detectable signs of spoilage; and isolating the antimicrobial microorganism from the agricultural products that have the least detectable signs of spoilage.

The detectable signs of spoilage can include physical changes or chemical changes associate with ripening or spoilage of agricultural products. For example, detectable signs of spoilage can include a color change, such as browning, yellowing, blackening, and a combination thereof, a loss of mass, a change in texture, a visible sign of growth of one or more biological stressors, a change in the metabolism of starch such as a change in the ratio of starch to soluble sugar, a development of an off-odor, a development of an off-flavor, and a combination thereof. In some embodiments, the color change can include changing from colors indicating under-ripened fruits to more ripened fruits. In some embodiments, the change in texture includes, for example, softening, wrinkling, increasing fibrousness, increasing sliminess, and combination thereof. In some embodiments, the biological stressor is a fungi, a bacterium, an archaea, a protist, a pathogen, a pest, or a combination thereof. In some embodiments, the development of an off-odor comprises an increase in production of one or more spoilage metabolites. In some embodiments, the development of an off-flavor comprises an increase in production of one or more spoilage metabolites, including an organic acid, a thiol, ammonia or salt thereof, indole, scatole, a biogenic amine or salt thereof, gluconate or a derivative thereof, a ketone, an aldehyde, an alcohol, an ester, a geosmin, a diacetyl, an acetaldehyde, a butanol, a dimethylsulfide, a 2,3-butanedione, an ethyl acetate, and/or a free fatty acid of a maximum length up to 10 carbons. In some embodiments, the one or more organic acids include lactic acid, acetic acid, butyric acid, propionic acid, and formic acid.

In some embodiments, antimicrobial microorganisms can be isolated from external components of the agricultural products, such as the skin, peel, endosphere, rhizosphere, or surrounding soil of agricultural products. This can be accomplished by cutting the agricultural products into pieces and then vortexing and/or sonicating the agricultural product pieces in media or buffer. The supernatant can be separated from the larger components by, for example, settling or centrifugation. Methods for separating large components from liquid are well known in the art. Isolating antimicrobial microorganisms can use, for example, iterative plate streaking and/or culturing methods. Supernatant from vortexed and/or sonicated agricultural product pieces, agricultural product pieces, or whole agricultural products can be used to inoculate culturing media. Isolation of antimicrobial microorganisms can include DNA sequencing and identification of antimicrobial microorganism isolates. Identification of antimicrobial microorganism isolates can use, for example, sequence-based methods such as 16S rRNA sequencing, or can use an analysis of cultured bacterial characteristics, such as gram-positive or gram-negative status, that are well known in the art. In some embodiments, the method of identifying an antimicrobial microorganism from a plurality of agricultural products further comprises assaying the antimicrobial microorganism for antimicrobial activity after isolating the antimicrobial microorganism. Determining antimicrobial activity can include the use of antimicrobial assays such as fungal growth inhibition assays or analysis of the whole transcriptome and/or genome to identify production of antimicrobial molecules, such as non-ribosomal peptides (NRPs) or ribosomally synthesized and post-translationally modified peptides (RiPPs).

To initiate agricultural product spoilage or ripening, a plurality of agricultural products can be infected with a food-spoilage associated microorganisms prior to storage. In some embodiments, the plurality of agricultural products are not infected with a food-spoilage pathogen prior to storage and are allowed to naturally spoil from environmental-derived microorganisms. Agricultural products can be infected with one or more (e.g., two or more, three or more, or four or more) food-spoilage associated microorganisms. In some embodiments, the food-spoilage pathogen is a fungi, a bacterial species, or a combination thereof. In some embodiments, the food-spoilage pathogen is mold. In some embodiments, the food-spoilage pathogen is Botrytis cinerea, Colletotrichum gloeosporioides, Penicillium digitatum, Penicillium italicum, Lasiodipodia theobromae, geotrichum candidum Alternaria citri, Phomopsis citrim fusarium spp., geotrichum citri-aurantii, or Rhizopus stolonifera.

Also provided herein are methods of reducing, preventing, inhibiting, or delaying microbial growth on an agricultural product, the method comprising coating the agricultural product with any of the coatings or composition described herein. Coatings can delay the onset of microbial growth on an agricultural product, or the progression of growth on an agricultural product.

Also provided herein are methods of improving the shelf life of an agricultural product, the method comprising coating the agricultural product with any of the coatings or composition described herein. In some embodiments, the shelf life of an agricultural product is improved without refrigeration. The coating can, for example, prevent moisture loss from agricultural products and/or their oxidation by ambient air, and/or control, for example, delaying, the rate of ripening, thereby minimizing decomposition and increasing the life of the agricultural products by aiding in resistance to abiotic stressors.

Also provided herein is a method of preventing or reducing produce desiccation, the method comprising coating a produce with any one of the embodiments described herein.

In some embodiments, a single coating is used. In some embodiments, multiple coats are used (e.g., multiple coats of the same composition or multiple coats of different compositions). In some embodiments, multiple coats are applied sequentially. In some embodiments, coatings are dried at air temperature or are heated to dry. In some embodiments, coatings are dried in an air tunnel. In some embodiments, multiple coats are applied after previous coats are dried at air temperature, are dried with heating, or are dried in an air tunnel.

In some embodiments, the deposited coating has a thickness of less than about 100 microns, for example less than 50 microns, less than 25 microns, less than 10 microns, less than 5 microns, less than 1 micron, less than 500 nm, or less than 250 nm, such that the coating is transparent to the naked eye. For example, the deposited coating can have a thickness of about 50 nm to about 100 microns inclusive of all ranges there between. The deposited coating can have a high degree of crystallinity to decrease permeability, such that the coating is conformally deposited over the agricultural product and is free of defects and/or pinholes. In some embodiments, the dip coating process includes sequential coating of the agricultural product in baths of precursors that can undergo self-assembly or covalent bonding on the agricultural product to form the coating. In some embodiments, the coatings are deposited on agricultural products by passing the agricultural products under a stream of the coating (e.g., a waterfall of the liquid coating). For example, the agricultural products can be disposed on a conveyor that passes through the stream of the coating. In some embodiments, the coating is vapor deposited on the surface of the agricultural product. In some embodiments, the coating is formulated to be fixed on the surface of the agricultural product by UV cross-linking or by exposure to a reactive gas, for example, oxygen. In some embodiments, the coating is applied in the field before harvest as an alternative to pesticides.

Any of the coatings described herein can be disposed on the external surface of an agricultural product or plant using any suitable means. For example, in some embodiments, the agricultural product can be dip coated in a bath of the coating (e.g., an aqueous solution of hydrogen-bonding organic molecules). The coating can form a thin layer on the surface of agricultural product, which can protect the agricultural product from biotic stressors, water loss, and/or oxidation. In some embodiments, any of the coatings is spray coated on the agricultural products. For example, commercially available sprayers can be used for spraying the coating or precursors of the coating onto the agricultural product. In some embodiments, the coatings are electrically charged in the sprayer before spray coating on the agricultural product, such that the coating covalently bonds to the exterior surface of the agricultural product. In some embodiments, the coating is brushed onto the agricultural product. In some embodiments, the brushing is performed using a brush bed. In some embodiments, the coating is deposited with ultrasonic misting. For example, an ultrasonic mist maker, sometimes referred to as an ultrasonic atomizer, can transpose a high-frequency sound wave into mechanical energy that is transferred into a liquid, generating mist. In some embodiments, the coating is a powder coating.

In some embodiments, the coating is deposited on the agricultural product such that the coating is unbound to the surface of the agricultural product. In some embodiments, one or more components of the coating, for example, the hydrogen-bonding organic molecule, is covalently (or hydrogen) bonded to at least a portion of the surface of the agricultural product. This can result, for example, in improved coating properties such as, for example, higher durability, tighter control of coating permeability and thickness. In some embodiments, multiple layers of the coating are deposited on the surface of agricultural product. In some embodiments, multiple layers of the coating achieve a more durable coating.

The coating can also be formulated to protect the surface of the portion of the plant or agricultural product from abrasion, bruising, or otherwise mechanical damage, and/or protect the portion of the plant or agricultural product from photodegradation. The portion of the plant or agricultural product can include, for example, a leaf, a stem, a shoot, a flower, a fruit, a root, etc. The coating can also be configured to prevent water or otherwise moisture loss from the coated portion of the plant or agricultural product, delay ripening, and/or prevent oxygen diffusion into the coated portion of the plant or agricultural product, for example, to reduce oxidation of the coated portion of the plant or agricultural product.

### EXAMPLES

### Example 1: Method of Isolating Antifungal Microorganism Pseudomonas sp. Strain 1 (Strain 1) from Asparagus

Pseudomonas sp. strain 1, referred to as strain 1 hereafter, was originally isolated from asparagus. Briefly, asparagus was left at room temperature and high humidity for seven days, at which point all but one of the spears had severely degraded. The one spear that remained healthy had in fact grown and was used to isolate potentially antifungal microorganisms.

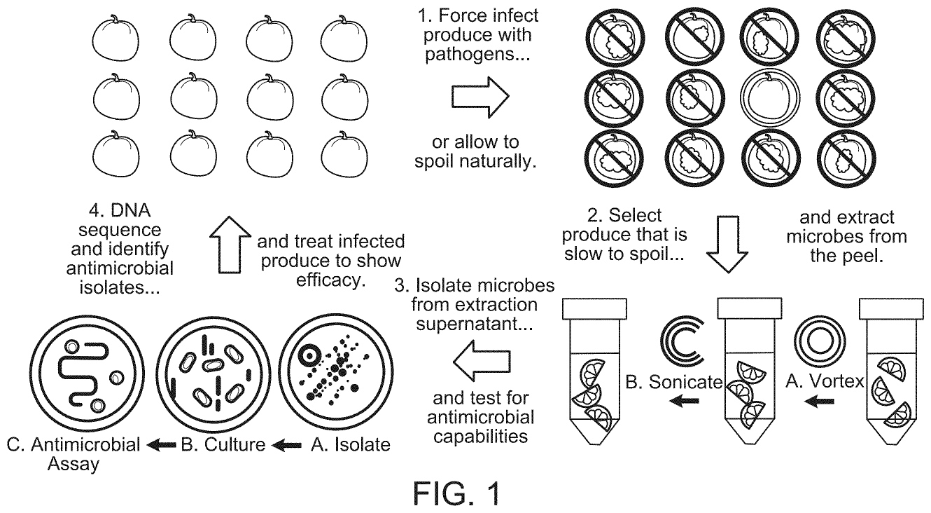

Briefly, the less or un-spoiled asparagus was cut into pieces, suspended in 10-25 mL of an extraction solution, for example, peptone water or phosphate buffered saline, vortexed, and sonicated to release attached microbes into the extraction solution. The extraction solution was then serially diluted, and plated on various media, for example, lab media such as nutrient agar, trypticase soy agar, or media derived from or containing target agricultural products extracts. Unique single colonies were then re-struck on plates with media to ensure purity. Pure isolates from less-spoiled asparagus were then tested in growth inhibition plate assays, where the microbe and fungus of interest were plated next to each other, incubated, and monitored for signs of germination inhibition, growth inhibition, and zones of clearing (FIG. 1).

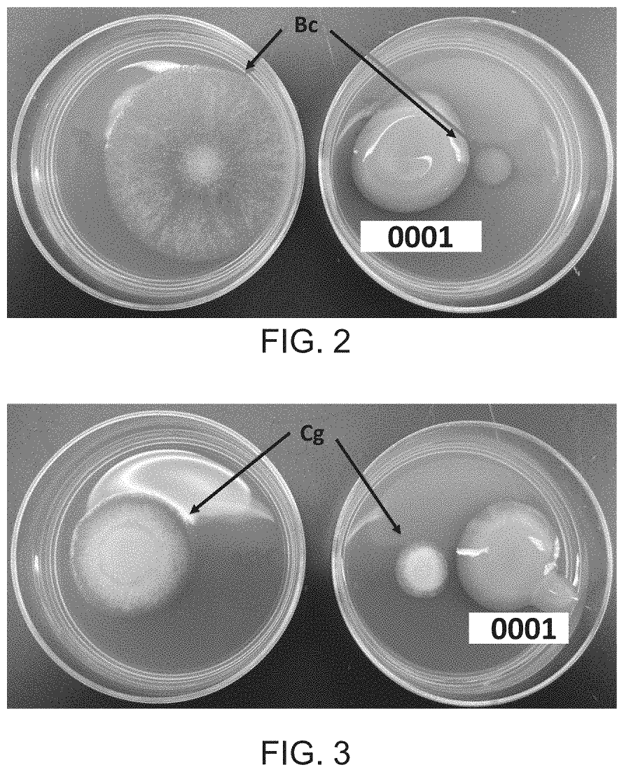

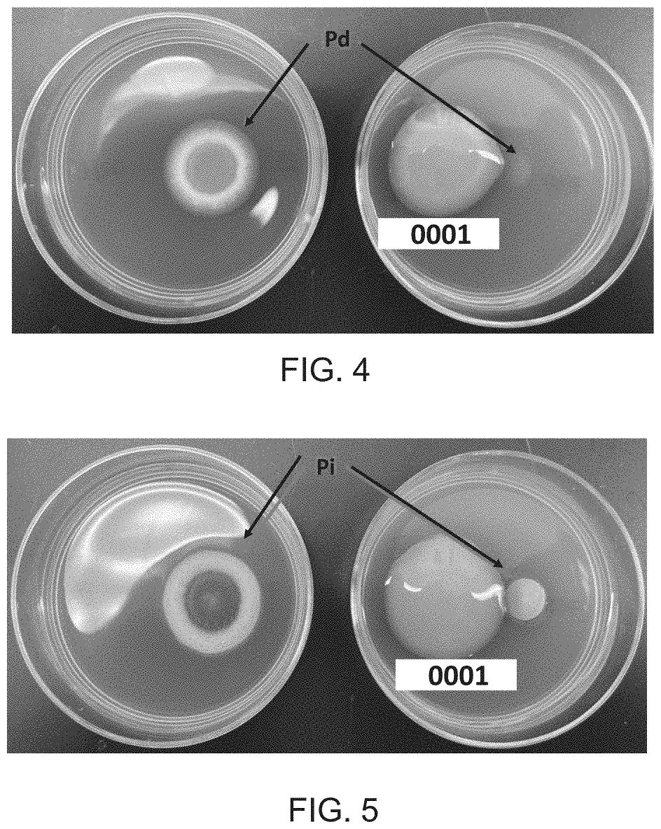

Five μL of saturated strain 1 culture were inoculated onto each plate, approximately 1 cm from the center of the plate, and incubated for 24 hours. Five μL of a fungal spore suspension were then inoculated opposite strain 1 and incubated for five days prior to imaging. Fungal spores included Botrytis cinerea (Bc) spores, Colletotrichum gloeosporioides (Cg) spores, Penicillium digitatum (Pd) spores, and Penicillium italicum (Pi) spores. Antifungal activity was indicated by smaller, less developed fungi for all tested fungal species (FIGS. 2-5). The growth inhibition assay plates showed a reduction in area covered by the Bc fungus (FIG. 2), the Pd fungus (FIG. 4), and the Pi fungus (FIG. 5). Cg fungus had an 83% reduction in area covered by the Cg fungus compared to the control plate (FIG. 3). One of the isolates, strain 1 stood out as possessing potent antifungal attributes with evidence of spore germination inhibition and/or growth inhibition against all tested species.

Strain 1 was then whole-genome sequenced to classify taxonomically, determine safety, and identify potential antifungal metabolites for further characterization. Whole-genome sequencing (WGS) was performed using MinION sequencing, and a circularized complete genome was obtained. Taxonomic analysis of strain 1 indicates that it a Pseudomonas, most closely related to P. fluorescens, and likely to be a species not currently present in the database. Genome analysis indicates that the strain produces a number of potentially novel secondary metabolites. These include molecules similar to pyoverdins, fragin, bacteriocins, bacillomycin, cepacin, rimosamide, and fengycin, all of which have been shown to have antifungal or antimicrobial properties.

Taken together, the results described herein demonstrate that strain 1 has incredible utility in preventing fungal disease pre- and post-harvest.

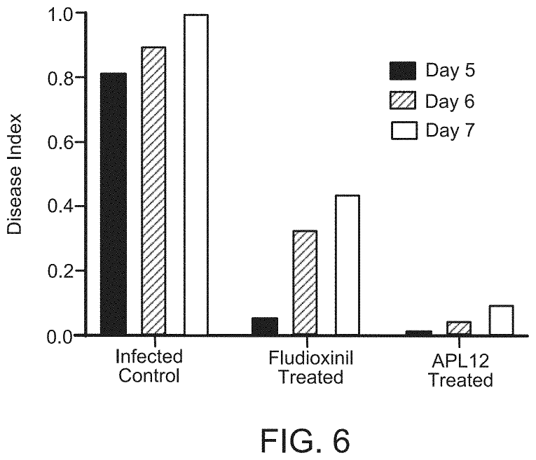

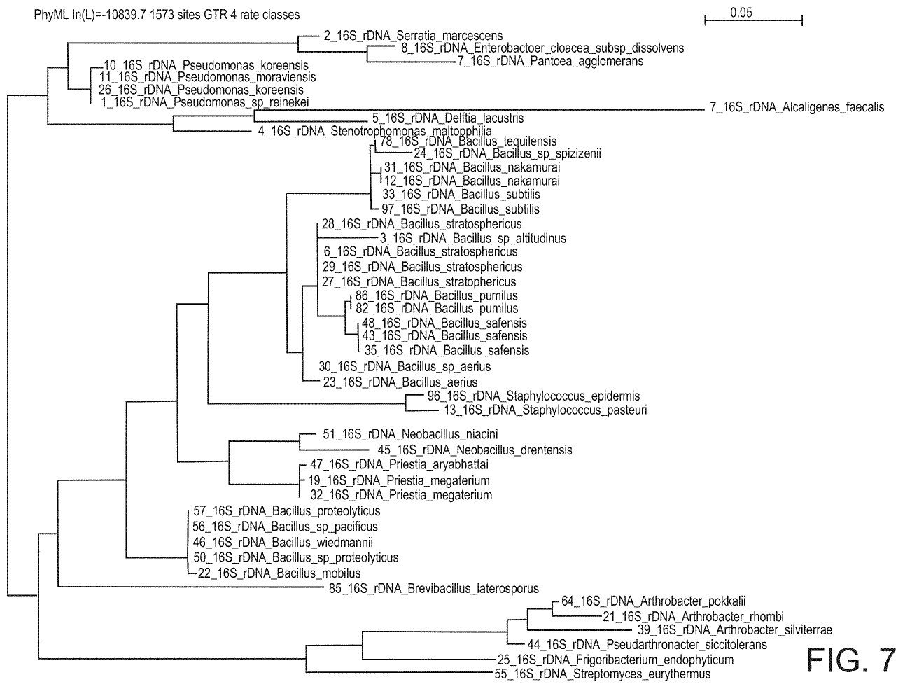

Finally, conditioned media in which strain 1 was cultured was used to treat test agricultural products to assess antifungal efficacy in vivo with fungal growth inhibition assays. Approximately 24 healthy grapes were destemmed by removing them from the pedicel, the short stem attached to the grape, and divided into two equal groups. All the grapes were inoculated with approximately 100 spores of Botrytis cinerea in the wound left by pedicel removal. The grapes in the control group then were briefly dipped in water, while the grapes in the test group were treated with strain 1 by dipping the grapes in conditioned media, the liquid portion of spent fermentation medium leftover after the cells were removed by centrifugation. Grapes from both treatments were then incubated inside plastic containers at room temperature and high relative humidity for 7 days prior to imaging (FIG. 6). Treated grapes show a reduced rate of infection and less severe infections.

Another aspect of strain 1 revealed by in vitro testing and WGS is the potential for plant growth-promotion. Strain 1 possesses a number of attributes that have been shown to promote plant growth. These include organic acid production, which solubilizes bound soil nutrients such as phosphorus, potassium, calcium, and zinc, improving the utilization rate of these essential nutrients; siderophore production, which supplies iron to plants; trehalose production, which aids in maintaining osmotic balance and preventing cellular oxidative damage; antifungal peptide and chitinase production, which protects plants from fungal disease and frees up nutrients in the soil; and finally, extracellular polysaccharide production and biofilm formation, which can directly protect the plant, and along with other metabolites, induce innate defense systems in plants allowing them to better protect themselves from biotic and abiotic stressors.

### Example 2: Method of Isolating Antifungal Microorganism Bacillus sp. (Strain 22) from Mandarin Oranges

Bacillus sp. strain 22, referred to as strain 22 hereafter, was originally isolated from oranges. Briefly, a flat of oranges were infected with Penicillium and left at room temperature and high humidity for seven days, at which point all but three of the oranges showed signs of severe fungal infection. The microbiome of these oranges was then isolated, and isolates screened for antifungal capabilities. One of the isolates, strain 22, stood out as possessing potent antifungal attributes.

Whole-genome sequence analysis (WGS) was then performed using MinION sequencing and a draft genome was obtained. Taxonomic analysis of strain 22 indicates that it is a Bacillus, most closely related to B. thuringiensis and B. toyonensis, and is likely to be a species not currently present in the database. Genome analysis indicates that the strain produces a number of potentially novel secondary metabolites. These include molecules similar to bacitracin, quartromicin A1, bacillibactin, petrobactin, molybdenum cofactor, and other non-ribosomal peptides. At least four chitinase genes (three copies of chitinase A1 and one copy of chitinase D), which hydrolyze the cell walls of pathogens and release elicitors for plant defense reactions, were also identified.

Another aspect of strain 22 revealed by in vitro testing and WGS is the potential for plant growth-promotion. Strain 22 possesses a number of attributes that have been shown to promote plant growth. These include organic acid production, which solubilizes bound soil nutrients such as phosphorus, potassium, calcium, and zinc, improving the utilization rate of essential nutrients; siderophore production, which can supply iron to plants; glycine betaine production, which can help with maintaining osmotic balance and stabilizes the structures and activities of enzymes and protein complexes; antifungal peptide and chitinase production, which can protect plants from fungal disease and frees up nutrients in the soil; and finally, biofilm formation, which can directly protect the plant, and along with other metabolites, can induce innate defense systems in plants allowing them to better protect themselves from biotic and abiotic stressors.

### Example 3: Method of Promoting Plant Growth

The Pseudomonas sp. stain 1 and Bacillus sp. stain 22 were assessed for plant promoting abilities with whole genome sequencing analysis.

It was found that both Pseudomonas sp. strain 1 and Bacillus sp. strain 22 possess a number of attributes that have been shown to promote plant growth. These include organic acid production, which solubilizes bound soil nutrients such as phosphorus, potassium, calcium, and zinc, improving the utilization rate of these essential nutrients; siderophore production, which supplies iron to plants; antifungal peptide and chitinase production, which protects plants from fungal disease and frees up nutrients in the soil; and finally, extracellular polysaccharide production and biofilm formation, which can directly protect the plant, and along with other metabolites, induce innate defense systems in plants allowing them to better protect themselves from biotic and abiotic stressors.

In addition, Pseudomonas sp. strain 1 also possesses trehalose production, which aids in maintaining osmotic balance and preventing cellular oxidative damage. Bacillus sp. strain 22 also possesses glycine betaine production, which aids in maintaining osmotic balance and stabilizes the structures and activities of enzymes and protein complexes; and biofilm formation, which can directly protect the plant, and along with other metabolites, induce innate defense systems in plants allowing them to better protect themselves from biotic and abiotic stressors.

A biological sample comprising strain 1 and/or strain 22 (e.g., bacterial culture or conditioned media) can be obtained. The culture of the microorganism(s), the conditioned media of the microorganism(s), or the isolated microorganism(s) can be combined with compositions of one or more fatty acid derivatives to create coatings for agricultural products. Coated agricultural products can have an improved shelf life compared to uncoated agricultural produces and the growth of spoilage-associated microorganisms can be delayed, slowed, inhibited, or prevented. Coated agricultural plants can experience plant growth promotion by growing, faster, or stronger than uncoated plants.

### Example 4: Determining Antifungal Activity of Bacterial Isolates

Seventy-two bacterial isolates from produce samples were screened for antifungal activity against Botrytis cinerea (Bc), Colletotrichum gloeosporioides (Cg), Penicillium digitatum (Pd), and Penicillium italicum (Pi) using the agar-diffusion assay. Briefly, all bacterial isolates were recovered from −80° C. glycerol stocks, plated on Tryptic Soy Agar (TSA) or Reasoner's 2A agar (R2A) and incubated at 30° C. for approximately 3 days. For each bacterial isolate, a single colony was collected on a sterile inoculation loop and inoculated into 3 mL of Tryptic Soy Broth (TSB) in a 15 mL test tube. To allow for aerobic condition, the test tube lid was loosely replaced and secured using tape. The tubes were then incubated at a 450 angle in an orbital shaker set to 30° C. at 150 rpm for approximately 3 days.

BD Tryptic Soy Agar, approximate formula per liter purified water:

| | |
|---|---|
| Pancreatic Digest of Casein | 15.0 g |
| Papaic Digest of Soybean Meal | 5.0 g |
| Sodium Chloride | 5.0 g |
| Agar | 15.0 g |

Final pH (at 25° C.) 7.3 ± 0.2

BD Difco™ R2A Agar, approximate formula per liter purified water:

| | |
|---|---|
| Yeast Extract | 0.5 g |
| Proteose Peptone No. 3 | 0.5 g |
| Casamino Acids | 0.5 g |
| Dextrose | 0.5 g |
| Soluble Starch | 0.5 g |
| Sodium Pyruvate | 0.3 g |
| Dipotassium Phosphate | 0.3 g |
| Magnesium Sulfate | 0.05 g |
| Agar | 15.0 g |

Final pH (at 25° C.) 7.2 ± 0.2

BD Tryptic Soy Broth, approximate formula per liter purified water:

| | |
|---|---|
| Bacto ™ Tryptone (Pancreatic Digest of Casein) | 17.0 g |
| Bacto Soytone (Peptic Digest of Soybean Meal) | 3.0 g |
| Dextrose | 2.5 g |
| Sodium Chloride | 5.0 g |
| Dipotassium Hydrogen Phosphate | 2.5 g |

Final pH (at 25° C.) 7.3 ± 0.2

For each fungal species, 10 μL of a 1×10⁵ fungal spore suspension was inoculated onto an agar plate of the appropriate medium approximately 1 cm from the edge of the plate. Seventy-three plates were prepared for each fungal species, one for each bacterial isolate and a negative control plate containing only fungus. For Bc, Juice Agar (V8A) was used. For Cg, Pd, and Pi, Potato Dextrose Agar (PDA) was used.

Vegetable Juice Agar (V8A), approximate formula per liter purified water:

| | |
|---|---|
| V8 ® Vegetable Juice (100 mL) | 8.3 g |
| L-Asparagine | 10.0 g |
| Yeast Extract | 2.0 g |
| Calcium Carbonate | 2.0 g |
| Dextrose | 2.0 g |
| Agar | 20.0 g |

Final pH (at 25° C.) 5.7 ± 0.2

BD Difco™ Potato Dextrose Agar, approximate formula per liter purified water:

| | |
|---|---|
| Potato Starch (from 200 g of infusion from potatoes) | 4.0 g |
| Dextrose | 20.0 g |
| Agar | 15.0 g |

Final pH (at 25° C.) 5.6 ± 0.2

Fungal plates were then incubated at 25° C. for approximately 1 day. For each bacterial isolate, 10 μL of saturated culture was inoculated onto each of the four fungal species plates approximately 1 cm from the edge of the plate opposite the fungal inoculation spot. The assay plates were then incubated at 25° C. for 10 days and examined on days 6-10.

For each bacterial isolate and fungal species combination, a plate assay ranking was assigned and surface tension was measured based on the scale in Table 2.

TABLE 2
Plate assay results

| | | | | | Reduced |
|---|---|---|---|---|---|
| | Plate Assay Results ^{a} | | | | Surface |
| Strain | Bc | Cg | Pd | Pi | Tension |
| 1 | ++ | − | − | + | 0 |
| 2 | ++ | − | − | − | 0 |
| 3 | ++ | − | ++ | ++ | 0 |
| 4 | − | − | − | + | 0 |
| 5 | ++ | − | − | + | 0 |
| 6 | ++ | − | + | − | 0 |
| 7 | + | − | − | + | 0 |
| 8 | + | − | − | + | 0 |
| 9 | + | − | − | − | 0 |
| 10 | ++ | − | − | + | 0 |
| 11 | ++ | − | + | + | 0 |
| 12 | ++ | ++ | ++ | ++ | 1 |
| 13 | + | − | − | − | 0 |
| 15 | − | − | − | − | 0 |
| 16 | − | − | − | − | 0 |
| 17 | − | − | − | − | 0 |
| 18 | − | − | − | − | 0 |
| 19 | + | − | − | − | 0 |
| 20 | − | − | − | − | 0 |
| 21 | − | − | − | ++ | 1 |
| 22 | +++ | − | − | − | 0 |
| 23 | +++ | − | ++ | ++ | 0 |
| 24 | +++ | ++ | ++ | ++ | 1 |
| 25 | +++ | − | − | + | 0 |
| 26 | +++ | − | − | + | 0 |
| 27 | +++ | − | + | − | 0 |
| 28 | +++ | − | ++ | ++ | 1 |
| 29 | +++ | − | ++ | ++ | 0 |
| 30 | +++ | ++ | ++ | ++ | 0 |
| 31 | +++ | ++ | + | ++ | 0 |
| 32 | − | − | − | + | 0 |
| 33 | + | − | − | − | 0 |
| 34 | − | − | − | − | 0 |
| 35 | ++ | − | − | − | 1 |
| 37 | ++ | − | − | ++ | 0 |
| 38 | + | − | − | − | 0 |
| 39 | − | − | − | + | 0 |
| 40 | NG | − | − | − | 0 |
| 41 | − | NG | NG | NG | 0 |
| 42 | − | − | − | − | 0 |
| 43 | +++ | ++ | ++ | ++ | 1 |
| 44 | +++ | − | − | − | 0 |
| 45 | +++ | NG | NG | NG | 0 |
| 46 | +++ | +++ | ++ | ++ | 0 |
| 47 | +++ | − | − | − | 0 |
| 48 | +++ | − | − | − | 1 |
| 49 | − | − | − | − | |
| 50 | +++ | ++ | ++ | − | 0 |
| 51 | +++ | − | − | + | 0 |
| 52 | NG | NG | NG | NG | 0 |
| 53 | NG | NG | NG | NG | 0 |
| 55 | − | − | +++ | +++ | |
| 56 | + | ++ | ++ | ++ | |
| 57 | + | ++ | ++ | ++ | |
| 58 | − | − | − | − | |
| 59 | NG | NG | NG | NG | |
| 60 | − | NG | NG | NG | |
| 61 | − | − | + | − | |
| 62 | − | NG | NG | NG | |
| 63 | − | − | − | − | |
| 64 | − | − | ++ | − | |
| 65 | − | − | − | − | |
| 66 | − | − | − | + | |
| 67 | − | NG | NG | NG | |
| 68 | − | − | − | − | |
| 69 | − | − | − | − | |
| 70 | − | − | − | − | |
| 71 | + | + | + | + | |
| 72 | − | − | − | − | |

+ Any inhibition;
++ Any clearing;
+++ Significant clearing;
− No sign of inhibition;
NG No growth of bacterial species

This assay identified Mucilaginibacter terrae, Kocuria dechangensis, Curtobacterium pusillum, Pseudoarthrobacter phenanthrenivorans, Niallia nealsonii, Frigoribacterium endophyticum, Curtobacterium pusillum, Arthrobacter agilis, and Kocuria rosea, as bacterial species having antifungal activity.

Bacterial species having antifungal activity were sequenced. The 16S rRNA sequences for certain strains that tested positive for antifungal activity in the plate assay are provided in Table 3. A phylogenetic tree was inferred using the 16S rRNA sequences (FIG. 7).

TABLE 3
16S rRNA sequences

| Strain | Organism | Sequence |
|---|---|---|
| 1 | Pseudomonas sp. | GCGCTATCAGATGAGCCTAGGTCGGATTAGCTAGTTGGTGAGGTAATGGCTCACCAAGGC |
| | | GACGATCCGTAACTGGTCTGAGAGGATGATCAGTCACACTGGAACTGAGACACGGTCCAG |
| | | ACTCCTACGGGAGGCAGCAGTGGGGAATATTGGACAATGGGCGAAAGCCTGATCCAGCCA |
| | | TGCCGCGTGTGTGAAGAAGGTCTTCGGATTGTAAAGCACTTTAAGTTGGGAGGAAGGGTT |
| | | GTAGATTAATACTCTGCAATTTTGACGTTACCGACAGAATAAGCACCGGCTAACTCTGTG |
| | | CCAGCAGCCGCGGTAATACAGAGGGTGCAAGCGTTAATCGGAATTACTGGGCGTAAAGCG |
| | | CGCGTAGGTGGTTCGTTAAGTTGGATGTGAAATCCCCGGGCTCAACCTGGGAACTGCATC |
| | | CAAAACTGGCGAGCTAGAGTATGGTAGAGGGTGGTGGAATTTCCTGTGTAGCGGTGAAAT |
| | | GCGTAGATATAGGAAGGAACACCAGTGGCGAAGGCGACCACCTGGACTGATACTGACACT |
| | | GAGGTGCGAAAGCGTGGGGAGCAAACAGGATTAGATACCCTGGTAGTCCACGCCGTAAAC |
| | | GATGTCAACTAGCCGTTGGGAGCCTTGAGCTCTTAGTGGCGCAGCTAACGCATTAAGTTG |
| | | ACCGCCTGGGGAGTACGGCCGCAAGGTTAAAACTCAAATGAATTGACGGGGGCCCGCACA |
| | | AGCGGTGGAGCATGTGGTTTAATTCGAAGCAACGCGAAGAACCTTACCAGGCCTTGACAT |
| | | CCAATGAACTTTCCAGAGATGGATTGGTGCCTTCGGGAGCATTGAGACAGGTGCTGCATG |
| | | GCTGTCGTCAGCTCGTGTCGTGAGATGTTGGGTTAAGTCCCGTAACGAGCGCAACCCTTG |
| | | TCCTTAGTTACCAGCACGTTATGGTGGGCACTCTAAGGAGACTGCCGGTGACAAACCGGA |
| | | GGAAGGTGGGGATGACGTCAAGTCATCATGGCCCTTACGGCCTGGGCTACACACGTGCTA |
| | | CAATGGTCGGTACAAAGGGTTGCCAAGCCGCGAGGTGGAGCTAATCCCATAAAACCGATC |
| | | GTAGTCCGGATCGCAGTCTGCAACTCGACTGCGTGAAGTCGGAGTCGCTAGTATC |
| | | (SEQ ID NO: 11) |
| 2 | Serratia | GCAAGTCGAGCGGTAGCACAGGGGAGCTTCTCCCTGGTGACGAGCGGCGGACGGGTGAGT |
| | marcescens | AATGTCTGGGAAACTGCCTGATGGAGGGGGATAACTACTGGAAACGGTAGCTAATACCGCA |
| | | TAACGTCGCAAGACCAAAGAGGGGGACCTTCGGGCCTCTTGCCATCAGATGTGCCCAGAT |
| | | GGGATTAGCTAGTAGGTGGGGTAATGGCTCACCTAGGCGACGATCCCTAGCTGGTCTGAG |
| | | AGGATGACCAGCCACACTGGAACTGAGACACGGTCCAGACTCCTACGGGAGGCAGCAGTG |
| | | GGGAATATTGCACAATGGGCGCAAGCCTGATGCAGCCATGCCGCGTGTGTGAAGAAGGCC |
| | | TTCGGGTTGTAAAGCACTTTCAGCGAGGAGGAAGGTGGTGAACTTAATACGTTCATCAAT |
| | | TGACGTTACTCGCAGAAGAAGCACCGGCTAACTCCGTGCCAGCAGCCGCGGTAATACGGA |
| | | GGGTGCAAGCGTTAATCGGAATTACTGGGCGTAAAGCGCACGCAGGCGGTTTGTTAAGTC |
| | | AGATGTGAAATCCCCGGGCTCAACCTGGGAACTGCATTTGAAACTGGCAAGCTAGAGTCT |
| | | CGTAGAGGGGGGTAGAATTCCAGGTGTAGCGGTGAAATGCGTAGAGATCTGGAGGAATAC |
| | | CGGTGGCGAAGGCGGCCCCCTGGACGAAGACTGACGCTCAGGTGCGAAAGCGTGGGGAGC |
| | | AAACAGGATTAGATACCCTGGTAGTCCACGCTGTAAACGATGTCGATTTGGAGGTTGTGC |
| | | CCTTGAGGCGTGGCTTCCGGAGCTAACGCGTTAAATCGACCGCCTGGGGAGTACGGCCGC |
| | | AAGGTTAAAACTCAAATGAATTGACGGGGGCCCGCACAAGCGGTGGAGCATGTGGTTTAA |
| | | TTCGATGCAACGCGAAGAACCTTACCTACTCTTGACATCCAGAGAACTTTCCAGAGATGG |
| | | ATTGGTGCCTTCGGGAACTCTGAGACAGGTGCTGCATGGCTGTCGTCAGCTCGTGTTGTG |
| | | AAATGTTGGGTTAAGTCCCGCAACGAGCGCAACCCTTATCCTTTGTTGCCAGCGGTTCGG |
| | | CCGGGAACTCAAAGGAGACTGCCAGTGATAAACTGGAGGAAGGTGGGGATGACGTCAAGT |
| | | CATCATGGCCCTTACGAGTAGGGCTACACACGTGCTACAATGGCGTATACAAAGA |
| | | (SEQ ID NO: 12) |
| 3 | Bacillus sp. | TGCTCAGACGAACGCTGGCGGCGTGCCTAATACATGCAAGTCGAGCGGACAGAAGGGAGC |
| | | TTGCTCCCGGATGTTAGCGGCGGACGGCGTGAGTAACACGTGGGTAACCTGCCTGTAAG |
| | | ACTGGGATAACTCCGGGAAACCGGAGCTAATACCGGATAGTTCCTTGAACCGCATGGTTC |
| | | AAGGATGAAAGACGGTTTCGGCTGTCACTTACAGATGGACCCGCGGCGCATTAGCTAGTT |
| | | GGTGAGGTAACGGCTCACCAAGGCGACGATGCGTAGCCGACCTGAGAGGGTGATCGGCCA |
| | | CACTGGGACTGAGACACGGCCCAGACTCCTACGGGAGGCAGCAGTAGGGAATCTTCCGCA |
| | | ATGGACGAAAGTCTGACGGAGCAACGCCGCGTGAGTGATGAAGGTTTTCGGATCGTAAAG |
| | | CTCTGTTGTTAGGGAAGAACAAGTGCAAGAGTAACTGCTTGCACCTTGACGGTACCTAAC |
| | | CAGAAAGCCACGGCTAACTACGTGCCAGCAGCCGCGGTAATACGTAGGTGGCAAGCGTTG |
| | | TCCGGAATTATTGGGCGTAAAGGGCTCGCAGGCGGTTTCTTAAGTCTGATGTGAAAGCCC |
| | | CCGGCTCAACCGGGGAGGGTCATTGGAAACTGGGAAACTTGAGTGCAGAAGAGGAGAGTG |
| | | GAATTCCACGTGTAGCGGTGAAATGCGTAGAGATGTGGAGGAACACCAGTGGCGAAGGCG |
| | | ACTCTCTGGTCTGTAACTGACGCTGAGGAGCGAAAGCGTGGGGAGCGAACAGGATTAGAT |
| | | ACCCTGGTAGTCCACGCCGTAAACGATGAGTGCTAAGTGTTAGGGGGTTTCCGCCCCTTA |
| | | GTGCTGCAGCTAACGCATTAAGCACTCCGCCTGGGGAGTACGGTCGCAAGACTGAAACTC |
| | | AAAGGAATTGACGGGGGCCCGCACAAGCGGTGGAGCATGTGGTTTAATTCGAAGCAACGC |
| | | GAAGAACCTTACCAGGTCTTGACATCCTCTGACAACCCTAGAGATAGGGCTTTCCCTTCG |
| | | GGGACAGAGTGACAGGTGGTGCATGGTTGTCGTCAGCTCGTGTCGTGAGATGTTGGGTTA |
| | | AGTCCCGCAACGAGCGCAACCCTTGATCTTAGTTGCCAGCATTTAGTTGGGCACTCTAAG |
| | | GTGACTGCCGGTGACAAACCGGAGGAAGGTGGGGATGACGTCAAATCATCATGCCCCTTA |
| | | TGACCTGGGCTACACACGTGCTACAATGGACAGAACAAAGGGCTGCGAGACCGCAAGGTT |
| | | TAGCCAATCCCACAAATCTGTTCTCAGTTCGGATCGCAGTCTGCAACTCGACTGCGTGAA |
| | | GCTGGAATCGCTAGTAATCGGCAGATCAGC (SEQ ID NO: 13) |
| 4 | Stenotrophomonas | TCAGAGTGAACGCTGGCGGTAGGCCTAACACATGCAAGTCGAACGGCAGCACAGAGGAGC |
| | maltophilia | TTGCTCCTTGGGTGGCGAGTGGCGGACGGGTGAGGAATACATCGGAATCTACTTTTTCGT |
| | | GGGGGATAACGTAGGGAAACTTACGCTAATACCGCATACGACCTACGGGTGAAAGCAGGG |
| | | GATCTTCGGACCTTGCGCGATTGAATGAGCCGATGTCGGATTAGCTAGTTGGCGGGGTAA |
| | | AGGCCCACCAAGGCGACGATCCGTAGCTGGTCTGAGAGGATGATCAGCCACACTGGAACT |
| | | GAGACACGGTCCAGACTCCTACGGGAGGCAGCAGTGGGGAATATTGGACAATGGGCGCAA |
| | | GCCTGATCCAGCCATACCGCGTGGGTGAAGAAGGCCTTCGGGTTGTAAAGCCCTTTTGTT |
| | | GGGAAAGAAATCCAGCCGGCTAATACCTGGTTGGGATGACGGTACCCAAAGAATAAGCAC |
| | | CGGCTAACTTCGTGCCAGCAGCCGCGGTAATACGAAGGGTGCAAGCGTTACTCGGAATTA |
| | | CTGGGCGTAAAGCGTGCGTAGGTGGTTGTTTAAGTCTGTTGTGAAAGCCCTGGGCTCAAC |
| | | CTGGGAACTGCAGTGGAAACTGGACAACTAGAGTGTGGTAGAGGGTAGCGGAATTCCCGG |
| | | TGTAGCAGTGAAATGCGTAGAGATCGGGAGGAACATCCATGGCGAAGGCAGCTACCTGGA |
| | | CCAACACTGACACTGAGGCACGAAAGCGTGGGGAGCAAACAGGATTAGATACCCTGGTAG |
| | | TCCACGCCCTAAACGATGCGAACTGGATGTTGGGTGCAATTTGGCACGCAGTATCGAAGC |
| | | TAACGCGTTAAGTTCGCCGCCTGGGGAGTACGGTCGCAAGACTGAAACTCAAAGGAATTG |
| | | ACGGGGGCCCGCACAAGCGGTGGAGTATGTGGTTTAATTCGATGCAACGCGAAGAACCTT |
| | | ACCTGGCCTTGACATGTCGAGAACTTTCCAGAGATGGATTGGTGCCTTCGGGAACTCGAA |
| | | CACAGGTGCTGCATGGCTGTCGTCAGCTCGTGTCGTGAGATGTTGGGTTAAGTCCCGCAA |
| | | CGAGCGCAACCCTTGTCCTTAGTTGCCAGCACGTAATGGTGGGAACTCTAAGGAGACCGC |
| | | CGGTGACAAACCGGAGGAAGGTGGGGATGACGTCAAGTCATCATGGCCCTTACGGCCAGG |
| | | GCTACACACGTACTACAATGGTAGGGACAGAGGGCTGCAAGCCGGCGACGGTAAGCCAAT |
| | | CCCAGAAACCCTATCTCAGTCCGGATTGGAGTCTGCAACTCGACTCCATGAAGTCGGAAT |
| | | CGCTAGTA (SEQ ID NO: 14) |
| 5 | Delftia lacustris | TCTTCGGACGCTGACGAGTGGCGAACGGGTGAGTAATACATCGGAACGTGCCCAGTCGTG |
| | | GGGGATAACTACTCGAAAGAGTAGCTAATACCGCATACGATCTGAGGATGAAAGCGGGGG |
| | | ACCTTCGGGCCTCGCGCGATTGGAGCGGCCGATGGCAGATTAGGTAGTTGGTGGGATAAA |
| | | AGCTTACCAAGCCGACGATCTGTAGCTGGTCTGAGAGGACGACCAGCCACACTGGGACTG |
| | | AGACACGGCCCAGACTCCTACGGGAGGCAGCAGTGGGGAATTTTGGACAATGGGCGAAAG |
| | | CCTGATCCAGCAATGCCGCGTGCAGGATGAAGGCCTTCGGGTTGTAAACTGCTTTTGTAC |
| | | GGAACGAAAAAGCTCCTTCTAATACAGGGGGCCCATGACGGTACCGTAAGAATAAGCACC |
| | | GGCTAACTACGTGCCAGCAGCCGCGGTAATACGTAGGGTGCGAGCGTTAATCGGAATTAC |
| | | TGGGCGTAAAGCGTGCGCAGGCGGTTATGTAAGACAGATGTGAAATCCCCGGGCTCAACC |
| | | TGGGAACTGCATTTGTGACTGCATGGCTAGAGTACGGTAGAGGGGGATGGAATTCCGCGT |
| | | GTAGCAGTGAAATGCGTAGATATGCGGAGGAACACCGATGGCGAAGGCAATCCCCTGGAC |
| | | CTGTACTGACGCTCATGCACGAAAGCGTGGGGAGCAAACAGGATTAGATACCCTGGTAGT |
| | | CCACGCCCTAAACGATGTCAACTGGTTGTTGGGAATTAGTTTTCTCAGTAACGAAGCTAA |
| | | CGCGTGAAGTTGACCGCCTGGGGAGTACGGCCGCAAGGTTGAAACTCAAAGGAATTGACG |
| | | GGGACCCGCACAAGCGGTGGATGATGTGGTTTAATTCGATGCAACGCGAAAAACCTTACC |
| | | CACCTTTGACATGGCAGGAAGTTTCCAGAGATGGATTCGTGCTCGAAAGAGAACCTGCAC |
| | | ACAGGTGCTGCATGGCTGTCGTCAGCTCGTGTCGTGAGATGTTGGGTTAAGTCCCGCAAC |
| | | GAGCGCAACCCTTGTCATTAGTTGCTACATTCAGTTGAGCACTCTAATGAGACTGCCGGT |
| | | GACAAACCGGAGGAAGGTGGGGATGACGTCAAGTCCTCATGGCCCTTATAGGTGGGGCTA |
| | | CACACGTCATACAATGGCTGGTACAGAGGGTTGCCAACCCGCGAGGGGGAGCTAATCCCA |
| | | TAAAACCAGTCGTAGTCCGGATCGCAGTCTGCAACTCGACTGCGTGAAGTCGGAGTCGCT |
| | | AGTAATCGCA (SEQ ID NO: 15) |
| 6 | Bacillus | TACATGCAAGTCGAGCGGACAGAAGGGAGCTTGCTCCCGGATGTTAGCGGCGGACGGGTG |
| | stratophericus | AGTAACACGTGGGTAACCTGCCTGTAAGACTGGGATAACTCCGGGAAACCGGAGCTAATA |
| | | CCGGATAGTTCCTTGAACCGCATGGTTCAAGGATGAAAGACGGTTTCGGCTGTCACTTAC |
| | | AGATGGACCCGCGGCGCATTAGCTAGTTGGTGAGGTAACGGCTCACCAAGGCGACGATGC |
| | | GTAGCCGACCTGAGAGGGTGATCGGCCACACTGGGACTGAGACACGGCCCAGACTCCTAC |
| | | GGGAGGCAGCAGTAGGGAATCTTCCGCAATGGACGAAAGTCTGACGGAGCAACGCCGCGT |
| | | GAGTGATGAAGGTTTTCGGATCGTAAAGCTCTGTTGTTAGGGAAGAACAAGTGCAAGAGT |
| | | AACTGCTTGCACCTTGACGGTACCTAACCAGAAAGCCACGGCTAACTACGTGCCAGCAGC |
| | | CGCGGTAATACGTAGGTGGCAAGCGTTGTCCGGAATTATTGGGCGTAAAGGGCTCGCAGG |
| | | CGGTTTCTTAAGTCTGATGTGAAAGCCCCCGGCTCAACCGGGGAGGGTCATTGGAAACTG |
| | | GGAAACTTGAGTGCAGAAGAGGAGAGTGGAATTCCACGTGTAGCGGTGAAATGCGTAGAG |
| | | ATGTGGAGGAACACCAGTGGCGAAGGCGACTCTCTGGTCTGTAACTGACGCTGAGGAGCG |
| | | AAAGCGTGGGGAGCGAACAGGATTAGATACCCTGGTAGTCCACGCCGTAAACGATGAGTG |
| | | CTAAGTGTTAGGGGGTTTCCGCCCCTTAGTGCTGCAGCTAACGCATTAAGCACTCCGCCT |
| | | GGGGAGTACGGTCGCAAGACTGAAACTCAAAGGAATTGACGGGGGCCCGCACAAGCGGTG |
| | | GAGCATGTGGTTTAATTCGAAGCAACGCGAAGAACCTTACCAGGTCTTGACATCCTCTGA |
| | | CAACCCTAGAGATAGGGCTTTCCCTTCGGGGACAGAGTGACAGGTGGTGCATGGTTGTCG |
| | | TCAGCTCGTGTCGTGAGATGTTGGGTTAAGTCCCGCAACGAGCGCAACCCTTGATCTTAG |
| | | TTGCCAGCATTTAGTTGGGCACTCTAAGGTGACTGCCGGTGACAAACCGGAGGAAGGTGG |
| | | GGATGACGTCAAATCATCATGCCCCTTATGACCTGGGCTACACACGTGCTACAATGGACA |
| | | GAACAAAGGGCTGCGAGACCGCAAGGTTTAGCCAATCCCACAAATCTGTTCTCAGTTCGG |
| | | ATCGCAGTCTGCAACTCGACTGCGTGAAGCTGGAGTCGCTAGTA (SEQ ID NO: 16) |
| 7 | Alcaligenes | GCAGCGCGAGAGAGCTTGCTCTCTTGGCGGCGAGTGGCGGACGGGTGAGTAATATATCGG |
| | faecalis | AACGTGCCCAGTAGCGGGGGATAACTACTCGAAAGAGTGGCTAATACCGCATACGCCCTA |
| | | CGGGGGAAAGGGGGGGATCGCAAGACCTCTCACTATTGGAGCGGCCGATATCGGATTAGC |
| | | TAGTTGGTGGGGTAAAGGCTCACCAAGGCAACGATCCGTAGCTGGTTTGAGAGGACGACC |
| | | AGCCACACTGGGACTGAGACACGGCCCAGACTCCTACGGGAGGCAGCAGTGGGGAATTTT |
| | | GGACAATGGGGGAAACCCTGATCCAGCCATCCCGCGTGTATGATGAAGGCCTTCGGGTTG |
| | | TAAAGTACTTTTGGCAGAGAAGAAAAGGTATCCCCTAATACGGGATACTGCTGACGGTAT |
| | | CTGCAGAATAAGCACCGGCTAACTACGTGCCAGCAGCCGCGGTAATACGTAGGGTGCAAG |
| | | CGTTAATCGGAATTACTGGGCGTAAAGCGTGTGTAGGCGGTTCGGAAAGAAAGATGTGAA |
| | | ATCCCAGGGCTCAACCTTGGAACTGCATTTTTAACTGCCGAGCTAGAGTATGTCAGAGGG |
| | | GGGTAGAATTCCACGTGTAGCAGTGAAATGCGTAGATATGTGGAGGAATACCGATGGCGA |
| | | AGGCAGCCCCCTGGGATAATACTGACGCTCAGACACGAAAGCGTGGGGAGCAAACAGGAT |
| | | TAGATACCCTGGTAGTCCACGCCCTAAACGATGTCAACTAGCTGTTGGGGCCGTTAGGCC |
| | | TTAGTAGCGCAGCTAACGCGTGAAGTTGACCGCCTGGGGAGTACGGTCGCAAGATTAAAA |
| | | CTCAAAGGAATTGACGGGGACCCGCACAAGCGGTGGATGATGTGGATTAATTCGATGCAA |
| | | CGCGAAAAACCTTACCTACCCTTGACATGTCTGGAAAGCCGAAGAGATTTGGCCGTGCTC |
| | | GCAAGAGAACCGGAACACAGGTGCTGCATGGCTGTCGTCAGCTCGTGTCGTGAGATGTTG |
| | | GGTTAAGTCCCGCAACGAGCGCAACCCTTGTCATTAGTTGCTACGCAAGAGCACTCTAAT |
| | | GAGACTGCCGGTGACAAACCGGAGGAAGGTGGGGATGACGTCAAGTCCTCATGGCCCTTA |
| | | TGGGTAGGGCTTCACACGTCATACAATGGTCGGGACAGAGGGTCGCCAACCCGCGAGGGG |
| | | GAGCCAATCTCAGAAACCCGATCGTAGTCCGGATCGCAGTCTGCAACTCGACTGCGTGAA |
| | | GTCGGAATCGCTAGTAATCGCGGATCAGAATGTCGCGGTGAATACGTTCCCGGGTCTTGT |
| | | ACACACCGCCCGTCACACCATGGGAGTGGGTTCACCAGAAGTAGGTAGCCTAACCGTAAG |
| | | GAGGGCGCTA (SEQ ID NO: 17) |
| 8 | Enterobacter | CATGCTCAGATTGAACGCTGGCGGCAGGCCTAACACATGCAAGTCGAACGGTAGCACAGA |
| | cloacae | GAGCTTGCTCTCGGGTGACGAGTGGCGGACGGGTGAGTAATGTCTGGGAAACTGCCTGAT |
| | | GGAGGGGGATAACTACTGGAAACGGTAGCTAATACCGCATAACGTCGCAAGACCAAAGAG |
| | | GGGGACCTTCGGGCCTCTTGCCATCAGATGTGCCCAGATGGGATTAGCTAGTAGGTGGGG |
| | | TAACGGCTCACCTAGGCGACGATCCCTAGCTGGTCTGAGAGGATGACCAGCCACACTGGA |
| | | ACTGAGACACGGTCCAGACTCCTACGGGAGGCAGCAGTGGGGAATATTGCACAATGGGCG |
| | | CAAGCCTGATGCAGCCATGCCGCGTGTATGAAGAAGGCCTTCGGGTTGTAAAGTACTTTC |
| | | AGCGGGGAGGAAGGTGTTGTGGTTAATAACCACAGCAATTGACGTTACCCGCAGAAGAAG |
| | | CACCGGCTAACTCCGTGCCAGCAGCCGCGGTAATACGGAGGGTGCAAGCGTTAATCGGAA |
| | | TTACTGGGCGTAAAGCGCACGCAGGCGGTCTGTCAAGTCGGATGTGAAATCCCCGGGCTC |
| | | AACCTGGGAACTGCATTCGAAACTGGCAGGCTAGAGTCTTGTAGAGGGGGGTAGAATTCC |
| | | AGGTGTAGCGGTGAAATGCGTAGAGATCTGGAGGAATACCGGTGGCGAAGGCGGCCCCCT |
| | | GGACAAAGACTGACGCTCAGGTGCGAAAGCGTGGGGAGCAAACAGGATTAGATACCCTGG |
| | | TAGTCCACGCCGTAAACGATGTCGATTTGGAGGTTGTGCCCTTGAGGCGTGGCTTCCGGA |
| | | GCTAACGCGTTAAATCGACCGCCTGGGGAGTACGGCCGCAAGGTTAAAACTCAAATGAAT |
| | | TGACGGGGGCCCGCACAAGCGGTGGAGCATGTGGTTTAATTCGATGCAACGCGAAGAACC |
| | | TTACCTGGTCTTGACATCCACAGAACTTAGCAGAGATGCTTTGGTGCCTTCGGGAACTGT |
| | | GAGACAGGTGCTGCATGGCTGTCGTCAGCTCGTGTTGTGAAATGTTGGGTTAAGTCCCGC |
| | | AACGAGCGCAACCCTTATCCTTTGTTGCCAGCGGTTAGGCCGGGAACTCAAAGGAGACTG |
| | | CCAGTGATAAACTGGAGGAAGGTGGGGATGACGTCAAGTCATCATGGCCCTTACGACCAG |
| | | GGCTACACACGTGCTACAATGGCGCATACAAAGAGAAGCGACCTCGCGAGAGCAAGCGGA |
| | | CCTCATAAAGTGCGTCGTA (SEQ ID NO: 18) |
| 10 | Pseudomonas | AACACATGCAAGTCGAGCGGATGAAAGGAGCTTGCTCCTGGATTCAGCGGCGGACGGGTG |
| | koreensis | AGTAATGCCTAGGAATCTGCTGGTAGTGGGGGACAACGTTTCGAAAGGAACGCTAATACC |
| | | GCATACGTCCTACGGGAGAAAGCAGGGGACCTTCGGGCCTTGCGCTATCAGATGAGCCTA |
| | | GGTCGGATTAGCTAGTTGGTGAGGTAATGGCTCACCAAGGCGACGATCCGTAACTGGTCT |
| | | GAGAGGATGATCAGTCACACTGGAACTGAGACACGGTCCAGACTCCTACGGGAGGCAGCA |
| | | GTGGGGAATATTGGACAATGGGCGAAAGCCTGATCCAGCCATGCCGCGTGTGTGAAGAAG |
| | | GTCTTCGGATTGTAAAGCACTTTAAGTTGGGAGGAAGGGTTGTAGATTAATACTCTGCAA |
| | | TTTTGACGTTACCGACAGAATAAGCACCGGCTAACTCTGTGCCAGCAGCCGCGGTAATAC |
| | | AGAGGGTGCAAGCGTTAATCGGAATTACTGGGCGTAAAGCGCGCGTAGGTGGTTCGTTAA |
| | | GTTGGATGTGAAATCCCCGGGCTCAACCTGGGAACTGCATCCAAAACTGGCGAGCTAGAG |
| | | TATGGTAGAGGGTGGTGGAATTTCCTGTGTAGCGGTGAAATGCGTAGATATAGGAAGGAA |
| | | CACCAGTGGCGAAGGCGACCACCTGGACTGATACTGACACTGAGGTGCGAAAGCGTGGGG |
| | | AGCAAACAGGATTAGATACCCTGGTAGTCCACGCCGTAAACGATGTCAACTAGCCGTTGG |
| | | GAGCCTTGAGCTCTTAGTGGCGCAGCTAACGCATTAAGTTGACCGCCTGGGGAGTACGGC |
| | | CGCAAGGTTAAAACTCAAATGAATTGACGGGGGCCCGCACAAGCGGTGGAGCATGTGGTT |
| | | TAATTCGAAGCAACGCGAAGAACCTTACCAGGCCTTGACATCCAATGAACTTTCCAGAGA |
| | | TGGATTGGTGCCTTCGGGAACATTGAGACAGGTGCTGCATGGCTGTCGTCAGCTCGTGTC |
| | | GTGAGATGTTGGGTTAAGTCCCGTAACGAGCGCAACCCTTGTCCTTAGTTACCAGCACGT |
| | | TATGGTGGGCACTCTAAGGAGACTGCCGGTGACAAACCGGAGGAAGGTGGGGATGACGTC |
| | | AAGTCATCATGGCCCTTACGGCCTGGGCTACACACGTGCTACAATGGTCGGTACAAAGGG |
| | | TTGCCAAGCCGCGAGGTGGAGCTAATCCCATAAAACCGATCGTAGTCCGGATCGCAGTCT |
| | | GCAACTCGACTGCGTGAAGTCGGA (SEQ ID NO: 19) |
| 11 | Pseudomonas | TCAGATTGAACGCTGCGGCAGGCCTAACACATGCAAGTCGAGCGGATGAAAGGAGCTTGC |
| | moraviensis | TCCTGGATTCAGCGGCGGACGGGTGAGTAATGCCTAGGAATCTGCCTGGTAGTGGGGGAC |
| | | AACGTTTCGAAAGGAACGCTAATACCGCATACGTCCTACGGGAGAAAGCAGGGGACCTTC |
| | | GGGCCTTGCGCTATCAGATGAGCCTAGGTCGGATTAGCTAGTTGGTGAGGTAATGGCTCA |
| | | CCAAGGCGACGATCCGTAACTGGTCTGAGAGGATGATCAGTCACACTGGAACTGAGACAC |
| | | GGTCCAGACTCCTACGGGAGGCAGCAGTGGGGAATATTGGACAATGGGCGAAAGCCTGAT |
| | | CCAGCCATGCCGCGTGTGTGAAGAAGGTCTTCGGATTGTAAAGCACTTTAAGTTGGGAGG |
| | | AAGGGTTGTAGATTAATACTCTGCAATTTTGACGTTACCGACAGAATAAGCACCGGCTAA |
| | | CTCTGTGCCAGCAGCCGCGGTAATACAGAGGGTGCAAGCGTTAATCGGAATTACTGGGCG |
| | | T-AAGCGCGCGTAGGTGGTTCGTTAAGTTGGATGTGAAATCCCCGGGCTCAACCTGGGAA |
| | | CTGCATCCAAAACTGGCGAGCTAGAGTATGGTAGAGGGTGGTGGAATTTCCTGTGTAGCG |
| | | GTGAAATGCGTAGATATAGGAAGGAACACCAGTGGCGAAGGCGACCACCTGGACTGATAC |
| | | TGACACTGAGGTGCGAAAGCGTGGGGAGCAAACAGGATTAGATACCCTGGTAGTCCACGC |
| | | CGTAAACGATGTCAACTAGCCGTTGGGAGCCTTGAGCTCTTAGTGGCGCAGCTAACGCAT |
| | | TAAGTTGACCGCCTGGGGAGTACGGCCGCAAGGTTAAAACTCAAATGAATTGACGGGGGC |
| | | CCGCACAAGCGGTGGAGCATGTGGTTTAATTCGAAGCAACGCGAAGAACCTTACCAGGCC |
| | | TTGACATCCAATGAACTTTCCAGAGATGGATTGGTGCCTTCGGGAGCATTGAGACAGGTG |
| | | CTGCATGGCTGTCGTCAGCTCGTGTCGTGAGATGTTGGGTTAAGTCCCGTAACGAGCGCA |
| | | ACCCTTGTCCTTAGTTACCAGCACGTTATGGTGGGCACTCTAAGGAGACTGCCGGTGACA |
| | | AACCGGAGGAAGGTG (SEQ ID NO: 20) |
| 12 | Bacillus nakamurai | GATGTTAGCGGCGGACGGGTGAGTAACACGTGGGTAACCTGCCTGTAAGACTGGGATAAC |
| | | TCCGGGAAACCGGGGCTAATACCGGATGCTTGTTTGAACCGCATGGTTCAAACATAAAAG |
| | | GTGGCTTCGGCTACCACTTACAGATGGACCCGCGGCGCATTAGCTAGTTGGTGAGGTAAC |
| | | GGCTCACCAAGGCAACGATGCGTAGCCGACCTGAGAGGGTGATCGGCCACACTGGGACTG |
| | | AGACACGGCCCAGACTCCTACGGGAGGCAGCAGTAGGGAATCTTCCGCAATGGACGAAAG |
| | | TCTGACGGAGCAACGCCGCGTGAGTGATGAAGGTTTTCGGATCGTAAAGCTCTGTTGTTA |
| | | GGGAAGAACAAGTGCCGTTCGAATAGGGCGGCACCTTGACGGTACCTAACCAGAAAGCCA |
| | | CGGCTAACTACGTGCCAGCAGCCGCGGTAATACGTAGGTGGCAAGCGTTGTCCGGAATTA |
| | | TTGGGCGTAAAGGGCTCGCAGGCGGTTTCTTAAGTCTGATGTGAAAGCCCCCGGCTCAAC |
| | | CGGGGAGGGTCATTGGAAACTGGGGAACTTGAGTGCAGAAGAGGAGAGTGGAATTCCACG |
| | | TGTAGCGGTGAAATGCGTAGAGATGTGGAGGAACACCAGTGGCGAAGGCGACTCTCTGGT |
| | | CTGTAACTGACGCTGAGGAGCGAAAGCGTGGGGAGCGAACAGGATTAGATACCCTGGTAG |
| | | TCCACGCCGTAAACGATGAGTGCTAAGTGTTAGGGGGTTTCCGCCCCTTAGTGCTGCAGC |
| | | TAACGCATTAAGCACTCCGCCTGGGGAGTACGGTCGCAAGACTGAAACTCAAAGGAATTG |
| | | ACGGGGGCCCGCACAAGCGGTGGAGCATGTGGTTTAATTCGAAGCAACGCGAAGAACCTT |
| | | ACCAGGTCTTGACATCCTCTGACAATCCTAGAGATAGGACGTCCCCTTCGGGGGCAGAGT |
| | | GACAGGTGGTGCATGGTTGTCGTCAGCTCGTGTCGTGAGATGTTGGGTTAAGTCCCGCAA |
| | | CGAGCGCAACCCTTGATCTTAGTTGCCAGCATTCAGTTGGGCACTCTAAGGTGACTGCCG |
| | | GTGACAAACCGGAGGAAGGTGGGGATGACGTCAAATCATCATGCCCCTTATGACCTGGGC |
| | | TACACACGTGCTACAATGGACAGAACAAAGGGCAGCGAAACCGCGAGGTTAAGCCAATCC |
| | | CACAAATCTGTTCTCAGTTCGGATCGCAGTCTGCAACTCGACTGCGTGAAGCTGGAATCG |
| | | CTAGTATCGGCG (SEQ ID NO: 21) |
| 13 | Staphylococcus | AATACATGCAAGTCGAGCGAACAGATAAGGAGCTTGCTCCTTTGACGTTAGCGGCGGACG |
| | pasteuri | GGTGAGTAACACGTGGATAACCTACCTATAAGACTGGGATAACTTCGGGAAACCGGAGCT |
| | | AATACCGGATAAGATTTTGAACCGCATGGTTCAATAGTGAAAGACGGCCTTGCTGTCACT |
| | | TATAGATGGATCCGCGCCGTATTAGCTAGTTGGTAAGGTAACGGCTTACCAAGGCAACGA |
| | | TACGTAGCCGACCTGAGAGGGTGATCGGCCACACTGGAACTGAGACACGGTCCAGACTCC |
| | | TACGGGAGGCAGCAGTAGGGAATCTTCCGCAATGGGCGAAAGCCTGACGGAGCAACGCCG |
| | | CGTGAGTGATGAAGGTCTTCGGATCGTAAAACTCTGTTATCAGGGAAGAACAAACGTGTA |
| | | AGTAACTGTGCACGTCTTGACGGTACCTGATCAGAAAGCCACGGCTAACTACGTGCCAGC |
| | | AGCCGCGGTAATACGTAGGTGGCAAGCGTTATCCGGAATTATTGGGCGTAAAGCGCGCGT |
| | | AGGCGGTTTTTTAAGTCTGATGTGAAAGCCCACGGCTCAACCGTGGAGGGTCATTGGAAA |
| | | CTGGAAAACTTGAGTGCAGAAGAGGAAAGTGGAATTCCATGTGTAGCGGTGAAATGCGCA |
| | | GAGATATGGAGGAACACCAGTGGCGAAGGCGACTTTCTGGTCTGTAACTGACGCTGATGT |
| | | GCGAAAGCGTGGGGATCAAACAGGATTAGATACCCTGGTAGTCCACGCCGTAAACGATGA |
| | | GTGCTAAGTGTTAGGGGGTTTCCGCCCCTTAGTGCTGCAGCTAACGCATTAAGCACTCCG |
| | | CCTGGGGAGTACGACCGCAAGGTTGAAACTCAAAGGAATTGACGGGGACCCGCACAAGCG |
| | | GTGGAGCATGTGGTTTAATTCGAAGCAACGCGAAGAACCTTACCAAATCTTGACATCCTT |
| | | TGACCGCTCTAGAGATAGAGTTTTCCCCTTCGGGGGACAAAGTGACAGGTGGTGCATGGT |
| | | TGTCGTCAGCTCGTGTCGTGAGATGTTGGGTTAAGTCCCGCAACGAGCGCAACCCTTAAG |
| | | CTTAGTTGCCATCATTAAGTTGGGCACTCTAAGTTGACTGCCGGTGACAAACCGGAGGAA |
| | | GGTGGGGATGACGTCAAATCATCATGCCCCTTATGATTTGGGCTACACACGTGCTACAAT |
| | | GGACAATACAAAGGGCAGCTAAACCGCGAGGTCAAGCAAATCCCATAAAGTTGTTCTCAG |
| | | TTCGGATTGTAGTCTGCAACTCGACTACATGAAGCTGGAGTCGCTAGTATCCGC |
| | | (SEQ ID NO: 22) |
| 19 | Preista megaterium | AGATGGTTTCGGCTATCACTTACAGATGGGCCCGCGGTGCATTAGCTAGTTGGTGAGGTA |
| | | ACGGCTCACCAAGGCAACGATGCATAGCCGACCTGAGAGGGTGATCGGCCACACTGGGAC |
| | | TGAGACACGGCCCAGACTCCTACGGGAGGCAGCAGTAGGGAATCTTCCGCAATGGACGAA |
| | | AGTCTGACGGAGCAACGCCGCGTGAGTGATGAAGGCTTTCGGGTCGTAAAACTCTGTTGT |
| | | TAGGGAAGAACAAGTACAAGAGTAACTGCTTGTACCTTGACGGTACCTAACCAGAAAGCC |
| | | ACGGCTAACTACGTGCCAGCAGCCGCGGTAATACGTAGGTGGCAAGCGTTATCCGGAATT |
| | | ATTGGGCGTAAAGCGCGCGCAGGCGGTTTCTTAAGTCTGATGTGAAAGCCCACGGCTCAA |
| | | CCGTGGAGGGTCATTGGAAACTGGGGAACTTGAGTGCAGAAGAGAAAAGCGGAATTCCAC |
| | | GTGTAGCGGTGAAATGCGTAGAGATGTGGAGGAACACCAGTGGCGAAGGCGGCTTTTTGG |
| | | TCTGTAACTGACGCTGAGGCGCGAAAGCGTGGGGAGCAAACAGGATTAGATACCCTGGTA |
| | | GTCCACGCCGTAAACGATGAGTGCTAAGTGTTAGAGGGTTTCCGCCCTTTAGTGCTGCAG |
| | | CTAACGCATTAAGCACTCCGCCTGGGGAGTACGGTCGCAAGACTGAAACTCAAAGGAATT |
| | | GACGGGGGCCCGCACAAGCGGTGGAGCATGTGGTTTAATTCGAAGCAACGCGAAGAACCT |
| | | TACCAGGTCTTGACATCCTCTGACAACTCTAAAGATAGAGCGTTCCCCTTCGGGGGACAG |
| | | AGTGACAGGTGGTGCATGGTTGTCGTCAGCTCGTGTCGTGAGATGTTGGGTTAAGTCCCG |
| | | CAACGAGCGCAACCCTTGATCTTAGTTGCCAGCATTTAGTTGGGCACTCTAAGGTGACTG |
| | | CCGGTGACAAACCGGAGGAAGGTGGGGATGACGTCAAATCATCATGCCCCTTATGACCTG |
| | | GGCTACACACGTGCTACAATGGATGGTACAAAGGGCTGCAAGACCGCGAGGTCAAGCCAA |
| | | TCCCATAAAACCATTCTCAGTTCGGATTGTAGGCTGC (SEQ ID NO: 23) |
| 21 | Arthrobacter | TCAGCTTGTTGGTGGGGTAATGGCCTACCAAGGCGACGACGGGTAGCCGGCCTGAGAGGG |
| | rhombi | TGACCGGCCACACTGGGACTGAGACACGGCCCAGACTCCTACGGGAGGCAGCAGTGGGGA |
| | | ATATTGCACAATGGGCGAAAGCCTGATGCAGCGACGCCGCGTGAGGGATGACGGCCTTCG |
| | | GGTTGTAAACCTCTTTCAGTAGGGAAGAAGCGAAAGTGACGGTACCTGCAGAAGAAGCGC |
| | | CGGCTAACTACGTGCCAGCAGCCGCGGTAATACGTAGGGCGCAAGCGTTATCCGGAATTA |
| | | TTGGGCGTAAAGAGCTCGTAGGCGGTTTGTCGCGTCTGCCGTGAAAGTCCGGGGCTCAAC |
| | | CCCGGATCTGCGGTGGGTACGGGCAGACTAGAGTGATGTAGGGGAGACTGGAATTCCTGG |
| | | TGTAGCGGTGAAATGCGCAGATATCAGGAGGAACACCGATGGCGAAGGCAGGTCTCTGGG |
| | | CATTAACTGACGCTGAGGAGCGAAAGCATGGGGAGCGAACAGGATTAGATACCCTGGTAG |
| | | TCCATGCCGTAAACGTTGGGCACTAGATGTGGGGGACATTCCACGTTTTCCGCGTCGTAG |
| | | CTAACGCATTAAGTGCCCCGCCTGGGGAGTACGGCCGCAAGGCTAAAACTCAAAGGAATT |
| | | GACGGGGGCCCGCACAAGCGGCGGAGCATGCGGATTAATTCGATGCAACGCGAAGAACCT |
| | | TACCAAGGCTTGACATGGGCCGGATCGCCGCAGAAATGTGGTTTCCCCTTTGGGGCCGGT |
| | | TCACAGGTGGTGCATGGTTGTCGTCAGCTCGTGTCGTGAGATGTTGGGTTAAGTCCCGCA |
| | | ACGAGCGCAACCCTCGTTCCATGTTGCCAGCACGTAGTGGTGGGGACTCATGGGAGACTG |
| | | CCGGGGTCAACTCGGAGGAAGGTGAGGACGACGTCAAATCATCATGCCCCTTATGTCTTG |
| | | GGCTTCACGCATGCTACAATGGCCGGTACAATGGGTTGCGATACTGTGAGGTGGAGCTAA |
| | | TCCCAAAAAGCCGGTCTCA (SEQ ID NO: 24) |
| 22 | Bacillus mobilus | TAATACATGCAAGTCGAGCGAATGGATTGAGAGCTTGCTCTCAAGAAGTTAGCGGCGGAC |
| | | GGGTGAGTAACACGTGGGTAACCTGCCCATAAGACTGGGATAACTCCGGGAAACCGGGGC |
| | | TAATACCGGATAATATTTTGAACTGCATGGTTCGAAATTGAAAGGCGGCTTCGGCTGTCA |
| | | CTTATGGATGGACCCGCGTCGCATTAGCTAGTTGGTGAGGTAACGGCTCACCAAGGCAAC |
| | | GATGCGTAGCCGACCTGAGAGGGTGATCGGCCACACTGGGACTGAGACACGGCCCAGACT |
| | | CCTACGGGAGGCAGCAGTAGGGAATCTTCCGCAATGGACGAAAGTCTGACGGAGCAACGC |
| | | CGCGTGAGTGATGAAGGCTTTCGGGTCGTAAAACTCTGTTGTTAGGGAAGAACAAGTGCT |
| | | AGTTGAATAAGCTGGCACCTTGACGGTACCTAACCAGAAAGCCACGGCTAACTACGTGCC |
| | | AGCAGCCGCGGTAATACGTAGGTGGCAAGCGTTATCCGGAATTATTGGGCGTAAAGCGCG |
| | | CGCAGGTGGTTTCTTAAGTCTGATGTGAAAGCCCACGGCTCAACCGTGGAGGGTCATTGG |
| | | AAACTGGGAGACTTGAGTGCAGAAGAGGAAAGTGGAATTCCATGTGTAGCGGTGAAATGC |
| | | GTAGAGATATGGAGGAACACCAGTGGCGAAGGCGACTTTCTGGTCTGTAACTGACACTGA |
| | | GGCGCGAAAGCGTGGGGAGCAAACAGGATTAGATACCCTGGTAGTCCACGCCGTAAACGA |
| | | TGAGTGCTAAGTGTTAGAGGGTTTCCGCCCTTTAGTGCTGAAGTTAACGCATTAAGCACT |
| | | CCGCCTGGGGAGTACGGCCGCAAGGCTGAAACTCAAAGGAATTGACGGGGGCCCGCACAA |
| | | GCGGTGGAGCATGTGGTTTAATTCGAAGCAACGCGAAGAACCTTACCAGGTCTTGACATC |
| | | CTCTGAAAACCCTAGAGATAGGGCTTCTCCTTCGGGAGCAGAGTGACAGGTGGTGCATGG |
| | | TTGTCGTCAGCTCGTGTCGTGAGATGTTGGGTTAAGTCCCGCAACGAGCGCAACCCTTGA |
| | | TCTTAGTTGCCATCATTAAGTTGGGCACTCTAAGGTGACTGCCGGTGACAAACCGGAGGA |
| | | AGGTGGGGATGACGTCAAATCATCATGCCCCTTATGACCTGGGCTACACACGTGCTACAA |
| | | TGGACGGTACAAAGAGCTGCAAGACCGCGAGGTGGAGCTAATCTCATAAAACCGTTCTCA |
| | | GTTCGGATTGTAGGCTGCAACTCGCCTACATGAAGCTGGA (SEQ ID NO: 25) |
| 23 | Bacillus aerius | TGAGTAACACGTGGGTAACCTGCCTGTAAGACTGGGATAACTCCGGGAAACCGGAGCTAA |
| | | TACCGGATAGTTCCTTGAACCGCATGGTTCAAGGATGAAAGACGGTTTCGGCTGTCACTT |
| | | ACAGATGGACCCGCGGCGCATTAGCTAGTTGGTGAGGTAACGGCTCACCAAGGCGACGAT |
| | | GCGTAGCCGACCTGAGAGGGTGATCGGCCACACTGGGACTGAGACACGGCCCAGACTCCT |
| | | ACGGGAGGCAGCAGTAGGGAATCTTCCGCAATGGACGAAAGTCTGACGGAGCAACGCCGC |
| | | GTGAGTGATGAAGGTTTTCGGATCGTAAAGCTCTGTTGTTAGGGAAGAACAAGTGCAAGA |
| | | GTAACTGCTTGCACCTTGACGGTACCTAACCAGAAAGCCACGGCTAACTACGTGCCAGCA |
| | | GCCGCGGTAATACGTAGGTGGCAAGCGTTGTCCGGAATTATTGGGCGTAAAGGGCTCGCA |
| | | GGCGGTTTCTTAAGTCTGATGTGAAAGCCCCCGGCTCAACCGGGGAGGGTCATTGGAAAC |
| | | TGGGAAACTTGAGTGCAGAAGAGGAGAGTGGAATTCCACGTGTAGCGGTGAAATGCGTAG |
| | | AGATGTGGAGGAACACCAGTGGCGAAGGCGACTCTCTGGTCTGTAACTGACGCTGAGGAG |
| | | CGAAAGCGTGGGGAGCGAACAGGATTAGATACCCTGGTAGTCCACGCCGTAAACGATGAG |
| | | TGCTAAGTGTTAGGGGGTTTCCGCCCCTTAGTGCTGCAGCTAACGCATTAAGCACTCCGC |
| | | CTGGGGAGTACGGTCGCAAGACTGAAACTCAAAGGAATTGACGGGGGCCCGCACAAGCGG |
| | | TGGAGCATGTGGTTTAATTCGAAGCAACGCGAAGAACCTTACCAGGTCTTGACATCCTCT |
| | | GACAACCCTAGAGATAGGGCTTTCCCTTCGGGGACAGAGTGACAGGTGGTGCATGGTTGT |
| | | CGTCAGCTCGTGTCGTGAGATGTTGGGTTAAGTCCCGCAACGAGCGCAACCCTTGATCTT |
| | | AGTTGCCAGCATTCAGTTGGGCACTCTAAGGTGACTGCCGGTGACAAACCGGAGGAAGGT |
| | | GGGGATGACGTCAAATCATCATGCCCCTTATGACCTGGGCTACACACGTGCTACAATGGA |
| | | CAGAACAAAGGGCTGCGAGACCGCAAGGTTTAGCCAATCCCACAAATCTGTTCTCAGTTC |
| | | GGATCGCAGTCTGCAACTCGACTGCGTGAAGCTGGA (SEQ ID NO: 26) |
| 24 | Bacillus sp. | GGTTCAAACATAAAAAGGTGGCTTCGGCTACCACTTACAGATGGACCCGCGGCGCATTAG |
| | | CTAGTTGGTGAGGTAATGGCTCACCAAGGCAACGATGCGTAGCCGACCTGAGAGGGTGAT |
| | | CGGCCACACTGGGACTGAGACACGGCCCAGACTCCTACGGGAGGCAGCAGTAGGGAATCT |
| | | TCCGCAATGGACGAAAGTCTGACGGAGCAACGCCGCGTGAGTGATGAAGGTTTTCGGATC |
| | | GTAAAGCTCTGTTGTTAGGGAAGAACAAGTACCGTTCGAATAGGGCGGTACCTTGACGGT |
| | | ACCTAACCAGAAAGCCACGGCTAACTACGTGCCAGCAGCCGCGGTAATACGTAGGTGGCA |
| | | AGCGTTGTCCGGAATTATTGGGCGTAAAGGGCTCGCAGGCGGTTTCTTAAGTCTGATGTG |
| | | AAAGCCCCCGGCTCAACCGGGGAGGGTCATTGGAAACTGGGGAACTTGAGTGCAGAAGAG |
| | | GAGAGTGGAATTCCACGTGTAGCGGTGAAATGCGTAGAGATGTGGAGGAACACCAGTGGC |
| | | GAAGGCGACTCTCTGGTCTGTAACTGACGCTGAGGAGCGAAAGCGTGGGGAGCGAACAGG |
| | | ATTAGATACCCTGGTAGTCCACGCCGTAAACGATGAGTGCTAAGTGTTAGGGGGTTTCCG |
| | | CCCCTTAGTGCTGCAGCTAACGCATTAAGCACTCCGCCTGGGGAGTACGGTCGCAAGACT |
| | | GAAACTCAAAGGAATTGACGGGGGCCCGCACAAGCGGTGGAGCATGTGGTTTAATTCGAA |
| | | GCAACGCAAAGAACCTTACCAGGTCTTGACATCCTCTGACAATCCTAGAGATAGGACGTC |
| | | CCCTTCGGGGGCAGAGTGACAGGTGGTGCATGGTTGTCGTCAGCTCGTGTCGTGAGATGT |
| | | TGGGTTAAGTCCCGCAACGAGCGCAACCCTTGATCTTAGTTGCCAGCATTCAGTTGGGCA |
| | | CTCTAAGGTGACTGCCGATGACAAACCGGAGGAAAGTGGG (SEQ ID NO: 27) |
| 25 | Frigoribacterium | TCATGGCTCAGGACGAACGCTGGCGGCGTGCTTAACACATGCAAGTCGAACGATGAACTC |
| | endophyticum | CAGCTTGCTGGGGGGATTAGTGGCGAACGGGTGAGTAACACGTGAGTAACCTGCCCTTGA |
| | | CTCTGGGATAAGCGCTGGAAACGGCGTCTAATACCGGATACGAGCTTCAGCCGCATGGCT |
| | | AGGAGTTGGAAAGAATTTCGGTCAAGGATGGACTCGCGGCCTATCAGCTTGTTGGTGAGG |
| | | TAATGGCTCACCAAGGCGACGACGGGTAGCCGGCCTGAGAGGGTGACCGGCCACACTGGG |
| | | ACTGAGACACGGCCCAGACTCCTACGGGAGGCAGCAGTGGGGAATATTGCACAATGGGCG |
| | | AAAGCCTGATGCAGCAACGCCGCGTGAGGGATGACGGCCTTCGGGTTGTAAACCTCTTTT |
| | | AGTAGGGAAGAAGCGAAAGTGACGGTACCTGCAGAAAAAGCACCGGCTAACTACGTGCCA |
| | | GCAGCCGCGGTAATACGTAGGGTGCAAGCGTTGTCCGGAATTATTGGGCGTAAAGAGCTC |
| | | GTAGGCGGTTTGTCGCGTCTGCTGTGAAATCTGGGGGCTCAACCCCCAGCCTGCAGTGGG |
| | | TACGGGCAGACTAGAGTGCGGTAGGGGAGATTGGAATTCCTGGTGTAGCGGTGGAATGCG |
| | | CAGATATCAGGAGGAACACCGATGGCGAAGGCAGATCTCTGGGCCGTAACTGACGCTGAG |
| | | GAGCGAAAGCGTGGGGAGCGAACAGGATTAGATACCCTGGTAGTCCACGCCGTAAACGTT |
| | | GGGAACTAGATGTGGGGACCATTCCACGGTCTCCGTGTCGCAGCTAACGCATTAAGTTCC |
| | | CCGCCTGGGGAGTACGGCCGCAAGGCTAAAACTCAAAGGAATTGACGGGGGCCCGCACAA |
| | | GCGGCGGAGCATGCGGATTAATTCGATGCAACGCGAAGAACCTTACCAAGGCTTGACATA |
| | | TACCGGAAACGGCCAGAGATGGTCGCCCCGCAAGGTCGGTATACAGGTGGTGCATGGTTG |
| | | TCGTCAGCTCGTGTCGTGAGATGTTGGGTTAAGTCCCGCAACGAGCGCAACCCTCGTTCT |
| | | ATGTTGCCAGCACGTTATGGTGGGAACTCATAGGAGACTGCCGGGGTCAACTCGGAGGAA |
| | | GGTGGGGATGACGTCAAATCATCATGCCCCTTATGTCTTGGGCTTCACGCATGCTACAAT |
| | | GGCCGGTACAAAGGGCTGCGATACCGTAAGGTGGAGCGAATCCCAAAAAGCCGGTCTCAG |
| | | TTCGGATTGGGGTCTGCAACTCGACCCCATGAAGTCGGAGTC (SEQ ID NO: 28) |
| 26 | Pseudomonas | GAGTAATGCCTAGGAATCTGCCTGGTAGTGGGGGACAACGTTTCGAAAGGAACGCTAATA |
| | koreensis | CCGCATACGTCCTACGGGAGAAAGCAGGGGACCTTCGGGCCTTGCGCTATCAGATGAGCC |
| | | TAGGTCGGATTAGCTAGTTGGTGAGGTAATGGCTCACCAAGGCGACGATCCGTAACTGGT |
| | | CTGAGAGGATGATCAGTCACACTGGAACTGAGACACGGTCCAGACTCCTACGGGAGGCAG |
| | | CAGTGGGGAATATTGGACAATGGGCGAAAGCCTGATCCAGCCATGCCGCGTGTGTGAAGA |
| | | AGGTCTTCGGATTGTAAAGCACTTTAAGTTGGGAGGAAGGGTTGTAGATTAATACTCTGC |
| | | AATTTTGACGTTACCGACAGAATAAGCACCGGCTAACTCTGTGCCAGCAGCCGCGGTAAT |
| | | ACAGAGGGTGCAAGCGTTAATCGGAATTACTGGGCGTAAAGCGCGCGTAGGTGGTTCGTT |
| | | AAGTTGGATGTGAAATCCCCGGGCTCAACCTGGGAACTGCATCCAAAACTGGCGAGCTAG |
| | | AGTATGGTAGAGGGTGGTGGAATTTCCTGTGTAGCGGTGAAATGCGTAGATATAGGAAGG |
| | | AACACCAGTGGCGAAGGCGACCACCTGGACTGATACTGACACTGAGGTGCGAAAGCGTGG |
| | | GGAGCAAACAGGATTAGATACCCTGGTAGTCCACGCCGTAAACGATGTCAACTAGCCGTT |
| | | GGGAGCCTTGAGCTCTTAGTGGCGCAGCTAACGCATTAAGTTGACCGCCTGGGGAGTACG |
| | | GCCGCAAGGTTAAAACTCAAATGAATTGACGGGGGCCCGCACAAGCGGTGGAGCATGTGG |
| | | TTTAATTCGAAGCAACGCGAAGAACCTTACCAGGCCTTGACATCCAATGAACTTTCCAGA |
| | | GATGGATTGGTGCCTTCGGGAGCATTGAGACAGGTGCTGCATGGCTGTCGTCAGCTCGTG |
| | | TCGTGAGATGTTGGGTTAAGTCCCGTAACGAGCGCAACCCTTGTCCTTAGTTACCAGCAC |
| | | GTTATGGTGGGCACTCTAAGGAGACTGCCGGTGACAAACCGGAGGAAGGTGGGGATGACG |
| | | TCAAGTCATCATGGCCCTTACGGCCTGGGCTACACACGTGCTACAATGGTCGGTACAAAG |
| | | GGTTGCCAAGCCGCGAGGTGGAGCTAATCCCATAAAACCGATCGTAGTCCGGATCGCAGT |
| | | CTGCAACTCGACTGCGTGAAGTCGGAGTCGCTAGTATCC (SEQ ID NO: 29) |
| 27 | Bacillus | AATACATGCAAGTCGAGCGGACAGAAGGGAGCTTGCTCCCGGATGTTAGCGGCGGACGGG |
| | stratosphericus | TGAGTAACACGTGGGTAACCTGCCTGTAAGACTGGGATAACTCCGGGAAACCGGAGCTAA |
| | | TACCGGATAGTTCCTTGAACCGCATGGTTCAAGGATGAAAGACGGTTTCGGCTGTCACTT |
| | | ACAGATGGACCCGCGGCGCATTAGCTAGTTGGTGAGGTAACGGCTCACCAAGGCGACGAT |
| | | GCGTAGCCGACCTGAGAGGGTGATCGGCCACACTGGGACTGAGACACGGCCCAGACTCCT |
| | | ACGGGAGGCAGCAGTAGGGAATCTTCCGCAATGGACGAAAGTCTGACGGAGCAACGCCGC |
| | | GTGAGTGATGAAGGTTTTCGGATCGTAAAGCTCTGTTGTTAGGGAAGAACAAGTGCAAGA |
| | | GTAACTGCTTGCACCTTGACGGTACCTAACCAGAAAGCCACGGCTAACTACGTGCCAGCA |
| | | GCCGCGGTAATACGTAGGTGGCAAGCGTTGTCCGGAATTATTGGGCGTAAAGGGCTCGCA |
| | | GGCGGTTTCTTAAGTCTGATGTGAAAGCCCCCGGCTCAACCGGGGAGGGTCATTGGAAAC |
| | | TGGGAAACTTGAGTGCAGAAGAGGAGAGTGGAATTCCACGTGTAGCGGTGAAATGCGTAG |
| | | AGATGTGGAGGAACACCAGTGGCGAAGGCGACTCTCTGGTCTGTAACTGACGCTGAGGAG |
| | | CGAAAGCGTGGGGAGCGAACAGGATTAGATACCCTGGTAGTCCACGCCGTAAACGATGAG |
| | | TGCTAAGTGTTAGGGGGTTTCCGCCCCTTAGTGCTGCAGCTAACGCATTAAGCACTCCGC |
| | | CTGGGGAGTACGGTCGCAAGACTGAAACTCAAAGGAATTGACGGGGGCCCGCACAAGCGG |
| | | TGGAGCATGTGGTTTAATTCGAAGCAACGCGAAGAACCTTACCAGGTCTTGACATCCTCT |
| | | GACAACCCTAGAGATAGGGCTTTCCCTTCGGGGACAGAGTGACAGGTGGTGCATGGTTGT |
| | | CGTCAGCTCGTGTCGTGAGATGTTGGGTTAAGTCCCGCAACGAGCGCAACCCTTGATCTT |
| | | AGTTGCCAGCATTTAGTTGGGCACTCTAAGGTGACTGCCGGTGACAAACCGGAGGAAGGT |
| | | GGGGATGACGTCAAATCATCATGCCCCTTATGACCTGGGCTACACACGTGCTACAATGGA |
| | | CAGAACAAAGGGCTGCGAGACCGCAAGGTTTAGCCAATCCCACAAATCTGTTCTCAGTTC |
| | | GGATCGCAGTCTGCAACTCGACTGCGTGAAGCTGGAGTCGCTAGTATCGCAGATCAGCAT |
| | | GCCGCGGTGAATACGTTCCCGGGCCTTGTACACACCGCCCGTCACACCACGAGAGTTTGC |
| | | AACACCCGAAGT (SEQ ID NO: 30) |
| 28 | Bacillus | TGCCTGTAAGACTGGGATAACTCCGGGAAACCGGAGCTAATACCGGATAGTTCCTTGAAC |
| | stratosphericus | CGCATGGTTCAAGGATGAAAGACGGTTTCGGCTGTCACTTACAGATGGACCCGCGGCGCA |
| | | TTAGCTAGTTGGTGAGGTAACGGCTCACCAAGGCGACGATGCGTAGCCGACCTGAGAGGG |
| | | TGATCGGCCACACTGGGACTGAGACACGGCCCAGACTCCTACGGGAGGCAGCAGTAGGGA |
| | | ATCTTCCGCAATGGACGAAAGTCTGACGGAGCAACGCCGCGTGAGTGATGAAGGTTTTCG |
| | | GATCGTAAAGCTCTGTTGTTAGGGAAGAACAAGTGCAAGAGTAACTGCTTGCACCTTGAC |
| | | GGTACCTAACCAGAAAGCCACGGCTAACTACGTGCCAGCAGCCGCGGTAATACGTAGGTG |
| | | GCAAGCGTTGTCCGGAATTATTGGGCGTAAAGGGCTCGCAGGCGGTTTCTTAAGTCTGAT |
| | | GTGAAAGCCCCCGGCTCAACCGGGGAGGGTCATTGGAAACTGGGAAACTTGAGTGCAGAA |
| | | GAGGAGAGTGGAATTCCACGTGTAGCGGTGAAATGCGTAGAGATGTGGAGGAACACCAGT |
| | | GGCGAAGGCGACTCTCTGGTCTGTAACTGACGCTGAGGAGCGAAAGCGTGGGGAGCGAAC |
| | | AGGATTAGATACCCTGGTAGTCCACGCCGTAAACGATGAGTGCTAAGTGTTAGGGGGTTT |
| | | CCGCCCCTTAGTGCTGCAGCTAACGCATTAAGCACTCCGCCTGGGGAGTACGGTCGCAAG |
| | | ACTGAAACTCAAAGGAATTGACGGGGGCCCGCACAAGCGGTGGAGCATGTGGTTTAATTC |
| | | GAAGCAACGCGAAGAACCTTACCAGGTCTTGACATCCTCTGACAACCCTAGAGATAGGGC |
| | | TTTCCCTTCGGGGACAGAGTGACAGGTGGTGCATGGTTGTCGTCAGCTCGTGTCGTGAGA |
| | | TGTTGGGTTAAGTCCCGCAACGAGCGCAACCCTTGATCTTAGTTGCCAGCATTTAGTTGG |
| | | GCACTCTAAGGTGACTGCCGGTGACAAACCGGAGGAAGGTGGGGATGACGTCAAATCATC |
| | | ATGCCCCTTATGACCTGGGCTACACACGTGCTACAATGGACAGAACAAAGGGCTGCGAGA |
| | | CCGCAAGGTTTAGCCAATCCCACAAATCTGTTCTCA (SEQ ID NO: 31) |
| 29 | Bacillus | AATACATGCAAGTCGAGCGGACAGAAGGGAGCTTGCTCCCGGATGTTAGCGGCGGACGGG |
| | stratosphericus | TGAGTAACACGTGGGTAACCTGCCTGTAAGACTGGGATAACTCCGGGAAACCGGAGCTAA |
| | | TACCGGATAGTTCCTTGAACCGCATGGTTCAAGGATGAAAGACGGTTTCGGCTGTCACTT |
| | | ACAGATGGACCCGCGGCGCATTAGCTAGTTGGTGAGGTAACGGCTCACCAAGGCGACGAT |
| | | GCGTAGCCGACCTGAGAGGGTGATCGGCCACACTGGGACTGAGACACGGCCCAGACTCCT |
| | | ACGGGAGGCAGCAGTAGGGAATCTTCCGCAATGGACGAAAGTCTGACGGAGCAACGCCGC |
| | | GTGAGTGATGAAGGTTTTCGGATCGTAAAGCTCTGTTGTTAGGGAAGAACAAGTGCAAGA |
| | | GTAACTGCTTGCACCTTGACGGTACCTAACCAGAAAGCCACGGCTAACTACGTGCCAGCA |
| | | GCCGCGGTAATACGTAGGTGGCAAGCGTTGTCCGGAATTATTGGGCGTAAAGGGCTCGCA |
| | | GGCGGTTTCTTAAGTCTGATGTGAAAGCCCCCGGCTCAACCGGGGAGGGTCATTGGAAAC |
| | | TGGGAAACTTGAGTGCAGAAGAGGAGAGTGGAATTCCACGTGTAGCGGTGAAATGCGTAG |
| | | AGATGTGGAGGAACACCAGTGGCGAAGGCGACTCTCTGGTCTGTAACTGACGCTGAGGAG |
| | | CGAAAGCGTGGGGAGCGAACAGGATTAGATACCCTGGTAGTCCACGCCGTAAACGATGAG |
| | | TGCTAAGTGTTAGGGGGTTTCCGCCCCTTAGTGCTGCAGCTAACGCATTAAGCACTCCGC |
| | | CTGGGGAGTACGTCGCAAGACTGAAACTCAAAGGAATTGACGGGGGCCCGCACAAGCGG |
| | | TGGAGCATGTGGTTTAATTCGAAGCAACGCGAAGAACCTTACCAGGTCTTGACATCCTCT |
| | | GACAACCCTAGAGATAGGGCTTTCCCTTCGGGGACAGAGTGACAGGTGGTGCATGGTTGT |
| | | CGTCAGCTCGTGTCGTGAGATGTTGGGTTAAGTCCCGCAACGAGCGCAACCCTTGATCTT |
| | | AGTTGCCAGCATTTAGTTGGGCACTCTAAGGTGACTGCCGGTGACAAACCGGAGGAAGGT |
| | | GGGGATGACGTCAAATCATCATGCCCCTTATGACCTGGGCTACACACGTGCTACAATGGA |
| | | CAGAACAAAGGGCTGCGAGACCGCAAGGTTTAGCCAATCCCACAAATCTGTTCTCAGTTC |
| | | GGATCGCAGTCTGCAACTCGACTGCGTGAAGCTGGA (SEQ ID NO: 32) |
| 30 | Bacillus sp. | TACATGCAAGTCGAGCGGACAGAAGGGAGCTTGCTCCCGGATGTTAGCGGCGGACGGGTG |
| | | AGTAACACGTGGGTAACCTGCCTGTAAGACTGGGATAACTCCGGGAAACCGGAGCTAATA |
| | | CCGGATAGTTCCTTGAACCGCATGGTTCAAGGATGAAAGACGGTTTCGGCTGTCACTTAC |
| | | AGATGGACCCGCGGCGCATTAGCTAGTTGGTGAGGTAACGGCTCACCAAGGCGACGATGC |
| | | GTAGCCGACCTGAGAGGGTGATCGGCCACACTGGGACTGAGACACGGCCCAGACTCCTAC |
| | | GGGAGGCAGCAGTAGGGAATCTTCCGCAATGGACGAAAGTCTGACGGAGCAACGCCGCGT |
| | | GAGTGATGAAGGTTTTCGGATCGTAAAGCTCTGTTGTTAGGGAAGAACAAGTGCAAGAGT |
| | | AACTGCTTGCACCTTGACGGTACCTAACCAGAAAGCCACGGCTAACTACGTGCCAGCAGC |
| | | CGCGGTAATACGTAGGTGGCAAGCGTTGTCCGGAATTATTGGGCGTAAAGGGCTCGCAGG |
| | | CGGTTTCTTAAGTCTGATGTGAAAGCCCCCGGCTCAACCGGGGAGGGTCATTGGAAACTG |
| | | GGAAACTTGAGTGCAGAAGAGGAGAGTGGAATTCCACGTGTAGCGGTGAAATGCGTAGAG |
| | | ATGTGGAGGAACACCAGTGGCGAAGGCGACTCTCTGGTCTGTAACTGACGCTGAGGAGCG |
| | | AAAGCGTGGGGAGCGAACAGGATTAGATACCCTGGTAGTCCACGCCGTAAACGATGAGTG |
| | | CTAAGTGTTAGGGGGTTTCCGCCCCTTAGTGCTGCAGCTAACGCATTAAGCACTCCGCCT |
| | | GGGGAGTACGGTCGCAAGACTGAAACTCAAAGGAATTGACGGGGGCCCGCACAAGCGGTG |
| | | GAGCATGTGGTTTAATTCGAAGCAACGCGAAGAACCTTACCAGGTCTTGACATCCTCTGA |
| | | CAACCCTAGAGATAGGGCTTTCCCTTCGGGGACAGAGTGACAGGTGGTGCATGGTTGTCG |
| | | TCAGCTCGTGTCGTGAGATGTTGGGTTAAGTCCCGCAACGAGCGCAACCCTTGATCTTAG |
| | | TTGCCAGCATTCAGTTGGGCACTCTAAGGTGACTGCCGGTGACAAACCGGAGGAAGGTGG |
| | | GGATGACGTCAAATCATCATGCCCCTTATGACCTGGGCTACACACGTGCTACAATGGACA |
| | | GAACAAAGGGCTGCGAGACCGCAAGGTTTAGCCAATCCCACAAATCTGTTCTCAGTTCGG |
| | | ATCGCAGTCTGCAACTCGACTGCGTGAAGCTGG (SEQ ID NO: 33) |
| 31 | Bacillus nakamurai | GATGTTAGCGGCGGACGGGTGAGTAACACGTGGGTAACCTGCCTGTAAGACTGGGATAAC |
| | | TCCGGGAAACCGGGGCTAATACCGGATGCTTGTTTGAACCGCATGGTTCAAACATAAAAG |
| | | GTGGCTTCGGCTACCACTTACAGATGGACCCGCGGCGCATTAGCTAGTTGGTGAGGTAAC |
| | | GGCTCACCAAGGCAACGATGCGTAGCCGACCTGAGAGGGTGATCGGCCACACTGGGACTG |
| | | AGACACGGCCCAGACTCCTACGGGAGGCAGCAGTAGGGAATCTTCCGCAATGGACGAAAG |
| | | TCTGACGGAGCAACGCCGCGTGAGTGATGAAGGTTTTCGGATCGTAAAGCTCTGTTGTTA |
| | | GGGAAGAACAAGTGCCGTTCGAATAGGGCGGCACCTTGACGGTACCTAACCAGAAAGCCA |
| | | CGGCTAACTACGTGCCAGCAGCCGCGGTAATACGTAGGTGGCAAGCGTTGTCCGGAATTA |
| | | TTGGGCGTAAAGGGCTCGCAGGCGGTTTCTTAAGTCTGATGTGAAAGCCCCCGGCTCAAC |
| | | CGGGGAGGGTCATTGGAAACTGGGGAACTTGAGTGCAGAAGAGGAGAGTGGAATTCCACG |
| | | TGTAGCGGTGAAATGCGTAGAGATGTGGAGGAACACCAGTGGCGAAGGCGACTCTCTGGT |
| | | CTGTAACTGACGCTGAGGAGCGAAAGCGTGGGGAGCGAACAGGATTAGATACCCTGGTAG |
| | | TCCACGCCGTAAACGATGAGTGCTAAGTGTTAGGGGGTTTCCGCCCCTTAGTGCTGCAGC |
| | | TAACGCATTAAGCACTCCGCCTGGGGAGTACGGTCGCAAGACTGAAACTCAAAGGAATTG |
| | | ACGGGGGCCCGCACAAGCGGTGGAGCATGTGGTTTAATTCGAAGCAACGCGAAGAACCTT |
| | | ACCAGGTCTTGACATCCTCTGACAATCCTAGAGATAGGACGTCCCCTTCGGGGGCAGAGT |
| | | GACAGGTGGTGCATGGTTGTCGTCAGCTCGTGTCGTGAGATGTTGGGTTAAGTCCCGCAA |
| | | CGAGCGCAACCCTTGATCTTAGTTGCCAGCATTCAGTTGGGCACTCTAAGGTGACTGCCG |
| | | GTGACAAACCGGAGGAAGGTGGGGATGACGTCAAATCATCATGCCCCTTATGACCTGGGC |
| | | TACACACGTGCTACAATGGACAGAACAAAGGGCAGCGAAACCGCGAGGTTAAGCCAATCC |
| | | CACAAATCTGTTCTCAGTTCGGATCGCAGTCTGCAACTCGACTGCGTGAAGCTGGAATCG |
| | | CTAGTATC (SEQ ID NO: 34) |
| 32 | Priestia | AATACATGCAAGTCGAGCGAACTGATTAGAAGCTTGCTTCTATGACGTTAGCGGCGGACG |
| | megaterium | GGTGAGTAACACGTGGGCAACCTGCCTGTAAGACTGGGATAACTTCGGGAAACCGAAGCT |
| | | AATACCGGATAGGATCTTCTCCTTCATGGGAGATGATTGAAAGATGGTTTCGGCTATCAC |
| | | TTACAGATGGGCCCGCGGTGCATTAGCTAGTTGGTGAGGTAACGGCTCACCAAGGCAACG |
| | | ATGCATAGCCGACCTGAGAGGGTGATCGGCCACACTGGGACTGAGACACGGCCCAGACTC |
| | | CTACGGGAGGCAGCAGTAGGGAATCTTCCGCAATGGACGAAAGTCTGACGGAGCAACGCC |
| | | GCGTGAGTGATGAAGGCTTTCGGGTCGTAAAACTCTGTTGTTAGGGAAGAACAAGTACAA |
| | | GAGTAACTGCTTGTACCTTGACGGTACCTAACCAGAAAGCCACGGCTAACTACGTGCCAG |
| | | CAGCCGCGGTAATACGTAGGTGGCAAGCGTTATCCGGAATTATTGGGCGTAAAGCGCGCG |
| | | CAGGCGGTTTCTTAAGTCTGATGTGAAAGCCCACGGCTCAACCGTGGAGGGTCATTGGAA |
| | | ACTGGGGAACTTGAGTGCAGAAGAGAAAAGCGGAATTCCACGTGTAGCGGTGAAATGCGT |
| | | AGAGATGTGGAGGAACACCAGTGGCGAAGGCGGCTTTTTGGTCTGTAACTGACGCTGAGG |
| | | CGCGAAAGCGTGGGGAGCAAACAGGATTAGATACCCTGGTAGTCCACGCCGTAAACGATG |
| | | AGTGCTAAGTGTTAGAGGGTTTCCGCCCTTTAGTGCTGCAGCTAACGCATTAAGCACTCC |
| | | GCCTGGGGAGTACGGTCGCAAGACTGAAACTCAAAGGAATTGACGGGGGCCCGCACAAGC |
| | | GGTGGAGCATGTGGTTTAATTCGAAGCAACGCGAAGAACCTTACCAGGTCTTGACATCCT |
| | | CTGACAACTCTAGAGATAGAGCGTTCCCCTTCGGGGGACAGAGTGACAGGTGGTGCATGG |
| | | TTGTCGTCAGCTCGTGTCGTGAGATGTTGGGTTAAGTCCCGCAACGAGCGCAACCCTTGA |
| | | TCTTAGTTGCCAGCATTTAGTTGGGCACTCTAAGGTGACTGCCGGTGACAAACCGGAGGA |
| | | AGGTGGGGATGACGTCAAATCATCATGCCCCTTATGACCTGGGCTACACACGTGCTACAA |
| | | TGGATGGTACAAAGGGCTGCAAGACCGCGAGGTCAAGCCAATCCCATAAAACCATTCTCA |
| | | GTTCGGATTGTAGGCTGCAACTCGCCTACATGAAGCTGGAGTCGCTAGTATCGCCAGATC |
| | | AG (SEQ ID NO: 35) |
| 33 | Bacillus subtilis | GATGTTAGCGGCGGACGGGTGAGTAACACGTGGGTAACCTGCCTGTAAGACTGGGATAAC |
| | | TCCGGGAAACCGGGGCTAATACCGGATGGTTGTTTGAACCGCATGGTTCAAACATAAAAG |
| | | GTGGCTTCGGCTACCACTTACAGATGGACCCGCGGCGCATTAGCTAGTTGGTGAGGTAAC |
| | | GGCTCACCAAGGCAACGATGCGTAGCCGACCTGAGAGGGTGATCGGCCACACTGGGACTG |
| | | AGACACGGCCCAGACTCCTACGGGAGGCAGCAGTAGGGAATCTTCCGCAATGGACGAAAG |
| | | TCTGACGGAGCAACGCCGCGTGAGTGATGAAGGTTTTCGGATCGTAAAGCTCTGTTGTTA |
| | | GGGAAGAACAAGTACCGTTCGAATAGGGCGGTACCTTGACGGTACCTAACCAGAAAGCCA |
| | | CGGCTAACTACGTGCCAGCAGCCGCGGTAATACGTAGGTGGCAAGCGTTGTCCGGAATTA |
| | | TTGGGCGTAAAGGGCTCGCAGGCGGTTTCTTAAGTCTGATGTGAAAGCCCCCGGCTCAAC |
| | | CGGGGAGGGTCATTGGAAACTGGGGAACTTGAGTGCAGAAGAGGAGAGTGGAATTCCACG |
| | | TGTAGCGGTGAAATGCGTAGAGATGTGGAGGAACACCAGTGGCGAAGGCGACTCTCTGGT |
| | | CTGTAACTGACGCTGAGGAGCGAAAGCGTGGGGAGCGAACAGGATTAGATACCCTGGTAG |
| | | TCCACGCCGTAAACGATGAGTGCTAAGTGTTAGGGGGTTTCCGCCCCTTAGTGCTGCAGC |
| | | TAACGCATTAAGCACTCCGCCTGGGGAGTACGGTCGCAAGACTGAAACTCAAAGGAATTG |
| | | ACGGGGGCCCGCACAAGCGGTGGAGCATGTGGTTTAATTCGAAGCAACGCGAAGAACCTT |
| | | ACCAGGTCTTGACATCCTCTGACAATCCTAGAGATAGGACGTCCCCTTCGGGGGCAGAGT |
| | | GACAGGTGGTGCATGGTTGTCGTCAGCTCGTGTCGTGAGATGTTGGGTTAAGTCCCGCAA |
| | | CGAGCGCAACCCTTGATCTTAGTTGCCAGCATTCAGTTGGGCACTCTAAGGTGACTGCCG |
| | | GTGACAAACCGGAGGAAGGTGGGGATGACGTCAAATCATCATGCCCCTTATGACCTGGGC |
| | | TACACACGTGCTACAATGGACAGAACAAAGGGCAGCGAAACCGCGAGGTTAAGCCAATCC |
| | | CACAAATCTGTTCTCAGTTCGGATCGCAGTCTGCAACTCGACTGCGTGAAGCTGGA |
| | | (SEQ ID NO: 36) |
| 35 | Bacillus safensis | ATGTTAGCGGCGGACGGGTGAGTAACACGTGGGTAACTGCCTGTAAGACTGGGATAACTC |
| | | CGGGAAACCGGAGCTAATACCGGATAGTTCCTTGAACCGCATGGTTCAAGGATGAAAGAC |
| | | GGTTTCGGCTGTCACTTACAGATGGACCCGCGGCGCATTAGCTAGTTGGTGGGGTAATGG |
| | | CTCACCAAGGCGACGATGCGTAGCCGACCTGAGAGGGTGATCGGCCACACTGGGACTGAG |
| | | ACACGGCCCAGACTCCTACGGGAGGCAGCAGTAGGGAATCTTCCGCAATGGACGAAAGTC |
| | | TGACGGAGCAACGCCGCGTGAGTGATGAAGGTTTTCGGATCGTAAAGCTCTGTTGTTAGG |
| | | GAAGAACAAGTGCGAGAGTAACTGCTCGCACCTTGACGGTACCTAACCAGAAAGCCACGG |
| | | CTAACTACGTGCCAGCAGCCGCGGTAATACGTAGGTGGCAAGCGTTGTCCGGAATTATTG |
| | | GGCGTAAAGGGCTCGCAGGCGGTTTCTTAAGTCTGATGTGAAAGCCCCCGGCTCAACCGG |
| | | GGAGGGTCATTGGAAACTGGGAAACTTGAGTGCAGAAGAGGAGAGTGGAATTCCACGTGT |
| | | AGCGGTGAAATGCGTAGAGATGTGGAGGAACACCAGTGGCGAAGGCGACTCTCTGGTCTG |
| | | TAACTGACGCTGAGGAGCGAAAGCGTGGGGAGCGAACAGGATTAGATACCCTGGTAGTCC |
| | | ACGCCGTAAACGATGAGTGCTAAGTGTTAGGGGGTTTCCGCCCCTTAGTGCTGCAGCTAA |
| | | CGCATTAAGCACTCCGCCTGGGGAGTACGGTCGCAAGACTGAAACTCAAAGGAATTGACG |
| | | GGGGCCCGCACAAGCGGTGGAGCATGTGGTTTAATTCGAAGCAACGCGAAGAACCTTACC |
| | | AGGTCTTGACATCCTCTGACAACCCTAGAGATAGGGCTTTCCCTTCGGGGACAGAGTGAC |
| | | AGGTGGTGCATGGTTGTCGTCAGCTCGTGTCGTGAGATGTTGGGTTAAGTCCCGCAACGA |
| | | GCGCAACCCTTGATCTTAGTTGCCAGCATTCAGTTGGGCACTCTAAGGTGACTGCCGGTG |
| | | ACAAACCGGAGGAAGGTGGGGATGACGTCAAATCATCATGCCCCTTATGACCTGGGCTAC |
| | | ACACGTGCTACAATGGACAGAACAAAGGGCTGCAAGACCGCAAGGTTTAGCCAATCCCAT |
| | | AAATCTGTTCTCAGTTCGGATCGCA (SEQ ID NO: 37) |
| 37 | Pantoea | AGCACAGAGAGCTTGCTCTCGGGTGACGAGTGGCGGACGGGTGAGTAATGTCTGGGGATC |
| | agglomerans | TGCCCGATAGAGGGGGATAACCACTGGAAACGGTGGCTAATACCGCATAACGTCGCAAGA |
| | | CCAAAGAGGGGGACCTTCGGGCCTCTCACTATCGGATGAACCCAGATGGGATTAGCTAGT |
| | | AGGCGGGGTAACGGCCCACCTAGGCGACGATCCCTAGCTGGTCTGAGAGGATGACCAGCC |
| | | ACACTGGAACTGAGACACGGTCCAGACTCCTACGGGAGGCAGCAGTGGGGAATATTGCAC |
| | | AATGGGCGCAAGCCTGATGCAGCCATGCCGCGTGTATGAAGAAGGCCTTCGGGTTGTAAA |
| | | GTACTTTCAGCGGGGAGGAAGGCGATGTGGTTAATAACCGCGTCGATTGACGTTACCCGC |
| | | AGAAGAAGCACCGGCTAACTCCGTGCCAGCAGCCGCGGTAATACGGAGGGTGCAAGCGTT |
| | | AATCGGAATTACTGGGCGTAAAGCGCACGCAGGCGGTCTGTTAAGTCAGATGTGAAATCC |
| | | CCGGGCTTAACCTGGGAACTGCATTTGAAACTGGCAGGCTTGAGTCTCGTAGAGGGGGGT |
| | | AGAATTCCAGGTGTAGCGGTGAAATGCGTAGAGATCTGGAGGAATACCGGTGGCGAAGGC |
| | | GGCCCCCTGGACGAAGACTGACGCTCAGGTGCGAAAGCGTGGGGAGCAAACAGGATTAGA |
| | | TACCCTGGTAGTCCACGCCGTAAACGATGTCGACTTGGAGGTTGTTCCCTTGAGGAGTGG |
| | | CTTCCGGAGCTAACGCGTTAAGTCGACCGCCTGGGGAGTACGGCCGCAAGGTTAAAACTC |
| | | AAATGAATTGACGGGGGCCCGCACAAGCGGTGGAGCATGTGGTTTAATTCGATGCAACGC |
| | | GAAGAACCTTACCTACTCTTGACATCCACGGAATTTGGCAGAGATGCCTTAGTGCCTTCG |
| | | GGAACCGTGAGACAGGTGCTGCATGGCTGTCGTCAGCTCGTGTTGTGAAATGTTGGGTTA |
| | | AGTCCCGCAACGAGCGCAACCCTTATCCTTTGTTGCCAGCGATTCGGTCGGGAACTCAAA |
| | | GGAGACTGCCGGTGATAAACCGGAGGAAGGTGGGGATGACGTCAAGTCATCATGGCCCTT |
| | | ACGAGTAGGGCTACACACGTGCTACAATGGCGCATACAAAGAGAAGCGACCTCGCGAGAG |
| | | CAAGCGGACCTCATAAAGTGCGTCGTA (SEQ ID NO: 38) |
| 39 | Arthrobacter | TCGCGGCCTATCAGCTTGTTGGTGGGGTAATGGCCTACCAAGGCGACGACGGGTAGCCGG |
| | silviterrae | CCTGAGAGGGTGACCGGCCACACTGGGACTGAGACACGGCCCAGACTCCTACGGGAGGCA |
| | | GCAGTGGGGAATATTGCACAATGGGCGGAAGCCTGATGCAGCGACGCCGCGTGAGGGATG |
| | | ACGGCCTTCGGGTTGTAAACCTCTTTCAGTAGGGAACAAGGCCATACGTTGTGTGGTTGA |
| | | GGGTACTTGCAGAAGAAGCGCCGGCTAACTACGTGCCAGCAGCCGCGGTAATAAGTAGGG |
| | | CGCAAGCGTTATCCGGAATTATTGGGCGTAAAGAGCTCGTAGGCGGTTTGTCGCGTCTGC |
| | | CGTGAAAGTCCGGGGCTCAACTCCGGATCTGCGGTGGGTACGGGCAGACTAGAGTGCAGT |
| | | AGGGGAGACTGGAATTCCTGGTGTAGCGGTGAAATGCGCAGATATCAGGAGGAACACCGA |
| | | TGGCGAAGGCAGGTCTCTGGGCTGTAACTGACGCTGAGGAGCGAAAGCATGGGGAGCGAA |
| | | CAGGATTAGATACCCTGGTAGTCCATGCCGTAAACGTTGGGCACTAGGTGTGGGGGACAT |
| | | TCCACGTTTTCCGCGCCGTAGCTAACGCATTAAGTGCCCCGCCTGGGGAGTACGGCCGCA |
| | | AGGCTAAAACTCAAAGGAATTGACGGGGGCCCGCACAAGCGGCGGAACATGCGGATTAAT |
| | | TCGATGCAACGCGAAGAACCTTACCAAGGCTTGACATGAACCGGATCGGCCTGGAAACAG |
| | | GTCTTCCACTTGTGGCTGGTTTACAGGTGGTGCATGGTTGTCGTCAGCTCGTGTCGTGAG |
| | | ATGTTGGGTTAAGTCCCGCAACGAGCGCAACCCTCGTTCCATGTTGCCAGCGGGTTATGC |
| | | CGGGGACTCATGGGAGACTGCCGGGGTCAACTCGGAGGAAGGTGGGGACGACGTCAAATC |
| | | ATCATGCCCCTTATGTCTTGGGGCTTCACGCATGCTACAATGGCCGGTACAAAGGGTTGC |
| | | GATACTGTGA (SEQ ID NO: 39) |
| 43 | Bacillus safensis | GGAGCTAATACCGGATAGTTCCTTGAACCGCATGGTTCAAGGATGAAAGACGGTTTCGGC |
| | | TGTCACTTACAGATGGACCCGCGGCGCATTAGCTAGTTGGTGGGGTAATGGCTCACCAAG |
| | | GCGACGATGCGTAGCCGACCTGAGAGGGTGATCGGCCACACTGGGACTGAGACACGGCCC |
| | | AGACTCCTACGGGAGGCAGCAGTAGGGAATCTTCCGCAATGGACGAAAGTCTGACGGAGC |
| | | AACGCCGCGTGAGTGATGAAGGTTTTCGGATCGTAAAGCTCTGTTGTTAGGGAAGAACAA |
| | | GTGCGAGAGTAACTGCTCGCACCTTGACGGTACCTAACCAGAAAGCCACGGCTAACTACG |
| | | TGCCAGCAGCCGCGGTAATACGTAGGTGGCAAGCGTTGTCCGGAATTATTGGGCGTAAAG |
| | | GGCTCGCAGGCGGTTTCTTAAGTCTGATGTGAAAGCCCCCGGCTCAACCGGGGAGGGTCA |
| | | TTGGAAACTGGGAAACTTGAGTGCAGAAGAGGAGAGTGGAATTCCACGTGTAGCGGTGAA |
| | | ATGCGTAGAGATGTGGAGGAACACCAGTGGCGAAGGCGACTCTCTGGTCTGTAACTGACG |
| | | CTGAGGAGCGAAAGCGTGGGGAGCGAACAGGATTAGATACCCTGGTAGTCCACGCCGTAA |
| | | ACGATGAGTGCTAAGTGTTAGGGGGTTTCCGCCCCTTAGTGCTGCAGCTAACGCATTAAG |
| | | CACTCCGCCTGGGGAGTACGGTCGCAAGACTGAAACTCAAAGGAATTGACGGGGGCCCGC |
| | | ACAAGCGGTGGAGCATGTGGTTTAATTCGAAGCAACGCGAAGAACCTTACCAGGTCTTGA |
| | | CATCCTCTGACAACCCTAGAGATAGGGCTTTCCCTTCGGGGACAGAGTGACAGGTGGTGC |
| | | ATGGTTGTCGTCAGCTCGTGTCGTGAGATGTTGGGTTAAGTCCCGCAACGAGCGCAACCC |
| | | TTGATCTTAGTTGCCAGCATTCAGTTGGGCACTCTAAGGTGACTGCCGGTGACAAACCGG |
| | | AGGAAGGTGGGGATGACGTCAAATCATCATGCCCCTTATGACCTGGGCTACACACGTGCT |
| | | ACAATGGACAGAACAAAGGGCTGCAAGACCGCAAGGTTTAGCCAATCCCATAAATCTGTT |
| | | CTCAGTTCGGATCGCA (SEQ ID NO: 40) |
| 44 | Pseudarthrobacter | TGGCTCAGGATGAACGCTGGCGGCGTGCTTAACACATGCAAGTCGAACGATGATCCGGTG |
| | siccitolerans | CTTGCGCCGGGGATTAGTGGCGAACGGGTGAGTAACACGTGAGTAACCTGCCCTTAACTC |
| | | TGGGATAAGCCTGGGAAACTGGGTCTAATACCGGATATGACTGATCATCGCATGGTGGTT |
| | | GGTGGAAAGCTTTTTGTGGTTTTGGATGGACTCGCGGCCTATCAGCTTGTTGGTGAGGTA |
| | | ATGGCTTACCAAGGCGACGACGGGTAGCCGGCCTGAGAGGGTGACCGGCCACACTGGGAC |
| | | TGAGACACGGCCCAGACTCCTACGGGAGGCAGCAGTGGGGAATATTGCACAATGGGCGCA |
| | | AGCCTGATGCAGCGACGCCGCGTGAGGGATGACGGCCTTCGGGTTGTAAACCTCTTTCAG |
| | | TAGGGAAGAAGCGAAAGTGACGGTACCTGCAGAAGAAGCGCCGGCTAACTACGTGCCAGC |
| | | AGCCGCGGTAATACGTAGGGCGCAAGCGTTATCCGGAATTATTGGGCGTAAAGAGCTCGT |
| | | AGGCGGTTTGTCGCGTCTGCCGTGAAAGTCCGGGGCTCAACTCCGGATCTGCGGTGGGTA |
| | | CGGGCAGACTAGAGTGATGTAGGGGAGACTGGAATTCCTGGTGTAGCGGTGAAATGCGCA |
| | | GATATCAGGAGGAACACCGATGGCGAAGGCAGGTCTCTGGGCATTAACTGACGCTGAGGA |
| | | GCGAAAGCATGGGGAGCGAACAGGATTAGATACCCTGGTAGTCCATGCCGTAAACGTTGG |
| | | GCACTAGGTGTGGGGGACATTCCACGTTTTCCGCGCCGTAGCTAACGCATTAAGTGCCCC |
| | | GCCTGGGGAGTACGGCCGCAAGGCTAAAACTCAAAGGAATTGACGGGGGCCCGCACAAGC |
| | | GGCGGAGCATGCGGATTAATTCGATGCAACGCGAAGAACCTTACCAAGGCTTGACATGAA |
| | | CCGGAAAGACCTGGAAACAGGTGCCCCGCTTGCGGTCGGTTTACAGGTGGTGCATGGTTG |
| | | TCGTCAGCTCGTGTCGTGAGATGTTGGGTTAAGTCCCGCAACGAGCGCAACCCTCGTTCT |
| | | ATGTTGCCAGCACGTGATGGTGGGGACTCATAGGAGACTGCCGGGGTCAACTCGGAGGAA |
| | | GGTGGGGACGACGTCAAATCATCATGCCCCTTATGTCTTGGGCTTCACGCATGCTACAAT |
| | | GGCCGGTACAAAGGGTTGCGATACTGTGAGGTGGAGCTAATCCCAAAAAGCCGGTCTCAG |
| | | TTCGGATTGGGGTCTGCAACTCGACCCCATGAAGT (SEQ ID NO: 41) |
| 45 | Neobacillus | CTTTTCCTCACATGAGGAAAAGCTGAAAGTCGGCCTCTCGCTGACACTTACAGATGGGCC |
| | drentensis | CGCGGCGCATTAGCTAGTTGGTGAGGTAACGGCTCACCAAGGCGACGATGCGTAGCCGAC |
| | | CTGAGAGGGTGATCGGCCACACTGGGACTGAGACACGGCCCAGACTCCTACGGGAGGCAG |
| | | CAGTAGGGAATCTTCCACAATGGACGAAAGTCTGATGGAGCAACGCCGCGTGAGCGATGA |
| | | AGGCCTTCGGGTCGTAAAGCTCTGTTGTTAGGGAAGAACAAGTACCGGAGTAACTGCCGG |
| | | TACCTTGACGGTACCTAACCAGAAAGCCACGGCTAACTACGTGCCAGCAGCCGCGGTAAT |
| | | ACGTAGGTGGCAAGCGTTGTCCGGAATTATTGGGCGTAAAGCGCGCGCAGGCGGTCCTTT |
| | | AAGTCTGATGTGAAAGCCCACGGCTCAACCGTGGAGGGTCATTGGAAACTGGGGGACTTG |
| | | AGTGCAGAAGAGGAAAGCGGAATTCCACGTGTAGCGGTGAAATGCGTAGAGATGTGGAGG |
| | | AACACCAGTGGCGAAGGCGGCTTTCTGGTCTGTAACTGACGCTGAGGCGCGAAAGCGTGG |
| | | GGAGCAAACAGGATTAGATACCCTGGTAGTCCACGCCGTAAACGATGAGTGCTAAGTGTT |
| | | AGGGGGTTTCCGCCCCTTAGTGCTGCAGCTAACGCATTAAGCACTCCGCCTGGGGAGTAC |
| | | GGCCGCAAGGCTGAAACTCAAAGGAATTGACGGGGGCCCGCACAAGCGGTGGAGCATGTG |
| | | GTTTAATTCGAAGCAACGCGAAGAACCTTACCAGGTCTTGACATCCTCTGACACTCCTAG |
| | | AGATAGGACGTTCCCCTTCGGGGGACAGAGTGACAGGTGGTGCATGGTTGTCGTCAGCTC |
| | | GTGTCGTGAGATGTTGGGTTAAGTCCCGCAACGAGCGCAACCCTTGATCTTAGTTGCCAG |
| | | CATTCAGTTGGGCACTCTAAGGTGACTGCCGGTGACAAACCGGAGGAAGGTGGGGATGAC |
| | | GTCAAATCATCATGCCCCTTATGACCTGGGCTACACACGTGCTACAATGGATGGTACAAA |
| | | GGGCTGCAAGACCGCGAGGTTTAGCCAATCCCATAAAACCATTCTCAGTTCGGATTGCAG |
| | | GCTGCAACTCGCCTGCATGAAGCCGGA (SEQ ID NO: 42) |
| 46 | Bacillus | GTCGAGCGAATGGATTAAGAGCTTGCTCTTATGAAGTTAGCGGCGGACGGGTGAGTAACA |
| | wiedmannii | CGTGGGTAACCTGCCCATAAGACTGGGATAACTCCGGGAAACCGGGGCTAATACCGGATA |
| | | ACATTTTGAACTGCATGGTTCGAAATTGAAAGGCGGCTTCGGCTGTCACTTATGGATGGA |
| | | CCCGCGTCGCATTAGCTAGTTGGTGAGGTAACGGCTCACCAAGGCAACGATGCGTAGCCG |
| | | ACCTGAGAGGGTGATCGGCCACACTGGGACTGAGACACGGCCCAGACTCCTACGGGAGGC |
| | | AGCAGTAGGGAATCTTCCGCAATGGACGAAAGTCTGACGGAGCAACGCCGCGTGAGTGAT |
| | | GAAGGCTTTCGGGTCGTAAAACTCTGTTGTTAGGGAAGAACAAGTGCTAGTTGAATAAGC |
| | | TGGCACCTTGACGGTACCTAACCAGAAAGCCACGGCTAACTACGTGCCAGCAGCCGCGGT |
| | | AATACGTAGGTGGCAAGCGTTATCCGGAATTATTGGGCGTAAAGCGCGCGCAGGTGGTTT |
| | | CTTAAGTCTGATGTGAAAGCCCACGGCTCAACCGTGGAGGGTCATTGGAAACTGGGAGAC |
| | | TTGAGTGCAGAAGAGGAAAGTGGAATTCCATGTGTAGCGGTGAAATGCGTAGAGATATGG |
| | | AGGAACACCAGTGGCGAAGGCGACTTTCTGGTCTGTAACTGACACTGAGGCGCGAAAGCG |
| | | TGGGGAGCAAACAGGATTAGATACCCTGGTAGTCCACGCCGTAAACGATGAGTGCTAAGT |
| | | GTTAGAGGGTTTCCGCCCTTTAGTGCTGAAGTTAACGCATTAAGCACTCCGCCTGGGGAG |
| | | TACGGCCGCAAGGCTGAAACTCAAAGGAATTGACGGGGGCCCGCACAAGCGGTGGAGCAT |
| | | GTGGTTTAATTCGAAGCAACGCGAAGAACCTTACCAGGTCTTGACATCCTCTGAAAACCC |
| | | TAGAGATAGGGCTTCTCCTTCGGGAGCAGAGTGACAGGTGGTGCATGGTTGTCGTCAGCT |
| | | CGTGTCGTGAGATGTTGGGTTAAGTCCCGCAACGAGCGCAACCCTTGATCTTAGTTGCCA |
| | | TCATTAAGTTGGGCACTCTAAGGTGACTGCCGGTGACAAACCGGAGGAAGGTGGGGATGA |
| | | CGTCAAATCATCATGCCCCTTATGACCTGGGCTACACACGTGCTACAATGGACGGTACAA |
| | | AGAGCTGCAAGACCGCGAGGTGGAGCTAATCTCATAAAACCGTTCTCAGTTCGGATTGTA |
| | | GGCTGCAACTCGCCTACATGAAGCTGGAATCGCTAGTATC (SEQ ID NO: 43) |
| 47 | Priestia | AATACATGCAAGTCGAGCGAACTGATTAGAAGCTTGCTTCTATGACGTTAGCGGCGGACG |
| | aryabhattai | GGTGAGTAACACGTGGGCAACCTGCCTGTAAGACTGGGATAACTTCGGGAAACCGAAGCT |
| | | AATACCGGATAGGATCTTCTCCTTCATGGGAGATGATTGAAAGATGGTTTCGGCTATCAC |
| | | TTACAGATGGGCCCGCGGTGCATTAGCTAGTTGGTGAGGTAACGGCTCACCAAGGCAACG |
| | | ATGCATAGCCGACCTGAGAGGGTGATCGGCCACACTGGGACTGAGACACGGCCCAGACTC |
| | | CTACGGGAGGCAGCAGTAGGGAATCTTCCGCAATGGACGAAAGTCTGACGGAGCAACGCC |
| | | GCGTGAGTGATGAAGGCTTTCGGGTCGTAAAACTCTGTTGTTAGGGAAGAACAAGTACGA |
| | | GAGTAACTGCTCGTACCTTGACGGTACCTAACCAGAAAGCCACGGCTAACTACGTGCCAG |
| | | CAGCCGCGGTAATACGTAGGTGGCAAGCGTTATCCGGAATTATTGGGCGTAAAGCGCGCG |
| | | CAGGCGGTTTCTTAAGTCTGATGTGAAAGCCCACGGCTCAACCGTGGAGGGTCATTGGAA |
| | | ACTGGGGAACTTGAGTGCAGAAGAGAAAAGCGGAATTCCACGTGTAGCGGTGAAATGCGT |
| | | AGAGATGTGGAGGAACACCAGTGGCGAAGGCGGCTTTTTGGTCTGTAACTGACGCTGAGG |
| | | CGCGAAAGCGTGGGGAGCAAACAGGATTAGATACCCTGGTAGTCCACGCCGTAAACGATG |
| | | AGTGCTAAGTGTTAGAGGGTTTCCGCCCTTTAGTGCTGCAGCTAACGCATTAAGCACTCC |
| | | GCCTGGGGAGTACGGTCGCAAGACTGAAACTCAAAGGAATTGACGGGGGCCCGCACAAGC |
| | | GGTGGAGCATGTGGTTTAATTCGAAGCAACGCGAAGAACCTTACCAGGTCTTGACATCCT |
| | | CTGACAACTCTAGAGATAGAGCGTTCCCCTTCGGGGGACAGAGTGACAGGTGGTGCATGG |
| | | TTGTCGTCAGCTCGTGTCGTGAGATGTTGGGTTAAGTCCCGCAACGAGCGCAACCCTTGA |
| | | TCTTAGTTGCCAGCATTTAGTTGGGCACTCTAAGGTGACTGCCGGTGACAAACCGGAGGA |
| | | AGGTGGGGATGACGTCAAATCATCATGCCCCTTATGACCTGGGCTACACACGTGCTACAA |
| | | TGGATGGTACAAAGGGCTGCAAGACCGCGAGGTCAAGCCAATCCCATAAAACCATTCTCA |
| | | GTTCGGATTGTAGGCTGCAACTCGCCTACATGAAGCTGGAGTCGCTAGTA |
| | | (SEQ ID NO: 44) |
| 48 | Bacillus safensis | TCAGGACGAACGCTGGCGGCGTGCTAATACATGCAAGTCGAGCGGACAGAAGGGAGCTTG |
| | | CTCCCGGATGTTAGCGGCGGACGGGTGAGTAACACGTGGGTAACCTGCCTGTAAGACTGG |
| | | GATAACTCCGGGAAACCGGAGCTAATACCGGATAGTTCCTTGAACCGCATGGTTCAAGGA |
| | | TGAAAGACGGTTTCGGCTGTCACTTACAGATGGACCCGCGGCGCATTAGCTAGTTGGTGG |
| | | GGTAATGGCTCACCAAGGCGACGATGCGTAGCCGACCTGAGAGGGTGATCGGCCACACTG |
| | | GGACTGAGACACGGCCCAGACTCCTACGGGAGGCAGCAGTAGGGAATCTTCCGCAATGGA |
| | | CGAAAGTCTGACGGAGCAACGCCGCGTGAGTGATGAAGGTTTTCGGATCGTAAAGCTCTG |
| | | TTGTTAGGGAAGAACAAGTGCGAGAGTAACTGCTCGCACCTTGACGGTACCTAACCAGAA |
| | | AGCCACGGCTAACTACGTGCCAGCAGCCGCGGTAATACGTAGGTGGCAAGCGTTGTCCGG |
| | | AATTATTGGGCGTAAAGGGCTCGCAGGCGGTTTCTTAAGTCTGATGTGAAAGCCCCCGGC |
| | | TCAACCGGGGAGGGTCATTGGAAACTGGGAAACTTGAGTGCAGAAGAGGAGAGTGGAATT |
| | | CCACGTGTAGCGGTGAAATGCGTAGAGATGTGGAGGAACACCAGTGGCGAAGGCGACTCT |
| | | CTGGTCTGTAACTGACGCTGAGGAGCGAAAGCGTGGGGAGCGAACAGGATTAGATACCCT |
| | | GGTAGTCCACGCCGTAAACGATGAGTGCTAAGTGTTAGGGGGTTTCCGCCCCTTAGTGCT |
| | | GCAGCTAACGCATTAAGCACTCCGCCTGGGGAGTACGGTCGCAAGACTGAAACTCAAAGG |
| | | AATTGACGGGGGCCCGCACAAGCGGTGGAGCATGTGGTTTAATTCGAAGCAACGCGAAGA |
| | | ACCTTACCAGGTCTTGACATCCTCTGACAACCCTAGAGATAGGGCTTTCCCTTCGGGGAC |
| | | AGAGTGACAGGTGGTGCATGGTTGTCGTCAGCTCGTGTCGTGAGATGTTGGGTTAAGTCC |
| | | CGCAACGAGCGCAACCCTTGATCTTAGTTGCCAGCATTCAGTTGGGCACTCTAAGGTGAC |
| | | TGCCGGTGACAAACCGGAGGAAGGTGGGGATGACGTCAAATCATCATGCCCCTTATGACC |
| | | TGGGCTACACACGTGCTACAATGGACAGAACAAAGGGCTGCAAGACCGCAAGGTTTAGCC |
| | | AATCCCATAAATCTGTTCTCAGTTCGGATCGCAGTCTGCAACTCGACTGCGTGAAGCTGG |
| | | AGTCGCTAGTATCGGCAGATC (SEQ ID NO: 45) |
| 50 | Bacillus sp. | TTATGAAGTTAGCGGCGGACGGGTGAGTAACACGTGGGTAACCTGCCCATAAGACTGGGA |
| | | TAACTCCGGGAAACCGGGGCTAATACCGGATAACATTTTGAACCGCATGGTTCGAAATTG |
| | | AAAGGCGGCTTCGGCTGTCACTTATGGATGGACCCGCGTCGCATTAGCTAGTTGGTGAGG |
| | | TAACGGCTCACCAAGGCAACGATGCGTAGCCGACCTGAGAGGGTGATCGGCCACACTGGG |
| | | ACTGAGACACGGCCCAGACTCCTACGGGAGGCAGCAGTAGGGAATCTTCCGCAATGGACG |
| | | AAAGTCTGACGGAGCAACGCCGCGTGAGTGATGAAGGCTTTCGGGTCGTAAAACTCTGTT |
| | | GTTAGGGAAGAACAAGTGCTAGTTGAATAAGCTGGCACCTTGACGGTACCTAACCAGAAA |
| | | GCCACGGCTAACTACGTGCCAGCAGCCGCGGTAATACGTAGGTGGCAAGCGTTATCCGGA |
| | | ATTATTGGGCGTAAAGCGCGCGCAGGTGGTTTCTTAAGTCTGATGTGAAAGCCCACGGCT |
| | | CAACCGTGGAGGGTCATTGGAAACTGGGAGACTTGAGTGCAGAAGAGGAAAGTGGAATTC |
| | | CATGTGTAGCGGTGAAATGCGTAGAGATATGGAGGAACACCAGTGGCGAAGGCGACTTTC |
| | | TGGTCTGTAACTGACACTGAGGCGCGAAAGCGTGGGGAGCAAACAGGATTAGATACCCTG |
| | | GTAGTCCACGCCGTAAACGATGAGTGCTAAGTGTTAGAGGGTTTCCGCCCTTTAGTGCTG |
| | | AAGTTAACGCATTAAGCACTCCGCCTGGGGAGTACGGCCGCAAGGCTGAAACTCAAAGGA |
| | | ATTGACGGGGGCCCGCACAAGCGGTGGAGCATGTGGTTTAATTCGAAGCAACGCGAAGAA |
| | | CCTTACCAGGTCTTGACATCCTCTGAAAACCCTAGAGATAGGGCTTCTCCTTCGGGAGCA |
| | | GAGTGACAGGTGGTGCATGGTTGTCGTCAGCTCGTGTCGTGAGATGTTGGGTTAAGTCCC |
| | | GCAACGAGCGCAACCCTTGATCTTAGTTGCCATCATTAAGTTGGGCACTCTAAGGTGACT |
| | | GCCGGTGACAAACCGGAGGAAGGTGGGGATGACGTCAAATCATCATGCCCCTTATGACCT |
| | | GGGCTACACACGTGCTACAATGGACGGTACAAAGAGCTGCAAGACCGCGAGGTGGAGCTA |
| | | ATCTCATAAAACCGTTCTCAGTTCGGATTGTAGGCTGCAACTCGCCTACATGAAGCTGGA |
| | | GTCGCTAGTAT (SEQ ID NO: 46) |
| 51 | Neobacillus niacini | ACACGTGGGCAACCTGCCTGTAAGACTGGGATAACTTCGGGAAACCGGAGCTAATACCGG |
| | | ATAATCCTTTTCCTCTCATGAGGAAAAGCTGAAAGTCGGTTTCGGCTGACACTTACAGAT |
| | | GGGCCCGCGGCGCATTAGCTAGTTGGTGAGGTAACGGCTCACCAAGGCGACGATGCGTAG |
| | | CCGACCTGAGAGGGTGATCGGCCACACTGGGACTGAGACACGGCCCAGACTCCTACGGGA |
| | | GGCAGCAGTAGGGAATCTTCCGCAATGGACGAAAGTCTGACGGAGCAACGCCGCGTGAGC |
| | | GATGAAGGCCTTCGGGTCGTAAAGCTCTGTTGTTAGGGAAGAACAAGTATCGGAGTAACT |
| | | GCCGGTACCTTGACGGTACCTAACCAGAAAGCCACGGCTAACTACGTGCCAGCAGCCGCG |
| | | GTAATACGTAGGTGGCAAGCGTTGTCCGGAATTATTGGGCGTAAAGCGCGCGCAGGCGGT |
| | | CCTTTAAGTCTGATGTGAAAGCCCACGGCTCAACCGTGGAGGGTCATTGGAAACTGGGGG |
| | | ACTTGAGTGCAGAAGAGGAAAGCGGAATTCCACGTGTAGCGGTGAAATGCGTAGAGATGT |
| | | GGAGGAACACCAGTGGCGAAGGCGGCTTTCTGGTCTGTAACTGACGCTGAGGCGCGAAAG |
| | | CGTGGGGAGCAAACAGGATTAGATACCCTGGTAGTCCACGCCGTAAACGATGAGTGCTAA |
| | | GTGTTAGAGGGTTTCCGCCCTTTAGTGCTGCAGCTAACGCATTAAGCACTCCGCCTGGGG |
| | | AGTACGGCCGCAAGGCTGAAACTCAAAGGAATTGACGGGGGCCCGCACAAGCGGTGGAGC |
| | | ATGTGGTTTAATTCGAAGCAACGCGAAGAACCTTACCAGGTCTTGACATCCTCTGACACT |
| | | CCTAGAGATAGGACTTTCCCCTTCGGGGGACAGAGTGACAGGTGGTGCATGGTTGTCGTC |
| | | AGCTCGTGTCGTGAGATGTTGGGTTAAGTCCCGCAACGAGCGCAACCCTTGATCTTAGTT |
| | | GCCAGCATTCAGTTGGGCACTCTAAGGTGACTGCCGGTGACAAACCGGAGGAAGGTGGGG |
| | | ATGACGTCAAATCATCATGCCCCTTATGACCTGGGCTACACACGTGCTACAATGGATGGT |
| | | ACAAAGGGCTGCGAAACCGCGAGGTTTAGCCAATCCCATAAAACCATTCTCAGTTCGGAT |
| | | TGTAGGCTGCAACTCGCCTACATGAAGCCGGA (SEQ ID NO: 47) |
| 55 | Streptomyces | ACGGAGAGTTTGATCCTGGCTCAGGACGAACGCTGGCGGCGTGCTTAACACATGCAAGTC |
| | eurythermus | GAACGATGAACCTCCTTCGGGAGGGGATTAGTGGCGAACGGGTGAGTAACACGTGGGCAA |
| | | TCTGCCCTGCACTCTGGGACAAGCCCTGGAAACGGGGTCTAATACCGGATACGACACGCT |
| | | CAGGCATCTGATGCGTGTGGAAAGCTCCGGCGGTGCAGGATGAGCCCGCGGCCTATCAGC |
| | | TTGTTGGTGAGGTAACGGCTCACCAAGGCGACGACGGGTAGCCGGCCTGAGAGGGCGACC |
| | | GGCCACACTGGGACTGAGACACGGCCCAGACTCCTACGGGAGGCAGCAGTGGGGAATATT |
| | | GCACAATGGGCGCAAGCCTGATGCAGCGACGCCGCGTGAGGGATGACGGCCTTCGGGTTG |
| | | TAAACCTCTTTCAGCAGGGAAGAAGCGAAAGTGACGGTACCTGCAGAAGAAGCGCCGGCT |
| | | AACTACGTGCCAGCAGCCGCGGTAATACGTAGGGCGCAAGCGTTGTCCGGAATTATTGGG |
| | | CGTAAAGAGCTCGTAGGCGGCTTGTCGCGTCGGTTGTGAAAGCCCGGGGCTTAACCCCGG |
| | | GTCTGCAGTCGATACGGGCAGGCTAGAGTTCGGTAGGGGAGATCGGAATTCCTGGTGTAG |
| | | CGGTGAAATGCGCAGATATCAGGAGGAACACCGGTGGCGAAGGCGGATCTCTGGGCCGAT |
| | | ACTGACGCTGAGGAGCGAAAGCGTGGGGAGCGAACAGGATTAGATACCCTGGTAGTCCAC |
| | | GCCGTAAACGGTGGGCACTAGGTGTGGGCAACATTCCACGTTGTCCGTGCCGCAGCTAAC |
| | | GCATTAAGTGCCCCGCCTGGGGAGTACGGCCGCAAGGCTAAAACTCAAAGGAATTGACGG |
| | | GGGCCCGCACAAGCGGCGGAGCATGTGGCTTAATTCGACGCAACGCGAAGAACCTTACCA |
| | | AGGCTTGACATACACCGGAAACATCCAGAGATGGGTGCCCCCTTGTGGTCGGTGTACAGG |
| | | TGGTGCATGGCTGTCGTCAGCTCGTGTCGTGAGATGTTGGGTTAAGTCCCGCAACGAGCG |
| | | CAACCCTTGTCCCGTGTTGCCAGCAGGCCCTTGTGGTGCTGGGGACTCACGGGAGACCGC |
| | | CGGGGTCAACTCGGAGGAAGGTGGGGACGACGTCAAGTCATCATGCCCCTTATGTCTTGG |
| | | GCTGCACACGTGCTACAATGGCCGGTACAATGAGCTGCGATACCGTGAGGTGGAGCGAAT |
| | | CTCAAAAAGCCGGTCTCAGTTCGGATTGGGGTCTGCAACTCGACCCCATGAAGTCGGAGT |
| | | CGCTAGTAATCGCAGATCAGCATTGCTGCGGTGAATACGTTCCCGGGCCTTGTACACACC |
| | | GCCCGTCACGTCACGAAAGTCGGTAACACCCGAAGCCGGTGGCCCAACCCCTTGTGGGAG |
| | | GGAGCTGTCGAAGGTGGGACTGGCGATTGGGACGAAGTCGTAACAAGGTAGCCGTACCGG |
| | | AAGGTGCGGCTGGATCACCTCCTTT (SEQ ID NO: 48) |
| 56 | Bacillus sp. | TTATGGATGGACCCGCGTCGCATTAGCTAGTTGGTGAGGTAACGGCTCACCAAGGCAACG |
| | | ATGCGTAGCCGACCTGAGAGGGTGATCGGCCACACTGGGACTGAGACACGGCCCAGACTC |
| | | CTACGGGAGGCAGCAGTAGGGAATCTTCCGCAATGGACGAAAGTCTGACGGAGCAACGCC |
| | | GCGTGAGTGATGAAGGCTTTCGGGTCGTAAAACTCTGTTGTTAGGGAAGAACAAGTGCTA |
| | | GTTGAATAAGCTGGCACCTTGACGGTACCTAACCAGAAAGCCACGGCTAACTACGTGCCA |
| | | GCAGCCGCGGTAATACGTAGGTGGCAAGCGTTATCCGGAATTATTGGGCGTAAAGCGCGC |
| | | GCAGGTGGTTTCTTAAGTCTGATGTGAAAGCCCACGGCTCAACCGTGGAGGGTCATTGGA |
| | | AACTGGGAGACTTGAGTGCAGAAGAGGAAAGTGGAATTCCATGTGTAGCGGTGAAATGCG |
| | | TAGAGATATGGAGGAACACCAGTGGCGAAGGCGACTTTCTGGTCTGTAACTGACACTGAG |
| | | GCGCGAAAGCGTGGGGAGCAAACAGGATTAGATACCCTGGTAGTCCACGCCGTAAACGAT |
| | | GAGTGCTAAGTGTTAGAGGGTTTCCGCCCTTTAGTGCTGAAGTTAACGCATTAAGCACTC |
| | | CGCCTGGGGAGTACGGCCGCAAGGCTGAAACTCAAAGGAATTGACGGGGGCCCGCACAAG |
| | | CGGTGGAGCATGTGGTTTAATTCGAAGCAACGCGAAGAACCTTACCAGGTCTTGACATCC |
| | | TCTGAAAACCCTAGAGATAGGGCTTCTCCTTCGGGAGCAGAGTGACAGGTGGTGCATGGT |
| | | TGTCGTCAGCTCGTGTCGTGAGATGTTGGGTTAAGTCCCGCAACGAGCGCAACCCTTGAT |
| | | CTTAGTTGCCATCATTAAGTTGGGCACTCTAAGGTGACTGCCGGTGACAAACCGGAGGAA |
| | | GGTGGGGATGACGTCAAATCATCATGCCCCTTATGACCTGGGCTACACACGTGCTACAAT |
| | | GGACGGTACAAAGAGCTGCAAGACCGCGAGGTGGAGCTAATCTCATAAAACCGTTCTCA |
| | | (SEQ ID NO: 49) |
| 57 | Bacillus | AATACATGCAAGTCGAGCGAATGGATTAAGAGCTTGCTCTTATGAAGTTAGCGGCGGACG |
| | proteolyticus | GGTGAGTAACACGTGGGTAACCTGCCCATAAGACTGGGATAACTCCGGGAAACCGGGGCT |
| | | AATACCGGATAACATTTTGAACTGCATGGTTCGAAATTGAAAGGCGGCTTCGGCTGTCAC |
| | | TTATGGATGGACCCGCGTCGCATTAGCTAGTTGGTGAGGTAACGGCTCACCAAGGCAACG |
| | | ATGCGTAGCCGACCTGAGAGGGTGATCGGCCACACTGGGACTGAGACACGGCCCAGACTC |
| | | CTACGGGAGGCAGCAGTAGGGAATCTTCCGCAATGGACGAAAGTCTGACGGAGCAACGCC |
| | | GCGTGAGTGATGAAGGCTTTCGGGTCGTAAAACTCTGTTGTTAGGGAAGAACAAGTGCTA |
| | | GTTGAATAAGCTGGCACCTTGACGGTACCTAACCAGAAAGCCACGGCTAACTACGTGCCA |
| | | GCAGCCGCGGTAATACGTAGGTGGCAAGCGTTATCCGGAATTATTGGGCGTAAAGCGCGC |
| | | GCAGGTGGTTTCTTAAGTCTGATGTGAAAGCCCACGGCTCAACCGTGGAGGGTCATTGGA |
| | | AACTGGGAGACTTGAGTGCAGAAGAGGAAAGTGGAATTCCATGTGTAGCGGTGAAATGCG |
| | | TAGAGATATGGAGGAACACCAGTGGCGAAGGCGACTTTCTGGTCTGTAACTGACACTGAG |
| | | GCGCGAAAGCGTGGGGAGCAAACAGGATTAGATACCCTGGTAGTCCACGCCGTAAACGAT |
| | | GAGTGCTAAGTGTTAGAGGGTTTCCGCCCTTTAGTGCTGAAGTTAACGCATTAAGCACTC |
| | | CGCCTGGGGAGTACGGCCGCAAGGCTGAAACTCAAAGGAATTGACGGGGGCCCGCACAAG |
| | | CGGTGGAGCATGTGGTTTAATTCGAAGCAACGCGAAGAACCTTACCAGGTCTTGACATCC |
| | | TCTGAAAACCCTAGAGATAGGGCTTCTCCTTCGGGAGCAGAGTGACAGGTGGTGCATGGT |
| | | TGTCGTCAGCTCGTGTCGTGAGATGTTGGGTTAAGTCCCGCAACGAGCGCAACCCTTGAT |
| | | CTTAGTTGCCATCATTAAGTTGGGCACTCTAAGGTGACTGCCGGTGACAAACCGGAGGAA |
| | | GGTGGGGATGACGTCAAATCATCATGCCCCTTATGACCTGGGCTACACACGTGCTACAAT |
| | | GGACGGTACAAAGAGCTGCAAGACCGCGAGGTGGAGCTAATCTCATAAAACCGTTCTCAG |
| | | TTCGGATTGTAGGCTGCAACTCGCCTACATGAAGCTGGA( SEQ ID NO: 50) |
| 64 | Arthrobacter | TCAGCTTGTTGGTGGGGTAATGGCCTACCAAGGCGACGACGGGTAGCCGGCCTGAGAGGG |
| | pokkalii | TGACCGGCCACACTGGGACTGAGACACGGCCCAGACTCCTACGGGAGGCAGCAGTGGGGA |
| | | ATATTGCACAATGGGCGCAAGCCTGATGCAGCGACGCCGCGTGAGGGATGACGGCCTTCG |
| | | GGTTGTAAACCTCTTTCAGTAGGGAAGAAGCGAAAGTGACGGTACCTGCAGAAGAAGCGC |
| | | CGGCTAACTACGTGCCAGCAGCCGCGGTAATACGTAGGGCGCAAGCGTTATCCGGAATTA |
| | | TTGGGCGTAAAGAGCTCGTAGGCGGTTTGTCGCGTCTGCCGTGAAAGTCCGGGGCTCAAC |
| | | TCCGGATCTGCGGTGGGTACGGGCAGACTAGAGTGATGTAGGGGAGACTGGAATTCCTGG |
| | | TGTAGCGGTGAAATGCGCAGATATCAGGAGGAACACCGATGGCGAAGGCAGGTCTCTGGG |
| | | CATTAACTGACGCTGAGGAGCGAAAGCATGGGGAGCGAACAGGATTAGATACCCTGGTAG |
| | | TCCATGCCGTAAACGTTGGGCACTAGGTGTGGGGGACATTCCACGTTTTCCGCGCCGTAG |
| | | CTAACGCATTAAGTGCCCCGCCTGGGGAGTACGGCCGCAAGGCTAAAACTCAAAGGAATT |
| | | GACGGGGGCCCGCACAAGCGGCGGAGCATGCGGATTAATTCGATGCAACGCGAAGAACCT |
| | | TACCAAGGCTTGACATGAACCAGACCGCCGCAGAAATGTGGTTTCCCCTTTGGGGTTGGT |
| | | TTACAGGTGGTGCATGGTTGTCGTCAGCTCGTGTCGTGAGATGTTGGGTTAAGTCCCGCA |
| | | ACGAGCGCAACCCTCGTTCTATGTTGCCAGCACGTGATGGTGGGGACTCATAGGAGACTG |
| | | CCGGGGTCAACTCGGAGGAAGGTGGGGACGACGTCAAATCATCATGCCCCTTATGTCTTG |
| | | GGCTTCACGCATGCTACAATGGCCGGTACAAAGGGTTGCGATACTGTGAGGTGGAGCTAA |
| | | TCCCAAAAAGCCGGTCTCAGTTCGGATTG (SEQ ID NO: 51) |
| 78 | Bacillus tequilensis | GATGTTAGCGGCGGACGGGTGAGTAACACGTGGGTAACCTGCCTGTAAGACTGGGATAAC |
| | | TCCGGGAAACCGGGGCTAATACCGGATGGTTGTTTGAACCGCATGGTTCAAACATAAAAG |
| | | GTGGCTTCGGCTACCACTTACAGATGGACCCGCGGCGCATTAGCTAGTTGGTGAGGTAAT |
| | | GGCTCACCAAGGCAACGATGCGTAGCCGACCTGAGAGGGTGATCGGCCACACTGGGACTG |
| | | AGACACGGCCCAGACTCCTACGGGAGGCAGCAGTAGGGAATCTTCCGCAATGGACGAAAG |
| | | TCTGACGGAGCAACGCCGCGTGAGTGATGAAGGTTTTCGGATCGTAAAGCTCTGTTGTTA |
| | | GGGAAGAACAAGTACCGTTCGAATAGGGCGGTACCTTGACGGTACCTAACCAGAAAGCCA |
| | | CGGCTAACTACGTGCCAGCAGCCGCGGTAATACGTAGGTGGCAAGCGTTGTCCGGAATTA |
| | | TTGGGCGTAAAGGGCTCGCAGGCGGTTTCTTAAGTCTGATGTGAAAGCCCCCGGCTCAAC |
| | | CGGGGAGGGTCATTGGAAACTGGGGAACTTGAGTGCAGAAGAGGAGAGTGGAATTCCACG |
| | | TGTAGCGGTGAAATGCGTAGAGATGTGGAGGAACACCAGTGGCGAAGGCGACTCTCTGGT |
| | | CTGTAACTGACGCTGAGGAGCGAAAGCGTGGGGAGCGAACAGGATTAGATACCCTGGTAG |
| | | TCCACGCCGTAAACGATGAGTGCTAAGTGTTAGGGGGTTTCCGCCCCTTAGTGCTGCAGC |
| | | TAACGCATTAAGCACTCCGCCTGGGGAGTACGGTCGCAAGACTGAAACTCAAAGGAATTG |
| | | ACGGGGGCCCGCACAAGCGGTGGAGCATGTGGTTTAATTCGAAGCAACGCGAAGAACCTT |
| | | ACCAGGTCTTGACATCCTCTGACAATCCTAGAGATAGGACGTCCCCTTCGGGGGCAGAGT |
| | | GACAGGTGGTGCATGGTTGTCGTCAGCTCGTGTCGTGAGATGTTGGGTTAAGTCCCGCAA |
| | | CGAGCGCAACCCTTGATCTTAGTTGCCAGCATTCAGTTGGGCACTCTAAGGTGACTGCCG |
| | | GTGACAAACCGGAGGAAGGTGGGGATGACGTCAAATCATCATGCCCCTTATGACCTGGGC |
| | | TACACACGTGCTACAATGGACAGAACAAAGGGCAGCGAAACCGCGAGGTTAAGCCAATCC |
| | | CACAAATCTGTTCTCAGTTCGGATCGCAGTCTGCAACTCGACTGCGTGAAGCTGGA |
| | | (SEQ ID NO: 52) |
| 82 | Bacillus pumilus | TAATACATGCAAGTCGAGCGAACAGAAGGGAGCTTGCTCCCGGATGTTAGCGGCGGACGG |
| | | GTGAGTAACACGTGGGTAACCTGCCTGTAAGACTGGGATAACTCCGGGAAACCGGAGCTA |
| | | ATACCGGATAGTTCCTTGAACCGCATGGTTCAAGGATGAAAGACGGTTTCGGCTGTCACT |
| | | TACAGATGGACCCGCGGCGCATTAGCTAGTTGGTGGGGTAATGGCTCACCAAGGCGACGA |
| | | TGCGTAGCCGACCTGAGAGGGTGATCGGCCACACTGGGACTGAGACACGGCCCAGACTCC |
| | | TACGGGAGGCAGCAGTAGGGAATCTTCCGCAATGGACGAAAGTCTGACGGAGCAACGCCG |
| | | CGTGAGTGATGAAGGTTTTCGGATCGTAAAGCTCTGTTGTTAGGGAAGAACAAGTGCGAG |
| | | AGTAACTGCTCGCACCTTGACGGTACCTAACCAGAAAGCCACGGCTAACTACGTGCCAGC |
| | | AGCCGCGGTAATACGTAGGTGGCAAGCGTTGTCCGGAATTATTGGGCGTAAAGGGCTCGC |
| | | AGGCGGTTTCTTAAGTCTGATGTGAAAGCCCCCGGCTCAACCGGGGAGGGTCATTGGAAA |
| | | CTGGGAAACTTGAGTGCAGAAGAGGAGAGTGGAATTCCACGTGTAGCGGTGAAATGCGTA |
| | | GAGATGTGGAGGAACACCAGTGGCGAAGGCGACTCTCTGGTCTGTAACTGACGCTGAGGA |
| | | GCGAAAGCGTGGGGAGCGAACAGGATTAGATACCCTGGTAGTCCACGCCGTAAACGATGA |
| | | GTGCTAAGTGTTAGGGGGTTTCCGCCCCTTAGTGCTGCAGCTAACGCATTAAGCACTCCG |
| | | CCTGGGGAGTACGGTCGCAAGACTGAAACTCAAAGGAATTGACGGGGGCCCGCACAAGCG |
| | | GTGGAGCATGTGGTTTAATTCGAAGCAACGCGAAGAACCTTACCAGGTCTTGACATCCTC |
| | | TGACAACCCTAGAGATAGGGCTTTCCCTTCGGGGACAGAGTGACAGGTGGTGCATGGTTG |
| | | TCGTCAGCTCGTGTCGTGAGATGTTGGGTTAAGTCCCGCAACGAGCGCAACCCTTGATCT |
| | | TAGTTGCCAGCATTTAGTTGGGCACTCTAAGGTGACTGCCGGTGACAAACCGGAGGAAGG |
| | | TGGGGATGACGTCAAATCATCATGCCCCTTATGACCTGGGCTACACACGTGCTACAATGG |
| | | ACAGAACAAAGGGCTGCGAGACCGCAAGGTTTAGCCAATCCCATAAATCTGTTCTCAGTT |
| | | CGGATCGCAGTCTGCAACTCGACTGCGTGAAGCTGGAGTCGCTAG (SEQ ID NO: 53) |
| 85 | Brevibacillus | TTCGGACCCTAGCGGCGGACGGGTGAGTAACACGTAGGCAACCTGCCTGTAAGACTGGGA |
| | laterosporus | TAACATAGGGAAACTTATGCTAATACCGGATAGGGTTTTGCTTCGCCTGAAGCGAAACGG |
| | | AAAGATGGCGCAAGCTATCACTTACAGATGGGCCTGCGGCGCATTAGCTAGTTGGTGAGG |
| | | TAATGGCTCACCAAGGCGACGATGCGTAGCCGACCTGAGAGGGTGACCGGCCACACTGGG |
| | | ACTGAGACACGGCCCAGACTCCTACGGGAGGCAGCAGTAGGGAATTTTCCACAATGGACG |
| | | AAAGTCTGATGGAGCAACGCCGCGTGAACGATGAAGGCTTTCGGGTCGTAAAGTTCTGTT |
| | | GTTAGGGAAGAAACAGTGCTATTTAAATAAGGTAGCACCTTGACGGTACCTAACGAGAAA |
| | | GCCACGGCTAACTACGTGCCAGCAGCCGCGGTAATACGTAGGTGGCAAGCGTTGTCCGGA |
| | | ATTATTGGGCGTAAAGCGCGCGCAGGTGGCTATGTAAGTCTGATGTTAAAGCCCGAGGCT |
| | | CAACCTCGGTTCGCATTGGAAACTGTGTAGCTTGAGTGCAGGAGAGGAAAGTGGTATTCC |
| | | ACGTGTAGCGGTGAAATGCGTAGAGATGTGGAGGAACACCAGTGGCGAAGGCGACTTTCT |
| | | GGCCTGTAACTGACACTGAGGCGCGAAAGCGTGGGGAGCAAACAGGATTAGATACCCTGG |
| | | TAGTCCACGCCGTAAACGATGAGTGCTAGGTGTTAGGGGTTTCAATACCCTTAGTGCCGC |
| | | AGCTAACGCAATAAGCACTCCGCCTGGGGAGTACGCTCGCAAGAGTGAAACTCAAAGGAA |
| | | TTGACGGGGGCCCGCACAAGCGGTGGAGCATGTGGTTTAATTCGAAGCAACGCGAAGAAC |
| | | CTTACCAGGTCTTGACATCCCACTGACCGCTCTAGAGATAGAGCTTCCCTTCGGGGCAGT |
| | | GGTGACAGGTGGTGCATGGTTGTCGTCAGCTCGTGTCGTGAGATGTTGGGTTAAGTCCCG |
| | | CAACGAGCGCAACCCTTATCTTTAGTTGCCAGCATTCAGTTGGGCACTCTAGAGAGACTG |
| | | CCGTCGACAAGACGGAGGAAGGCGGGGATGACGTCAAATCATCATGCCCCTTATGACCTG |
| | | GGCTACACACGTGCTACAATGGTTGGTACAACGGGATGCTACTTCGCGAGAAGATGCTAA |
| | | TCTCTTAAAACCAATCTCAGTTCGGATTGTAGGCTGCAACTCGCCTACATGAAGTCGGA |
| | | (SEQ ID NO: 54) |
| 86 | Bacillus pumilus | AATACATGCAAGTCGAGCGAACAGAAGGGAGCTTGCTCCCGGATGTTAGCGGCGGACGGG |
| | | TGAGTAACACGTGGGTAACCTGCCTGTAAGACTGGGATAACTCCGGGAAACCGGAGCTAA |
| | | TACCGGATAGTTCCTTGAACCGCATGGTTCAAGGATGAAAGACGGTTTCGGCTGTCACTT |
| | | ACAGATGGACCCGCGGCGCATTAGCTAGTTGGTGGGGTAATGGCTCACCAAGGCGACGAT |
| | | GCGTAGCCGACCTGAGAGGGTGATCGGCCACACTGGGACTGAGACACGGCCCAGACTCCT |
| | | ACGGGAGGCAGCAGTAGGGAATCTTCCGCAATGGACGAAAGTCTGACGGAGCAACGCCGC |
| | | GTGAGTGATGAAGGTTTTCGGATCGTAAAGCTCTGTTGTTAGGGAAGAACAAGTGCGAGA |
| | | GTAACTGCTCGCACCTTGACGGTACCTAACCAGAAAGCCACGGCTAACTACGTGCCAGCA |
| | | GCCGCGGTAATACGTAGGTGGCAAGCGTTGTCCGGAATTATTGGGCGTAAAGGGCTCGCA |
| | | GGCGGTTTCTTAAGTCTGATGTGAAAGCCCCCGGCTCAACCGGGGAGGGTCATTGGAAAC |
| | | TGGGAAACTTGAGTGCAGAAGAGGAGAGTGGAATTCCACGTGTAGCGGTGAAATGCGTAG |
| | | AGATGTGGAGGAACACCAGTGGCGAAGGCGACTCTCTGGTCTGTAACTGACGCTGAGGAG |
| | | CGAAAGCGTGGGGAGCGAACAGGATTAGATACCCTGGTAGTCCACGCCGTAAACGATGAG |
| | | TGCTAAGTGTTAGGGGGTTTCCGCCCCTTAGTGCTGCAGCTAACGCATTAAGCACTCCGC |
| | | CTGGGGAGTACGGTCGCAAGACTGAAACTCAAAGGAATTGACGGGGGCCCGCACAAGCGG |
| | | TGGAGCATGTGGTTTAATTCGAAGCAACGCGAAGAACCTTACCAGGTCTTGACATCCTCT |
| | | GACAACCCTAGAGATAGGGCTTTCCCTTCGGGGACAGAGTGACAGGTGGTGCATGGTTGT |
| | | CGTCAGCTCGTGTCGTGAGATGTTGGGTTAAGTCCCGCAACGAGCGCAACCCTTGATCTT |
| | | AGTTGCCAGCATTTAGTTGGGCACTCTAAGGTGACTGCCGGTGACAAACCGGAGGAAGGT |
| | | GGGGATGACGTCAAATCATCATGCCCCTTATGACCTGGGCTACACACGTGCTACAATGGA |
| | | CAGAACAAAGGGCTGCGAGACCGCAAGGTTTAGCCAATCCCATAAATCTGTTCTCAGTTC |
| | | GGATCGCAGTCTGCAACTCGACTGCGTGAAGCTGGAGTCGCTAGTATCC |
| | | (SEQ ID NO: 55) |
| 96 | Staphylococcus | TATACATGCAAGTCGAGCGAACAGACGAGGAGCTTGCTCCTCTGACGTTAGCGGCGGACG |
| | epidermis | GGTGAGTAACACGTGGATAACCTACCTATAAGACTGGGATAACTTCGGGAAACCGGAGCT |
| | | AATACCGGATAATATATTGAACCGCATGGTTCAATAGTGAAAGACGGTTTTGCTGTCACT |
| | | TATAGATGGATCCGCGCCGCATTAGCTAGTTGGTAAGGTAACGGCTTACCAAGGCAACGA |
| | | TGCGTAGCCGACCTGAGAGGGTGATCGGCCACACTGGAACTGAGACACGGTCCAGACTCC |
| | | TACGGGAGGCAGCAGTAGGGAATCTTCCGCAATGGGCGAAAGCCTGACGGAGCAACGCCG |
| | | CGTGAGTGATGAAGGTCTTCGGATCGTAAAACTCTGTTATTAGGGAAGAACAAATGTGTA |
| | | AGTAACTATGCACGTCTTGACGGTACCTAATCAGAAAGCCACGGCTAACTACGTGCCAGC |
| | | AGCCGCGGTAATACGTAGGTGGCAAGCGTTATCCGGAATTATTGGGCGTAAAGCGCGCGT |
| | | AGGCGGTTTTTTAAGTCTGATGTGAAAGCCCACGGCTCAACCGTGGAGGGTCATTGGAAA |
| | | CTGGAAAACTTGAGTGCAGAAGAGGAAAGTGGAATTCCATGTGTAGCGGTGAAATGCGCA |
| | | GAGATATGGAGGAACACCAGTGGCGAAGGCGACTTTCTGGTCTGTAACTGACGCTGATGT |
| | | GCGAAAGCGTGGGGATCAAACAGGATTAGATACCCTGGTAGTCCACGCCGTAAACGATGA |
| | | GTGCTAAGTGTTAGGGGGTTTCCGCCCCTTAGTGCTGCAGCTAACGCATTAAGCACTCCG |
| | | CCTGGGGAGTACGACCGCAAGGTTGAAACTCAAAGGAATTGACGGGGACCCGCACAAGCG |
| | | GTGGAGCATGTGGTTTAATTCGAAGCAACGCGAAGAACCTTACCAAATCTTGACATCCTC |
| | | TGACCCCTCTAGAGATAGAGTTTTCCCCTTCGGGGGACAGAGTGACAGGTGGTGCATGGT |
| | | TGTCGTCAGCTCGTGTCGTGAGATGTTGGGTTAAGTCCCGCAACGAGCGCAACCCTTAAG |
| | | CTTAGTTGCCATCATTAAGTTGGGCACTCTAAGTTGACTGCCGGTGACAAACCGGAGGAA |
| | | GGTGGGGATGACGTCAAATCATCATGCCCCTTATGATTTGGGCTACACACGTGCTACAAT |
| | | GGACAATACAAAGGGTAGCGAAACCGCGAGGTCAAGCAAATCCCATAAAGTTGTTCTCAG |
| | | TTCGGATTGTAGTCTGCAACTCGACTATATGAAGCTGGA( SEQ ID NO: 56) |
| 97 | Bacillus subtilis | AATACATGCAAGTCGAGCGGACAGATGGGAGCTTGCTCCTGATGTTAGCGGCGGACGGGT |
| | | GAGTAACACGTGGGTAACCTGCCTGTAAGACTGGGATAACTCCGGGAAACCGGGGCTAAT |
| | | ACCGGATGGTTGTTTGAACCGCATGGTTCAAACATAAAAGGTGGCTTCGGCTACCACTTA |
| | | CAGATGGACCCGCGGCGCATTAGCTAGTTGGTGAGGTAACGGCTCACCAAGGCAACGATG |
| | | CGTAGCCGACCTGAGAGGGTGATCGGCCACACTGGGACTGAGACACGGCCCAGACTCCTA |
| | | CGGGAGGCAGCAGTAGGGAATCTTCCGCAATGGACGAAAGTCTGACGGAGCAACGCCGCG |
| | | TGAGTGATGAAGGTTTTCGGATCGTAAAGCTCTGTTGTTAGGGAAGAACAAGTACCGTTC |
| | | GAATAGGGCGGTACCTTGACGGTACCTAACCAGAAAGCCACGGCTAACTACGTGCCAGCA |
| | | GCCGCGGTAATACGTAGGTGGCAAGCGTTGTCCGGAATTATTGGGCGTAAAGGGCTCGCA |
| | | GGCGGTTTCTTAAGTCTGATGTGAAAGCCCCCGGCTCAACCGGGGAGGGTCATTGGAAAC |
| | | TGGGGAACTTGAGTGCAGAAGAGGAGAGTGGAATTCCACGTGTAGCGGTGAAATGCGTAG |
| | | AGATGTGGAGGAACACCAGTGGCGAAGGCGACTCTCTGGTCTGTAACTGACGCTGAGGAG |
| | | CGAAAGCGTGGGGAGCGAACAGGATTAGATACCCTGGTAGTCCACGCCGTAAACGATGAG |
| | | TGCTAAGTGTTAGGGGGTTTCCGCCCCTTAGTGCTGCAGCTAACGCATTAAGCACTCCGC |
| | | CTGGGGAGTACGGTCGCAAGACTGAAACTCAAAGGAATTGACGGGGGCCCGCACAAGCGG |
| | | TGGAGCATGTGGTTTAATTCGAAGCAACGCGAAGAACCTTACCAGGTCTTGACATCCTCT |
| | | GACAATCCTAGAGATAGGACGTCCCCTTCGGGGGCAGAGTGACAGGTGGTGCATGGTTGT |
| | | CGTCAGCTCGTGTCGTGAGATGTTGGGTTAAGTCCCGCAACGAGCGCAACCCTTGATCTT |
| | | AGTTGCCAGCATTCAGTTGGGCACTCTAAGGTGACTGCCGGTGACAAACCGGAGGAAGGT |
| | | GGGGATGACGTCAAATCATCATGCCCCTTATGACCTGGGCTACACACGTGCTACAATGGA |
| | | CAGAACAAAGGGCAGCGAAACCGCGAGGTTAAGCCAATCCCACAAATCTGTTCTCAGTTC |
| | | GGATCGCAGTCTGCAACTCGACTGCGTGAAGCTGGAATCGCTAGTATC |
| | | (SEQ ID NO: 57) |

### Example 5: Determining Volatile Production of Bacterial Isolates

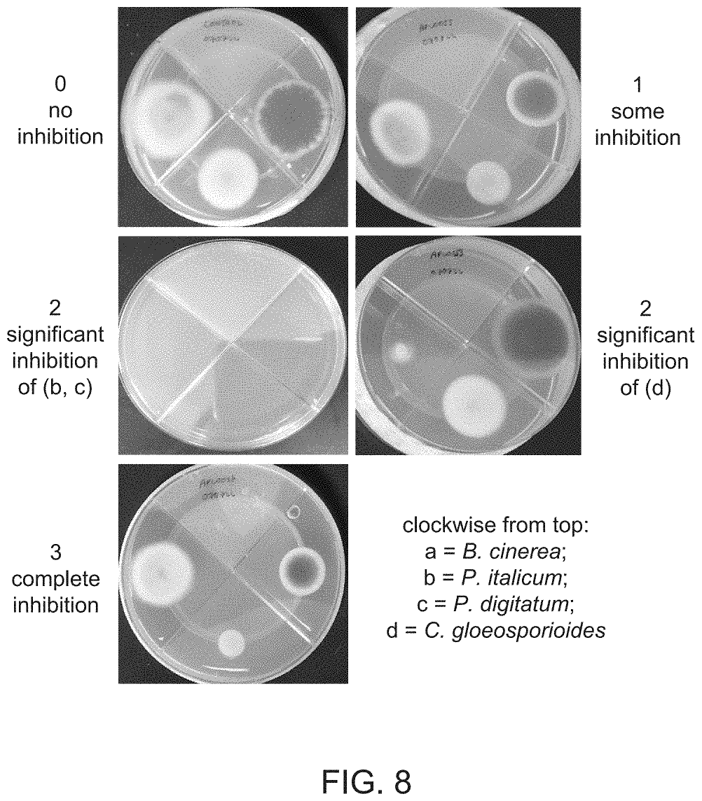

Bacterial isolates from produce samples were screened for volatile production against Botrytis cinerea (Bc), Colletotrichum gloeosporioides (Cg), Penicillium digitatum (Pd), and Penicillium italicum (Pi) using a plate assay as described in Example 4. For each bacterial isolate and fungal species combination, a plate assay ranking was assigned and volatile production was measured based on the scale in FIG. 8 and Table 4.

TABLE 4
Plate assay results

Plate Assay Results ^{a}

| Strain | Bc | Pi | Pd | Cg |
|---|---|---|---|---|
| 1 | 1 | 1 | 1 | 1 |
| 2 | 2 | 2 | 2 | 0 |
| 3 | 1 | 1 | 1 | 0 |
| 4 | 2 | 2 | 2 | 1 |
| 5 | 1 | 0 | 0 | 3 |
| 6 | 2 | 1 | 1 | 0 |
| 7 | 1 | 0 | 0 | 3 |
| 8 | 1 | 0 | 1 | 0 |
| 9 | 1 | 0 | 1 | 0 |
| 10 | 1 | 0 | 1 | 0 |
| 11 | 1 | 0 | 1 | 0 |
| 12 | 1 | 0 | 1 | 0 |
| 13 | 1 | 0 | 0 | 0 |
| 14 | 0 | 0 | 0 | 3 |
| 15 | 0 | 0 | 0 | 0 |
| 16 | 0 | 0 | 0 | 0 |
| 17 | 0 | 0 | 0 | 0 |
| 18 | 1 | 0 | 0 | 0 |
| 19 | 1 | 0 | 0 | 0 |
| 20 | 0 | 0 | 0 | 0 |
| 21 | 0 | 0 | 0 | 0 |
| 22 | 1 | 0 | 0 | 3 |
| 23 | 1 | 0 | 1 | 0 |
| 24 | 1 | 1 | 1 | 0 |
| 25 | 0 | 0 | 0 | 0 |
| 26 | 1 | 1 | 1 | 0 |
| 27 | 0 | 1 | 1 | 0 |
| 28 | 0 | 0 | 0 | 3 |
| 29 | 0 | 1 | 1 | 0 |
| 30 | 0 | 1 | 1 | 0 |
| 31 | 0 | 1 | 1 | 0 |
| 32 | 0 | 0 | 0 | 0 |
| 33 | 0 | 0 | 0 | 3 |
| 34 | 0 | 0 | 3 | 0 |
| 35 | 0 | 1 | 2 | 0 |
| 36 | 0 | 0 | 0 | 0 |
| 37 | 0 | 1 | 1 | 0 |
| 38 | 3 | 0 | 0 | 0 |
| 39 | 3 | 0 | 0 | 0 |
| 40 | NG | NG | NG | NG |
| 41 | 0 | 0 | 0 | 0 |
| 42 | 0 | 0 | 0 | 0 |
| 43 | 0 | 2 | 2 | 3 |
| 44 | 0 | 0 | 0 | 0 |
| 45 | 0 | 0 | 0 | 0 |
| 46 | 0 | 1 | 1 | 0 |
| 47 | 0 | 1 | 1 | 3 |
| 48 | 0 | 2 | 2 | 1 |
| 49 | NG | NG | NG | NG |
| 50 | 0 | 0 | 0 | 0 |
| 51 | 0 | 0 | 0 | 3 |
| 52 | 0 | 0 | 0 | 0 |
| 53 | 0 | 0 | 0 | 2 |
| 54 | 0 | 0 | 0 | 0 |
| 55 | 0 | 1 | 1 | 1 |
| 56 | 0 | 0 | 0 | 0 |
| 57 | 0 | 1 | 1 | 3 |
| 58 | 0 | 1 | 1 | 3 |
| 59 | 0 | 0 | 0 | 0 |
| 60 | 0 | 1 | 1 | 0 |
| 61 | 0 | 0 | 0 | 0 |
| 62 | 0 | 2 | 2 | 1 |
| 63 | 0 | 1 | 1 | 3 |
| 64 | 2 | 2 | 2 | 1 |
| 65 | 0 | 0 | 0 | 0 |
| 66 | 0 | 0 | 0 | 0 |
| 67 | 0 | 1 | 1 | NG |
| 68 | 1 | 1 | 1 | 3 |
| 69 | 1 | 0 | 0 | 0 |
| 70 | 0 | 0 | 1 | 3 |
| 71 | 0 | 0 | 0 | 0 |
| 72 | 0 | 0 | 0 | 3 |
| 73 | NG | NG | NG | NG |
| 74 | 0 | 0 | 0 | 0 |
| 75 | 0 | 1 | 1 | 0 |
| 76 | 0 | 0 | 0 | 3 |
| 77 | 0 | 0 | 0 | 3 |
| 78 | 2 | 2 | 2 | 1 |
| 79 | 0 | 0 | 0 | 3 |
| 80 | 0 | 0 | 0 | 3 |
| 81 | 0 | 0 | 0 | 2 |
| 82 | 1 | 2 | 2 | NG |
| 83 | 0 | 0 | 0 | 0 |
| 84 | 0 | 0 | 0 | 0 |
| 85 | 0 | 0 | 0 | NG |
| 86 | 2 | 3 | 2 | 1 |
| 87 | 2 | 0 | 1 | NG |
| 88 | 2 | 1 | 1 | NG |
| 89 | 1 | 0 | 0 | 0 |
| 90 | 0 | 0 | 0 | 1 |
| 91 | 0 | 0 | 0 | NG |
| 92 | 0 | 0 | 0 | NG |
| 93 | 0 | 0 | 0 | NG |
| 94 | 0 | 0 | 0 | 0 |
| 95 | 0 | 0 | 0 | 2 |
| 96 | 0 | 0 | 0 | NG |
| 97 | 2 | 1 | 2 | 1 |
| 98 | 0 | 0 | 0 | 0 |
| 99 | 2 | 2 | 2 | 1 |
| 100 | 2 | 2 | 2 | NG |
| 101 | 0 | 0 | 0 | NG |
| 102 | 1 | 1 | 1 | 1 |
| 103 | 0 | 0 | 0 | 0 |
| 104 | 0 | 0 | 0 | NG |
| 105 | 0 | 1 | 1 | NG |
| 106 | 0 | 0 | 0 | NG |
| 107 | 0 | 0 | 0 | NG |
| 108 | 0 | 0 | 0 | NG |
| 109 | 1 | 1 | 1 | 2 |
| 110 | 0 | 0 | 1 | NG |
| 111 | 1 | 1 | 2 | NG |
| 112 | 0 | 0 | 0 | NG |
| 113 | NG | NG | NG | NG |
| 114 | 0 | 0 | 0 | NG |
| 115 | 0 | 0 | 0 | NG |
| 116 | 0 | 0 | 0 | NG |

0—no inhibition;
1—some inhibition;
2—significant inhibition;
3—complete inhibition;
NG—No growth of bacterial species

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composition comprising:
a plurality of antimicrobial microorganisms, or conditioned media of a plurality of cultured antimicrobial microorganisms; and
one or more fatty acid derivatives.

2. The composition of claim 1, wherein the plurality of antimicrobial microorganisms comprises one or more antimicrobial microorganisms selected from strain 1-116.

3. The composition of claim 1, wherein the plurality of antimicrobial microorganisms comprises one or more antimicrobial microorganisms selected from Bacillus strain 22, Pseudomonas strain 1, Bacillus strain 12, Bacillus strain 15, Bacillus strain 23, Bacillus strain 24, Bacillus strain 35, Streptomyces strain 33, and Pantoea strain 37.

4. The composition of claim 1, wherein the antimicrobial microorganism in the plurality of antimicrobial microorganisms comprises a 16S rRNA sequence that is at least 75%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% identical to any one of SEQ ID NOs: 1-57.

5. The composition of claim 1, wherein the composition comprises 10³ to 10¹⁰ CFU of antimicrobial microorganisms per milliliter.

6. The composition of claim 1, wherein the one or more fatty acid derivatives comprises one or more fatty acids, one or more fatty acid esters, or one or more fatty acid salts.

7. The composition of claim 1, wherein the composition comprises from about 60% to about 99.9% by weight of the one or more fatty acid derivatives.

8. The composition of claim 1, wherein the one or more fatty acid derivatives comprises a compound of Formula IA: 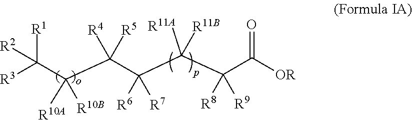
wherein:
R is selected from: H and C₁-C₆ alkyl optionally substituted with one or more of OH and C₁-C₆ alkoxy;
R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;
each occurrence of R^{10A}, R^{10B}, R^{11A}, and R^{11B} is independently selected from: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and
o is an integer from 0 to 17;
p is an integer from 0 to 17;
wherein the sum of o and p is from 0 to 17;
or a salt thereof when R is C₁-C₆ alkyl optionally substituted with one or more of OH and C₁-C₆ alkoxy.

9. The composition of claim 1, wherein the one or more fatty acid derivatives comprises a compound of Formula IA-A: 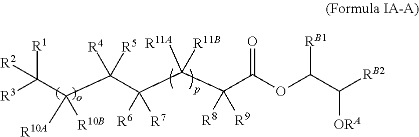
or a salt thereof,
wherein:
one of R^{B1} and R^{B2} is H, and the other of R^{B1} and R^{B2} is —CH₂OR^{A};
each occurrence of R^{A} is independently selected from H and C₁-C₆ alkyl;
R¹, R², R³, R⁴, R⁵, R⁶, R⁷, R⁸, and R⁹ are independently selected from: H, OH, C₁-C₆ alkyl, C₂-C₆ alkenyl, and C₁-C₆ alkoxy;
each occurrence of R^{10A}, R^{10B}, R^{11A}, and R^{11B} is independently selected from: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

10. A method of identifying an antimicrobial microorganism from a plurality of agricultural products, the method comprising:
storing the plurality of agricultural products until at least 90% of the agricultural products show detectable signs of spoilage; and
isolating the antimicrobial microorganism from the agricultural products that have the least detectable signs of spoilage.

11. The method of claim 10, wherein the plurality of agricultural products are treated with a food-spoilage pathogen prior to storage.

12. The method of claim 10, wherein the food-spoilage pathogen is a fungi or a bacterial species.

13. The method of claim 10, wherein the method further comprises assaying the antimicrobial microorganism for antimicrobial activity after isolating the antimicrobial microorganism.

14. The method of claim 10, wherein the detectable signs of spoilage are selected from: a color change, a change in the ratio of starch to soluble sugar, a loss of mass, a change in texture, a visible sign of growth of a biological stressor, a development of an off-odor, a development of an off-flavor, and a combination thereof.

15. A method of preserving an agricultural product, the method comprising coating the agricultural product with a composition comprising a plurality of antimicrobial microorganisms or conditioned media of a plurality of antimicrobial microorganisms.

16. The method of claim 15, wherein the agricultural product coated with the composition displays an improved feature compared to an uncoated agricultural product, wherein the improved feature comprises reduced microbial growth, delayed onset of microbial growth, improved shelf life, reduced desiccation, or a combination thereof.

17. The method of claim 15, wherein the composition further comprises one or more fatty acid derivatives.

18. The method of claim 15, wherein the method further comprises coating the agricultural product with an additional composition comprising one or more fatty acid derivatives.

19. The method of claim 15, wherein the plurality of antimicrobial microorganisms comprises one or more antimicrobial microorganisms selected from strain 1-116.

20. The method of claim 15, wherein the plurality of antimicrobial microorganisms comprises one or more antimicrobial microorganisms selected from Bacillus strain 22, Pseudomonas strain 1, Bacillus strain 12, Bacillus strain 15, Bacillus strain 23, Bacillus strain 24, Bacillus strain 35, Streptomyces strain 33, and Pantoea strain 37.

21. The method of claim 15, wherein the antimicrobial microorganism in the plurality of antimicrobial microorganisms comprises a 16S rRNA sequence that is at least 75%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% identical to any one of SEQ ID NOs: 1-57.

22. The method of claim 15, wherein the composition comprises 10³ to 10¹⁰ CFU of antimicrobial microorganisms per milliliter.

23. The method of claim 15, wherein the agricultural product is coated pre-harvest, post-harvest, or both.

24. The method of claim 15, wherein coating the agricultural product comprises spraying, dipping, or brushing the composition onto the agricultural product.

25. The method of claim 15, wherein the agricultural product comprises a fruit, a vegetable, a plant, or a flower.


SEQUENCE LISTING (57 sequences)

SEQ ID NO: 1 - DNA, 1532 bp, unidentified
  source 1..1532: mol_type = other DNA
tgaagagtttgatcatggctcagattgaacgctggcggcaggcctaacacatgcaagtcgagcggatgaaaggagcttgctcctggattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggttcgttaagttggatgtgaaatccccgggctcaacctgggaactgcatccaaaactggcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggattggtgccttcgggagcattgagacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaaccttcgggaggacggttaccacggtgtgattcatgactggggtgaagtcgtaacaaggtagccgtaggggaacctgcggctggatcacctcctt

SEQ ID NO: 2 - DNA, 1542 bp, unidentified
  source 1..1542: mol_type = other DNA
tcggagagtttgatcctggctcaggacgaacgctggcggcgtgcctaatacatgcaagtcgagcggacagatgggagcttgctcctgatgttagcggcggacgggtgagtaacacgtgggtaacctgcctgtaagactgggataactccgggaaaccggggctaataccggatgcttgtttgaaccgcatggttcaaacataaaagtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcaaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttaggggtttccgccccttagtgctgcagctaacgcattaagcactccgcctgggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttatggagccagccgccgaaggtgggacagatgattggggtgaagtcgtaacaaggtagccgtatcggaaggtgcggctggatcacctccttt

SEQ ID NO: 3 - DNA, 1548 bp, unidentified
  source 1..1548: mol_type = other DNA
tcggagagtttgatcctggctcaggatgaacgctggcggcgtgcctaatacatgcaagtcgagcgaactgattagaagcttgcttctatgacgttagcggcggacgggtgagtaacacgtgggcaacctgcctgtaagactgggataacttcgggaaaccgaagctaataccggataggatcttctccttcatgggagatgattgaaagatggtttcggctatcacttacagatgggcccgcggtgcattagctagttggtgaggtaacggctcaccaaggccacgatgcatagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtacaagagtaactgcttgtaccttgacggtacctaaccagaaagccacggctaactacgtgccagcagccgcggtaatacgtaggtggcaagcgttatccggaattattgggcgtaaagcgcgcgcaggcggtttcttaagtctgatgtgaaagcccacggctcaaccgtggagggtcattggaaactggggaacttgagtgcagaagagaaaagcggaattccacgtgtagcggtgaaatgcgtagagatgtggaggaacaccagtggcgaaggcggctttttggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaactctagagatagagcgttccccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggatggtacaaagggctgcaagaccgcgaggtcaagccaatcccataaaaccattctcagttcggattgtaggctgcaactcgcctacatgaagctggaatcgctagtaatcgcggatcagcatgccgcggtgaatacgttcccgggccttgtacacaccgcccgtcacaccacgagagtttgtaacacccgaagtcggtggagtaaccgtaaggagctagccgcctaaggtgggacagatgattggggtgaagtcgtaacaaggtagccgtatcggaaggtgcggctggatcacctccttt

SEQ ID NO: 4 - DNA, 1545 bp, unidentified
  source 1..1545: mol_type = other DNA
attggagagttcgatcctggctcaggatgaacgctggcatgtgcctaatacatgcaagtcgagcgaatggattgagagcttgctctcaagaagttagcatggacgggtgagtaacacgtgggtaacctgcccataagactgggataactccgggaaaccggggctaataccggataatattttgaactgcatggttcgaaattgaaaggcgacttcggctgtcacttatggatggacccgcgtcgcattagctagttggtgaggtaacggctcaccaaggcaacgatgcgtagccgacctgagagggcgatcggccacactgggactgagacacggcccagactcctacgggaggcaagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcgtaccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaaccctcgatcttagttgccatcattaagttgggcactctaaggtgactgccggtgacaaaccggaggaaggtggggatgacgtcaaatcatcatgccccttatgacctgggctacacacgtgctacaatggacggtacaaagagccgcaagaccgcgaggtggagctaatctcataaaaccgttctcagttcggattgtaggtcgcaactcgcctacatgaagctggaatcgctagtaatcgcgatcagcatgccgcggtgaatacgttcccgggccttgtacacaccgcccgtcacaccacgagagtttgtaacacccgaagtcggtggggtaacctttggagccagccgcctaaggtgggacagatgattggggtgaagtcgtaacaaggtagccgtatcggaaggtgcactggatcacctccttt

SEQ ID NO: 5 - DNA, 1541 bp, unidentified
  source 1..1541: mol_type = other DNA
ttcggagagtttgatcctggctcaggacgaacgctggcggcgtgcctaatacatgcaagtcgagcggacagaaggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccgggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttaggggtttccgccccttagtgctgcagctaacgcattaagcactccgcctgggagtacggtcgcaagactgaaactcaaaggaattgacggggcccgcacaagcggtggagcatgtggtttaattcgaagcaacgcgaagaaccttaccaggtcttgacatcctctgacaaccctagagatagggctttccttcggggacagagtgacaggtggtgcatggttgtcgtcagctcgtgtcgtgagatgttgggttaagtcccgcaacgaggcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacctttatggagccagccgccgaaggtggggcagatgattggggtgaagtcgtaacaaggtagccgtatcggaaggtgcggctggatcacctccttt

SEQ ID NO: 6 - DNA, 1544 bp, unidentified
  source 1..1544: mol_type = other DNA
tcggagagtttgatcctggctcaggacgaacgctggcggcgtgcctaatacatgcaagtcgagcggacagatgggagcttgctccctgatgttagcggcggacgggtgagtaacacgtgggtaacctgcctgtaagactgggataactccgggaaaccggggctaataccggatgcttgtttgaaccgcatggttcaaacataaaggtggcttcggctaccacttacagatggacccgcggcgcattagctagttggtgaggtaatggctcaccaaggcaacgatgcgtagccgacctgagaggggtgatcggccacactgggactgagacacggcccagactcctacgggaggcggcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcgaccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttaggggtttccgccccttagtgccgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagatgggacgtccccttcggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaagaggcggcgaaaccgcgagttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaaggtgggacagatgattggggtgaagtcgtaacaaggtagccgtatcggaaggtgcggctggatcacctccttt

SEQ ID NO: 7 - DNA, 1521 bp, unidentified
  source 1..1521: mol_type = other DNA
acggagagtttgatcctggctcaggacgaacgctggcggcgtgcttaacacatgcaagtcgaacgatgaagcccttcggggtggattagtggcgaacgggtgagtaacacgtgggcaatctgccctgcactctgggacaagccctggaaacggggtctaataccggatactgatcgccttgggcatccttggtgatcgaaagctccggcggtgcaggatgagcccgcggcctatcagcttgttggtgaggtaatggctcaccaaggcgacgacaggtagccggcctgagagggcgaccggccacactgggactgagacacggcccagactcctacgggaggcagcagtggggaatattgcacaatgggcgaaagcctgatgcagcgacgccgcgtgagggatgacggccttcgggttgtaaacctctttcagcagggaagaagcgaaagtgacggtacctgcagaagaagcgccggctaactacgtgccagcagccgcggtaatacgtagggcgcgagcgttgtccggaattattgggcgtaaagagctcgtaggcggcttgtcgcgtcggttagaaagcccggggcttaaccccgggtctgcagtcgatacgggcaggctagagttcggtaggggagatcggaattcctggtgtagcggtgaaatgcgcagatatcaggaggaacaccggtggcgaaggcggatctctgggccgatactgacgctgaggagcgaaagcgtggggagcgaacaggattagataccctggtagtccacgccgtaaacggtgggcactaggtgtgggcgacattccacgtcgtccgtgccgcagctaacgcattaagtgccccgcctggggagtacggccgcaaggctaaaactcaaaggaattgacggggcccgcacaagcggcggagcatgtggcttaattcgacgcaacgcgaagaaccttaccaaggcttgacatacaccggaaacgtccagagatgggcgccccttgtggtcggtgtacaggtggtgcatggctgtcgtcagctcgtgtcgtgagatgttgggttaagtcccgcaacgagcgcaacccttgtcccgtgttgccagcaggcccttgtggtgctggggactcacgggagaccgccggggtcaactcggaggaaggtggggacgacgtcaagtcatcatgccccttatgtcttgggctgcacacgtgctacaatggccggtacaatgagctgcgataccgcgaggtggagcgaatctcaaaaagccggtctcagttcggattggggtctgcaactcgaccccatgaagtcggagtcgctagtaatcgcagatcagcattgctgcggtgaatacgttcccgggccttgtacacaccgcccgtcacgtcacgaaagtcggtaacacccgaagccggtggcccaaccccttgtggggagggagctgtcgaaggtgggactggcgattgggacgaagtcgtaacaaggtagccgtaccggaaggtgcggctggatcacctccttt

SEQ ID NO: 8 - DNA, 1542 bp, unidentified
  source 1..1542: mol_type = other DNA
ttcggagagtttgatcctggctcaggacgaacgctggcggcgtgcctaatacatgcaagtcgagcggacagaaggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttaggggtttccgccccttagtgctgcagctaacgcattaagcactccgcctggggagtacggtcgcaagactgaaactcaaaggaattgacggggcccgcacaagcggtggagcatgtggtttaattcgaagcaacgcgaagaaccttaccaggtcttgacatcctctgacaaccctagagatagggctttccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcaagaccgcaaggtttagccaatcccataaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacctttatggagccagccgccgaaggtggggcagatgattggggtgaagtcgtaacaaggtagccgtatcggaaggtgcggctggatcacctccttt

SEQ ID NO: 9 - DNA, 1528 bp, unidentified
  source 1..1528: mol_type = other DNA
ttgaagagtttgatcatggctcagattgaacgctggcggcaggcctaacacatgcaagtcggacggtagcacagagagcttgctctcgggtgacgagtggcggacgggtgagtaatgtctggggatctgcccgatagaggggataaccactggaaacggtggctaataccgcataacgtcgcaagaccaaagaggggaccttcgggcctctcactatcggatgaacccagatgggattagctagtaggcggggtaacggcccacctaggcgacgatcctagctggtctgagaggatgaccagccacactggaactgagacacggtccagactcctacgggaggcagcagtggggaatattgcacaatgggcgcaagcctgatgcagccatgccgcgtgtatgaagaaggccttcgggttgtaaagtactttcagcggggaggaaggcgatgtggttaataaccgcgtcgattgacgttacccgcagaagaagcaccggctaactccgtgccagcagccgcggtaatacggagggtgcaagcgttaatcggaattactgggcgtaaagcgcacgcaggcggtctgttaagtcagatgtgaaatccccgggcttaacccgggaactgcatttgaaactggcaggcttgagtctcgtagaggggtagaattcaggtgtagcggtgaaatgcgtagagatctggaggaataccggtggcgaaggcggcccctggacgaagactgacgctcaggtgcgaaagcgtgggagcaaacaggattagataccctggtagtccacgccgtaaacgatgtcgacttggaggttgttcccttgaggagtggcttccggagctaacgcgttaagtcgaccgcctggggagtacggccgcaaggttaaaactcaaatgaattgacgggggcccgcacaagcggtggagcatgtggtttaattcgatgcaacgcgaagaaccttacctactcttgacatccacggaatttggcagagatgccttagtgccttcgggaaccgtgagacaggtgctgcatggctgtcgtcagctcgtgttgtgaaatgttgggttaagtcccgcaacgagcgcaacccttatcctttgttgccagcgattcggtcgggaactcaaaggagactgccggtgataaaccggaggaaggtggggatgacgtcaagtcatcatggcccttacgagtagggctacacacgtgctacaatggcgcatacaaagagaagcgacctcgcgagagcaagcggacctcataaagtgcgtcgtagtccggatcggagtctgcaactcgactccgtgaagtcggaatcgctagtaatcgtggatcagaatgccacggtgaatacgttcccgggccttgtacacaccgcccgtcacaccatgggagtgggttgcaaaagaagtaggtagcttaaccttcgggagggcgcttaccactttgtgattcatgactggggtgaagtcgtaacaaggtaaccgtaggggaacctgcggttggatcacctcctt

SEQ ID NO: 10 - DNA, 940 bp, unidentified
  source 1..940: mol_type = other DNA
cagccgggggcattagtatttgcacgctagaggtgaaattcttggattgtgcaaagacttcctactgcgaaagcatttgccaagaatgttttcattaatcaagaacgaaggttagggtatcgaaaacgattagataccgttgtagtcttaacagtaaactatgccgactccgaatcggtcgatgctcatttcactggctcgatcggcgcggtacgagaaatcaaagtttttgggttctgggggagtatggtcgcaaggctgaaacttaaagaaattgacggaagggcaccaccaggagtggagcctgcggcttaatttgactcaacacgggaaaactcaccgggtccggacatagtaaggattgacagattgatggcgctttcatgattctatgggtggtggtgcatggccgttcttagttggtggagtgatttgtctggttaattccgataacgaacgagaccttgacctgctaaatagacgggttgacattttgttggccccttatgtcttcttagagggactatcgaccgtctaggtgatggaggcaaaaggcaataacaggtctgtgatgcccttagatgttccgggctgcacgcgcgctacactgacagagacaacgagtggggccccttgtccgaaatgactgggtaaacttgtgaaactttgtcgtgctggggatggagctttgtaatttttgctcttcaacgaggaattcctagtaagcgcaagtcatcagcttgcgttgactacgtccctgccctttgtacacaccgcccgtcgctactaccgattgaatggcttagtgaggacttgggagagtacatcggggagccagcaatggcaccctgacggctcaaactcttacaaacttggtcatttagaggaagtaaaagtcgtaacaaggtatctgtaggtgaacctgcagatggatcatttc

SEQ ID NO: 11 - DNA, 1135 bp, unidentified
  source 1..1135: mol_type = other DNA
gcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggttcgttaagttggatgtgaaatccccgggctcaacctgggaactgcatccaaaactggcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggattggtgccttcgggagcattgagacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggagtcgctagtatc

SEQ ID NO: 12 - DNA, 1196 bp, Serratia marcescens
  source 1..1196: mol_type = other DNA
gcaagtcgagcggtagcacaggggagcttctccctggtgacgagcggcggacgggtgagtaatgtctgggaaactgcctgatggagggggataactactggaaacggtagctaataccgcataacgtcgcaagaccaaagagggggaccttcgggcctcttgccatcagatgtgcccagatgggattagctagtaggtggggtaatggctcacctaggcgacgatccctagctggtctgagaggatgaccagccacactggaactgagacacggtccagactcctacgggaggcagcagtggggaatattgcacaatgggcgcaagcctgatgcagccatgccgcgtgtgtgaagaaggccttcgggttgtaaagcactttcagcgaggaggaaggtggtgaacttaatacgttcatcaattgacgttactcgcagaagaagcaccggctaactccgtgccagcagccgcggtaatacggagggtgcaagcgttaatcggaattactgggcgtaaagcgcacgcaggcggtttgttaagtcagatgtgaaatccccgggctcaacctgggaactgcatttgaaactggcaagctagagtctcgtagaggggggtagaattccaggtgtagcggtgaaatgcgtagagatctggaggaataccggtggcgaaggcggccccctggacgaagactgacgctcaggtgcgaaagcgtggggagcaaacaggattagataccctggtagtccacgctgtaaacgatgtcgatttggaggttgtgcccttgaggcgtggcttccggagctaacgcgttaaatcgaccgcctggggagtacggccgcaaggttaaaactcaaatgaattgacgggggcccgcacaagcggtggagcatgtggtttaattcgatgcaacgcgaagaaccttacctactcttgacatccagagaactttccagagatggattggtgccttcgggaactctgagacaggtgctgcatggctgtcgtcagctcgtgttgtgaaatgttgggttaagtcccgcaacgagcgcaacccttatcctttgttgccagcggttcggccgggaactcaaaggagactgccagtgataaactggaggaaggtggggatgacgtcaagtcatcatggcccttacgagtagggctacacacgtgctacaatggcgtatacaaaga

SEQ ID NO: 13 - DNA, 1349 bp, unidentified
  source 1..1349: mol_type = other DNA
tgctcagacgaacgctggcggcgtgcctaatacatgcaagtcgagcggacagaagggagcttgctcccggatgttagcggcggacggcgtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggaatcgctagtaatcggcagatcagc

SEQ ID NO: 14 - DNA, 1328 bp, Stenotrophomonas maltophilia
  source 1..1328: mol_type = other DNA
tcagagtgaacgctggcggtaggcctaacacatgcaagtcgaacggcagcacagaggagcttgctccttgggtggcgagtggcggacgggtgaggaatacatcggaatctactttttcgtgggggataacgtagggaaacttacgctaataccgcatacgacctacgggtgaaagcaggggatcttcggaccttgcgcgattgaatgagccgatgtcggattagctagttggcggggtaaaggcccaccaaggcgacgatccgtagctggtctgagaggatgatcagccacactggaactgagacacggtccagactcctacgggaggcagcagtggggaatattggacaatgggcgcaagcctgatccagccataccgcgtgggtgaagaaggccttcgggttgtaaagcccttttgttgggaaagaaatccagccggctaatacctggttgggatgacggtacccaaagaataagcaccggctaacttcgtgccagcagccgcggtaatacgaagggtgcaagcgttactcggaattactgggcgtaaagcgtgcgtaggtggttgtttaagtctgttgtgaaagccctgggctcaacctgggaactgcagtggaaactggacaactagagtgtggtagagggtagcggaattcccggtgtagcagtgaaatgcgtagagatcgggaggaacatccatggcgaaggcagctacctggaccaacactgacactgaggcacgaaagcgtggggagcaaacaggattagataccctggtagtccacgccctaaacgatgcgaactggatgttgggtgcaatttggcacgcagtatcgaagctaacgcgttaagttcgccgcctggggagtacggtcgcaagactgaaactcaaaggaattgacgggggcccgcacaagcggtggagtatgtggtttaattcgatgcaacgcgaagaaccttacctggccttgacatgtcgagaactttccagagatggattggtgccttcgggaactcgaacacaggtgctgcatggctgtcgtcagctcgtgtcgtgagatgttgggttaagtcccgcaacgagcgcaacccttgtccttagttgccagcacgtaatggtgggaactctaaggagaccgccggtgacaaaccggaggaaggtggggatgacgtcaagtcatcatggcccttacggccagggctacacacgtactacaatggtagggacagagggctgcaagccggcgacggtaagccaatcccagaaaccctatctcagtccggattggagtctgcaactcgactccatgaagtcggaatcgctagta

SEQ ID NO: 15 - DNA, 1270 bp, Delftia lacustris
  source 1..1270: mol_type = other DNA
tcttcggacgctgacgagtggcgaacgggtgagtaatacatcggaacgtgcccagtcgtgggggataactactcgaaagagtagctaataccgcatacgatctgaggatgaaagcgggggaccttcgggcctcgcgcgattggagcggccgatggcagattaggtagttggtgggataaaagcttaccaagccgacgatctgtagctggtctgagaggacgaccagccacactgggactgagacacggcccagactcctacgggaggcagcagtggggaattttggacaatgggcgaaagcctgatccagcaatgccgcgtgcaggatgaaggccttcgggttgtaaactgcttttgtacggaacgaaaaagctccttctaatacagggggcccatgacggtaccgtaagaataagcaccggctaactacgtgccagcagccgcggtaatacgtagggtgcgagcgttaatcggaattactgggcgtaaagcgtgcgcaggcggttatgtaagacagatgtgaaatccccgggctcaacctgggaactgcatttgtgactgcatggctagagtacggtagagggggatggaattccgcgtgtagcagtgaaatgcgtagatatgcggaggaacaccgatggcgaaggcaatcccctggacctgtactgacgctcatgcacgaaagcgtggggagcaaacaggattagataccctggtagtccacgccctaaacgatgtcaactggttgttgggaattagttttctcagtaacgaagctaacgcgtgaagttgaccgcctggggagtacggccgcaaggttgaaactcaaaggaattgacggggacccgcacaagcggtggatgatgtggtttaattcgatgcaacgcgaaaaaccttacccacctttgacatggcaggaagtttccagagatggattcgtgctcgaaagagaacctgcacacaggtgctgcatggctgtcgtcagctcgtgtcgtgagatgttgggttaagtcccgcaacgagcgcaacccttgtcattagttgctacattcagttgagcactctaatgagactgccggtgacaaaccggaggaaggtggggatgacgtcaagtcctcatggcccttataggtggggctacacacgtcatacaatggctggtacagagggttgccaacccgcgagggggagctaatcccataaaaccagtcgtagtccggatcgcagtctgcaactcgactgcgtgaagtcggagtcgctagtaatcgca

SEQ ID NO: 16 - DNA, 1304 bp, Bacillus stratosphericus
  source 1..1304: mol_type = other DNA
tacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggagtcgctagta

SEQ ID NO: 17 - DNA, 1390 bp, Alcaligenes faecalis
  source 1..1390: mol_type = other DNA
gcagcgcgagagagcttgctctcttggcggcgagtggcggacgggtgagtaatatatcggaacgtgcccagtagcgggggataactactcgaaagagtggctaataccgcatacgccctacgggggaaagggggggatcgcaagacctctcactattggagcggccgatatcggattagctagttggtggggtaaaggctcaccaaggcaacgatccgtagctggtttgagaggacgaccagccacactgggactgagacacggcccagactcctacgggaggcagcagtggggaattttggacaatgggggaaaccctgatccagccatcccgcgtgtatgatgaaggccttcgggttgtaaagtacttttggcagagaagaaaaggtatcccctaatacgggatactgctgacggtatctgcagaataagcaccggctaactacgtgccagcagccgcggtaatacgtagggtgcaagcgttaatcggaattactgggcgtaaagcgtgtgtaggcggttcggaaagaaagatgtgaaatcccagggctcaaccttggaactgcatttttaactgccgagctagagtatgtcagaggggggtagaattccacgtgtagcagtgaaatgcgtagatatgtggaggaataccgatggcgaaggcagccccctgggataatactgacgctcagacacgaaagcgtggggagcaaacaggattagataccctggtagtccacgccctaaacgatgtcaactagctgttggggccgttaggccttagtagcgcagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatgtctggaaagccgaagagatttggccgtgctcgcaagagaaccggaacacaggtgctgcatggctgtcgtcagctcgtgtcgtgagatgttgggttaagtcccgcaacgagcgcaacccttgtcattagttgctacgcaagagcactctaatgagactgccggtgacaaaccggaggaaggtggggatgacgtcaagtcctcatggcccttatgggtagggcttcacacgtcatacaatggtcgggacagagggtcgccaacccgcgagggggagccaatctcagaaacccgatcgtagtccggatcgcagtctgcaactcgactgcgtgaagtcggaatcgctagtaatcgcggatcagaatgtcgcggtgaatacgttcccgggtcttgtacacaccgcccgtcacaccatgggagtgggttcaccagaagtaggtagcctaaccgtaaggagggcgcta

SEQ ID NO: 18 - DNA, 1279 bp, Enterobacter cloacae
  source 1..1279: mol_type = other DNA
catgctcagattgaacgctggcggcaggcctaacacatgcaagtcgaacggtagcacagagagcttgctctcgggtgacgagtggcggacgggtgagtaatgtctgggaaactgcctgatggagggggataactactggaaacggtagctaataccgcataacgtcgcaagaccaaagagggggaccttcgggcctcttgccatcagatgtgcccagatgggattagctagtaggtggggtaacggctcacctaggcgacgatccctagctggtctgagaggatgaccagccacactggaactgagacacggtccagactcctacgggaggcagcagtggggaatattgcacaatgggcgcaagcctgatgcagccatgccgcgtgtatgaagaaggccttcgggttgtaaagtactttcagcggggaggaaggtgttgtggttaataaccacagcaattgacgttacccgcagaagaagcaccggctaactccgtgccagcagccgcggtaatacggagggtgcaagcgttaatcggaattactgggcgtaaagcgcacgcaggcggtctgtcaagtcggatgtgaaatccccgggctcaacctgggaactgcattcgaaactggcaggctagagtcttgtagaggggggtagaattccaggtgtagcggtgaaatgcgtagagatctggaggaataccggtggcgaaggcggccccctggacaaagactgacgctcaggtgcgaaagcgtggggagcaaacaggattagataccctggtagtccacgccgtaaacgatgtcgatttggaggttgtgcccttgaggcgtggcttccggagctaacgcgttaaatcgaccgcctggggagtacggccgcaaggttaaaactcaaatgaattgacgggggcccgcacaagcggtggagcatgtggtttaattcgatgcaacgcgaagaaccttacctggtcttgacatccacagaacttagcagagatgctttggtgccttcgggaactgtgagacaggtgctgcatggctgtcgtcagctcgtgttgtgaaatgttgggttaagtcccgcaacgagcgcaacccttatcctttgttgccagcggttaggccgggaactcaaaggagactgccagtgataaactggaggaaggtggggatgacgtcaagtcatcatggcccttacgaccagggctacacacgtgctacaatggcgcatacaaagagaagcgacctcgcgagagcaagcggacctcataaagtgcgtcgta

SEQ ID NO: 19 - DNA, 1284 bp, Pseudomonas koreensis
  source 1..1284: mol_type = other DNA
aacacatgcaagtcgagcggatgaaaggagcttgctcctggattcagcggcggacgggtgagtaatgcctaggaatctgctggtagtgggggacaacgtttcgaaaggaacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggttcgttaagttggatgtgaaatccccgggctcaacctgggaactgcatccaaaactggcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggattggtgccttcgggaacattgagacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcgga

SEQ ID NO: 20 - DNA, 1154 bp, Pseudomonas moraviensis
  source 1..1154: mol_type = other DNA
tcagattgaacgctgcggcaggcctaacacatgcaagtcgagcggatgaaaggagcttgctcctggattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaagcgcgcgtaggtggttcgttaagttggatgtgaaatccccgggctcaacctgggaactgcatccaaaactggcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggattggtgccttcgggagcattgagacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtg

SEQ ID NO: 21 - DNA, 1272 bp, Bacillus nakamurai
  source 1..1272: mol_type = other DNA
gatgttagcggcggacgggtgagtaacacgtgggtaacctgcctgtaagactgggataactccgggaaaccggggctaataccggatgcttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcgaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtatcggcg

SEQ ID NO: 22 - DNA, 1314 bp, Staphylococcus pasteuri
  source 1..1314: mol_type = other DNA
aatacatgcaagtcgagcgaacagataaggagcttgctcctttgacgttagcggcggacgggtgagtaacacgtggataacctacctataagactgggataacttcgggaaaccggagctaataccggataagattttgaaccgcatggttcaatagtgaaagacggccttgctgtcacttatagatggatccgcgccgtattagctagttggtaaggtaacggcttaccaaggcaacgatacgtagccgacctgagagggtgatcggccacactggaactgagacacggtccagactcctacgggaggcagcagtagggaatcttccgcaatgggcgaaagcctgacggagcaacgccgcgtgagtgatgaaggtcttcggatcgtaaaactctgttatcagggaagaacaaacgtgtaagtaactgtgcacgtcttgacggtacctgatcagaaagccacggctaactacgtgccagcagccgcggtaatacgtaggtggcaagcgttatccggaattattgggcgtaaagcgcgcgtaggcggttttttaagtctgatgtgaaagcccacggctcaaccgtggagggtcattggaaactggaaaacttgagtgcagaagaggaaagtggaattccatgtgtagcggtgaaatgcgcagagatatggaggaacaccagtggcgaaggcgactttctggtctgtaactgacgctgatgtgcgaaagcgtggggatcaaacaggattagataccctggtagtccacgccgtaaacgatgagtgctaagtgttagggggtttccgccccttagtgctgcagctaacgcattaagcactccgcctggggagtacgaccgcaaggttgaaactcaaaggaattgacggggacccgcacaagcggtggagcatgtggtttaattcgaagcaacgcgaagaaccttaccaaatcttgacatcctttgaccgctctagagatagagttttccccttcgggggacaaagtgacaggtggtgcatggttgtcgtcagctcgtgtcgtgagatgttgggttaagtcccgcaacgagcgcaacccttaagcttagttgccatcattaagttgggcactctaagttgactgccggtgacaaaccggaggaaggtggggatgacgtcaaatcatcatgccccttatgatttgggctacacacgtgctacaatggacaatacaaagggcagctaaaccgcgaggtcaagcaaatcccataaagttgttctcagttcggattgtagtctgcaactcgactacatgaagctggagtcgctagtatccgc

SEQ ID NO: 23 - DNA, 1117 bp, Preista megaterium
  source 1..1117: mol_type = other DNA
agatggtttcggctatcacttacagatgggcccgcggtgcattagctagttggtgaggtaacggctcaccaaggcaacgatgcatagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtacaagagtaactgcttgtaccttgacggtacctaaccagaaagccacggctaactacgtgccagcagccgcggtaatacgtaggtggcaagcgttatccggaattattgggcgtaaagcgcgcgcaggcggtttcttaagtctgatgtgaaagcccacggctcaaccgtggagggtcattggaaactggggaacttgagtgcagaagagaaaagcggaattccacgtgtagcggtgaaatgcgtagagatgtggaggaacaccagtggcgaaggcggctttttggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaactctaaagatagagcgttccccttcgggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggatggtacaaagggctgcaagaccgcgaggtcaagccaatcccataaaaccattctcagttcggattgtaggctgc

SEQ ID NO: 24 - DNA, 1039 bp, Arthrobacter rhombi
  source 1..1039: mol_type = other DNA
tcagcttgttggtggggtaatggcctaccaaggcgacgacgggtagccggcctgagagggtgaccggccacactgggactgagacacggcccagactcctacgggaggcagcagtggggaatattgcacaatgggcgaaagcctgatgcagcgacgccgcgtgagggatgacggccttcgggttgtaaacctctttcagtagggaagaagcgaaagtgacggtacctgcagaagaagcgccggctaactacgtgccagcagccgcggtaatacgtagggcgcaagcgttatccggaattattgggcgtaaagagctcgtaggcggtttgtcgcgtctgccgtgaaagtccggggctcaaccccggatctgcggtgggtacgggcagactagagtgatgtaggggagactggaattcctggtgtagcggtgaaatgcgcagatatcaggaggaacaccgatggcgaaggcaggtctctgggcattaactgacgctgaggagcgaaagcatggggagcgaacaggattagataccctggtagtccatgccgtaaacgttgggcactagatgtgggggacattccacgttttccgcgtcgtagctaacgcattaagtgccccgcctggggagtacggccgcaaggctaaaactcaaaggaattgacgggggcccgcacaagcggcggagcatgcggattaattcgatgcaacgcgaagaaccttaccaaggcttgacatgggccggatcgccgcagaaatgtggtttcccctttggggccggttcacaggtggtgcatggttgtcgtcagctcgtgtcgtgagatgttgggttaagtcccgcaacgagcgcaaccctcgttccatgttgccagcacgtagtggtggggactcatgggagactgccggggtcaactcggaggaaggtgaggacgacgtcaaatcatcatgccccttatgtcttgggcttcacgcatgctacaatggccggtacaatgggttgcgatactgtgaggtggagctaatcccaaaaagccggtctca

SEQ ID NO: 25 - DNA, 1300 bp, Bacillus mobilus
  source 1..1300: mol_type = other DNA
taatacatgcaagtcgagcgaatggattgagagcttgctctcaagaagttagcggcggacgggtgagtaacacgtgggtaacctgcccataagactgggataactccgggaaaccggggctaataccggataatattttgaactgcatggttcgaaattgaaaggcggcttcggctgtcacttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaacccttgatcttagttgccatcattaagttgggcactctaaggtgactgccggtgacaaaccggaggaaggtggggatgacgtcaaatcatcatgccccttatgacctgggctacacacgtgctacaatggacggtacaaagagctgcaagaccgcgaggtggagctaatctcataaaaccgttctcagttcggattgtaggctgcaactcgcctacatgaagctgga

SEQ ID NO: 26 - DNA, 1236 bp, Bacillus aerius
  source 1..1236: mol_type = other DNA
tgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctgga

SEQ ID NO: 27 - DNA, 1000 bp, unidentified
  source 1..1000: mol_type = other DNA
ggttcaaacataaaaaggtggcttcggctaccacttacagatggacccgcggcgcattagctagttggtgaggtaatggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcaaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccgatgacaaaccggaggaaagtggg

SEQ ID NO: 28 - DNA, 1302 bp, Frigoribacterium endophyticum
  source 1..1302: mol_type = other DNA
tcatggctcaggacgaacgctggcggcgtgcttaacacatgcaagtcgaacgatgaactccagcttgctggggggattagtggcgaacgggtgagtaacacgtgagtaacctgcccttgactctgggataagcgctggaaacggcgtctaataccggatacgagcttcagccgcatggctaggagttggaaagaatttcggtcaaggatggactcgcggcctatcagcttgttggtgaggtaatggctcaccaaggcgacgacgggtagccggcctgagagggtgaccggccacactgggactgagacacggcccagactcctacgggaggcagcagtggggaatattgcacaatgggcgaaagcctgatgcagcaacgccgcgtgagggatgacggccttcgggttgtaaacctcttttagtagggaagaagcgaaagtgacggtacctgcagaaaaagcaccggctaactacgtgccagcagccgcggtaatacgtagggtgcaagcgttgtccggaattattgggcgtaaagagctcgtaggcggtttgtcgcgtctgctgtgaaatctgggggctcaacccccagcctgcagtgggtacgggcagactagagtgcggtaggggagattggaattcctggtgtagcggtggaatgcgcagatatcaggaggaacaccgatggcgaaggcagatctctgggccgtaactgacgctgaggagcgaaagcgtggggagcgaacaggattagataccctggtagtccacgccgtaaacgttgggaactagatgtggggaccattccacggtctccgtgtcgcagctaacgcattaagttccccgcctggggagtacggccgcaaggctaaaactcaaaggaattgacgggggcccgcacaagcggcggagcatgcggattaattcgatgcaacgcgaagaaccttaccaaggcttgacatataccggaaacggccagagatggtcgccccgcaaggtcggtatacaggtggtgcatggttgtcgtcagctcgtgtcgtgagatgttgggttaagtcccgcaacgagcgcaaccctcgttctatgttgccagcacgttatggtgggaactcataggagactgccggggtcaactcggaggaaggtggggatgacgtcaaatcatcatgccccttatgtcttgggcttcacgcatgctacaatggccggtacaaagggctgcgataccgtaaggtggagcgaatcccaaaaagccggtctcagttcggattggggtctgcaactcgaccccatgaagtcggagtc

SEQ ID NO: 29 - DNA, 1239 bp, Pseudomonas koreensis
  source 1..1239: mol_type = other DNA
gagtaatgcctaggaatctgcctggtagtgggggacaacgtttcgaaaggaacgctaataccgcatacgtcctacgggagaaagcaggggaccttcgggccttgcgctatcagatgagcctaggtcggattagctagttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggttcgttaagttggatgtgaaatccccgggctcaacctgggaactgcatccaaaactggcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttccagagatggattggtgccttcgggagcattgagacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggagtcgctagtatcc

SEQ ID NO: 30 - DNA, 1392 bp, Bacillus stratosphericus
  source 1..1392: mol_type = other DNA
aatacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctggagtcgctagtatcgcagatcagcatgccgcggtgaatacgttcccgggccttgtacacaccgcccgtcacaccacgagagtttgcaacacccgaagt

SEQ ID NO: 31 - DNA, 1176 bp, Bacillus stratosphericus
  source 1..1176: mol_type = other DNA
tgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctca

SEQ ID NO: 32 - DNA, 1295 bp, Bacillus stratosphericus
  source 1..1295: mol_type = other DNA
aatacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacgtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctgga

SEQ ID NO: 33 - DNA, 1293 bp, unidentified
  source 1..1293: mol_type = other DNA
tacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcaagagtaactgcttgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccacaaatctgttctcagttcggatcgcagtctgcaactcgactgcgtgaagctgg

SEQ ID NO: 34 - DNA, 1268 bp, Bacillus nakamurai
  source 1..1268: mol_type = other DNA
gatgttagcggcggacgggtgagtaacacgtgggtaacctgcctgtaagactgggataactccgggaaaccggggctaataccggatgcttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcgaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtatc

SEQ ID NO: 35 - DNA, 1322 bp, Priestia megaterium
  source 1..1322: mol_type = other DNA
aatacatgcaagtcgagcgaactgattagaagcttgcttctatgacgttagcggcggacgggtgagtaacacgtgggcaacctgcctgtaagactgggataacttcgggaaaccgaagctaataccggataggatcttctccttcatgggagatgattgaaagatggtttcggctatcacttacagatgggcccgcggtgcattagctagttggtgaggtaacggctcaccaaggcaacgatgcatagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtacaagagtaactgcttgtaccttgacggtacctaaccagaaagccacggctaactacgtgccagcagccgcggtaatacgtaggtggcaagcgttatccggaattattgggcgtaaagcgcgcgcaggcggtttcttaagtctgatgtgaaagcccacggctcaaccgtggagggtcattggaaactggggaacttgagtgcagaagagaaaagcggaattccacgtgtagcggtgaaatgcgtagagatgtggaggaacaccagtggcgaaggcggctttttggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaactctagagatagagcgttccccttcgggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggatggtacaaagggctgcaagaccgcgaggtcaagccaatcccataaaaccattctcagttcggattgtaggctgcaactcgcctacatgaagctggagtcgctagtatcgccagatcag

SEQ ID NO: 36 - DNA, 1256 bp, Bacillus subtilis
  source 1..1256: mol_type = other DNA
gatgttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctgga

SEQ ID NO: 37 - DNA, 1225 bp, Bacillus safensis
  source 1..1225: mol_type = other DNA
atgttagcggcggacgggtgagtaacacgtgggtaactgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcaagaccgcaaggtttagccaatcccataaatctgttctcagttcggatcgca

SEQ ID NO: 38 - DNA, 1227 bp, Pantoea agglomerans
  source 1..1227: mol_type = other DNA
agcacagagagcttgctctcgggtgacgagtggcggacgggtgagtaatgtctggggatctgcccgatagagggggataaccactggaaacggtggctaataccgcataacgtcgcaagaccaaagagggggaccttcgggcctctcactatcggatgaacccagatgggattagctagtaggcggggtaacggcccacctaggcgacgatccctagctggtctgagaggatgaccagccacactggaactgagacacggtccagactcctacgggaggcagcagtggggaatattgcacaatgggcgcaagcctgatgcagccatgccgcgtgtatgaagaaggccttcgggttgtaaagtactttcagcggggaggaaggcgatgtggttaataaccgcgtcgattgacgttacccgcagaagaagcaccggctaactccgtgccagcagccgcggtaatacggagggtgcaagcgttaatcggaattactgggcgtaaagcgcacgcaggcggtctgttaagtcagatgtgaaatccccgggcttaacctgggaactgcatttgaaactggcaggcttgagtctcgtagaggggggtagaattccaggtgtagcggtgaaatgcgtagagatctggaggaataccggtggcgaaggcggccccctggacgaagactgacgctcaggtgcgaaagcgtggggagcaaacaggattagataccctggtagtccacgccgtaaacgatgtcgacttggaggttgttcccttgaggagtggcttccggagctaacgcgttaagtcgaccgcctggggagtacggccgcaaggttaaaactcaaatgaattgacgggggcccgcacaagcggtggagcatgtggtttaattcgatgcaacgcgaagaaccttacctactcttgacatccacggaatttggcagagatgccttagtgccttcgggaaccgtgagacaggtgctgcatggctgtcgtcagctcgtgttgtgaaatgttgggttaagtcccgcaacgagcgcaacccttatcctttgttgccagcgattcggtcgggaactcaaaggagactgccggtgataaaccggaggaaggtggggatgacgtcaagtcatcatggcccttacgagtagggctacacacgtgctacaatggcgcatacaaagagaagcgacctcgcgagagcaagcggacctcataaagtgcgtcgta

SEQ ID NO: 39 - DNA, 1030 bp, Arthrobacter silviterrae
  source 1..1030: mol_type = other DNA
tcgcggcctatcagcttgttggtggggtaatggcctaccaaggcgacgacgggtagccggcctgagagggtgaccggccacactgggactgagacacggcccagactcctacgggaggcagcagtggggaatattgcacaatgggcggaagcctgatgcagcgacgccgcgtgagggatgacggccttcgggttgtaaacctctttcagtagggaacaaggccatacgttgtgtggttgagggtacttgcagaagaagcgccggctaactacgtgccagcagccgcggtaataagtagggcgcaagcgttatccggaattattgggcgtaaagagctcgtaggcggtttgtcgcgtctgccgtgaaagtccggggctcaactccggatctgcggtgggtacgggcagactagagtgcagtaggggagactggaattcctggtgtagcggtgaaatgcgcagatatcaggaggaacaccgatggcgaaggcaggtctctgggctgtaactgacgctgaggagcgaaagcatggggagcgaacaggattagataccctggtagtccatgccgtaaacgttgggcactaggtgtgggggacattccacgttttccgcgccgtagctaacgcattaagtgccccgcctggggagtacggccgcaaggctaaaactcaaaggaattgacgggggcccgcacaagcggcggaacatgcggattaattcgatgcaacgcgaagaaccttaccaaggcttgacatgaaccggatcggcctggaaacaggtcttccacttgtggctggtttacaggtggtgcatggttgtcgtcagctcgtgtcgtgagatgttgggttaagtcccgcaacgagcgcaaccctcgttccatgttgccagcgggttatgccggggactcatgggagactgccggggtcaactcggaggaaggtggggacgacgtcaaatcatcatgccccttatgtcttggggcttcacgcatgctacaatggccggtacaaagggttgcgatactgtga

SEQ ID NO: 40 - DNA, 1156 bp, Bacillus safensis
  source 1..1156: mol_type = other DNA
ggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcaagaccgcaaggtttagccaatcccataaatctgttctcagttcggatcgca

SEQ ID NO: 41 - DNA, 1295 bp, Pseudarthrobacter siccitolerans
  source 1..1295: mol_type = other DNA
tggctcaggatgaacgctggcggcgtgcttaacacatgcaagtcgaacgatgatccggtgcttgcgccggggattagtggcgaacgggtgagtaacacgtgagtaacctgcccttaactctgggataagcctgggaaactgggtctaataccggatatgactgatcatcgcatggtggttggtggaaagctttttgtggttttggatggactcgcggcctatcagcttgttggtgaggtaatggcttaccaaggcgacgacgggtagccggcctgagagggtgaccggccacactgggactgagacacggcccagactcctacgggaggcagcagtggggaatattgcacaatgggcgcaagcctgatgcagcgacgccgcgtgagggatgacggccttcgggttgtaaacctctttcagtagggaagaagcgaaagtgacggtacctgcagaagaagcgccggctaactacgtgccagcagccgcggtaatacgtagggcgcaagcgttatccggaattattgggcgtaaagagctcgtaggcggtttgtcgcgtctgccgtgaaagtccggggctcaactccggatctgcggtgggtacgggcagactagagtgatgtaggggagactggaattcctggtgtagcggtgaaatgcgcagatatcaggaggaacaccgatggcgaaggcaggtctctgggcattaactgacgctgaggagcgaaagcatggggagcgaacaggattagataccctggtagtccatgccgtaaacgttgggcactaggtgtgggggacattccacgttttccgcgccgtagctaacgcattaagtgccccgcctggggagtacggccgcaaggctaaaactcaaaggaattgacgggggcccgcacaagcggcggagcatgcggattaattcgatgcaacgcgaagaaccttaccaaggcttgacatgaaccggaaagacctggaaacaggtgccccgcttgcggtcggtttacaggtggtgcatggttgtcgtcagctcgtgtcgtgagatgttgggttaagtcccgcaacgagcgcaaccctcgttctatgttgccagcacgtgatggtggggactcataggagactgccggggtcaactcggaggaaggtggggacgacgtcaaatcatcatgccccttatgtcttgggcttcacgcatgctacaatggccggtacaaagggttgcgatactgtgaggtggagctaatcccaaaaagccggtctcagttcggattggggtctgcaactcgaccccatgaagt

SEQ ID NO: 42 - DNA, 1167 bp, Neobacillus drentensis
  source 1..1167: mol_type = other DNA
cttttcctcacatgaggaaaagctgaaagtcggcctctcgctgacacttacagatgggcccgcggcgcattagctagttggtgaggtaacggctcaccaaggcgacgatgcgtagccgacctgagagggtgatcggccacactgggactgagacacggcccagactcctacgggaggcagcagtagggaatcttccacaatggacgaaagtctgatggagcaacgccgcgtgagcgatgaaggccttcgggtcgtaaagctctgttgttagggaagaacaagtaccggagtaactgccggtaccttgacggtacctaaccagaaagccacggctaactacgtgccagcagccgcggtaatacgtaggtggcaagcgttgtccggaattattgggcgtaaagcgcgcgcaggcggtcctttaagtctgatgtgaaagcccacggctcaaccgtggagggtcattggaaactgggggacttgagtgcagaagaggaaagcggaattccacgtgtagcggtgaaatgcgtagagatgtggaggaacaccagtggcgaaggcggctttctggtctgtaactgacgctgaggcgcgaaagcgtggggagcaaacaggattagataccctggtagtccacgccgtaaacgatgagtgctaagtgttagggggtttccgccccttagtgctgcagctaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgacactcctagagataggacgttccccttcgggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggatggtacaaagggctgcaagaccgcgaggtttagccaatcccataaaaccattctcagttcggattgcaggctgcaactcgcctgcatgaagccgga

SEQ ID NO: 43 - DNA, 1300 bp, Bacillus wiedmannii
  source 1..1300: mol_type = other DNA
gtcgagcgaatggattaagagcttgctcttatgaagttagcggcggacgggtgagtaacacgtgggtaacctgcccataagactgggataactccgggaaaccggggctaataccggataacattttgaactgcatggttcgaaattgaaaggcggcttcggctgtcacttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaacccttgatcttagttgccatcattaagttgggcactctaaggtgactgccggtgacaaaccggaggaaggtggggatgacgtcaaatcatcatgccccttatgacctgggctacacacgtgctacaatggacggtacaaagagctgcaagaccgcgaggtggagctaatctcataaaaccgttctcagttcggattgtaggctgcaactcgcctacatgaagctggaatcgctagtatc

SEQ ID NO: 44 - DNA, 1310 bp, Priestia aryabhattai
  source 1..1310: mol_type = other DNA
aatacatgcaagtcgagcgaactgattagaagcttgcttctatgacgttagcggcggacgggtgagtaacacgtgggcaacctgcctgtaagactgggataacttcgggaaaccgaagctaataccggataggatcttctccttcatgggagatgattgaaagatggtttcggctatcacttacagatgggcccgcggtgcattagctagttggtgaggtaacggctcaccaaggcaacgatgcatagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtacgagagtaactgctcgtaccttgacggtacctaaccagaaagccacggctaactacgtgccagcagccgcggtaatacgtaggtggcaagcgttatccggaattattgggcgtaaagcgcgcgcaggcggtttcttaagtctgatgtgaaagcccacggctcaaccgtggagggtcattggaaactggggaacttgagtgcagaagagaaaagcggaattccacgtgtagcggtgaaatgcgtagagatgtggaggaacaccagtggcgaaggcggctttttggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaactctagagatagagcgttccccttcgggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggatggtacaaagggctgcaagaccgcgaggtcaagccaatcccataaaaccattctcagttcggattgtaggctgcaactcgcctacatgaagctggagtcgctagta

SEQ ID NO: 45 - DNA, 1341 bp, Bacillus safensis
  source 1..1341: mol_type = other DNA
tcaggacgaacgctggcggcgtgctaatacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggctgcaagaccgcaaggtttagccaatcccataaatctgttctcagttcggatcgcagtctgcaactcgactgcgtgaagctggagtcgctagtatcggcagatc

SEQ ID NO: 46 - DNA, 1271 bp, unidentified
  source 1..1271: mol_type = other DNA
ttatgaagttagcggcggacgggtgagtaacacgtgggtaacctgcccataagactgggataactccgggaaaccggggctaataccggataacattttgaaccgcatggttcgaaattgaaaggcggcttcggctgtcacttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaacccttgatcttagttgccatcattaagttgggcactctaaggtgactgccggtgacaaaccggaggaaggtggggatgacgtcaaatcatcatgccccttatgacctgggctacacacgtgctacaatggacggtacaaagagctgcaagaccgcgaggtggagctaatctcataaaaccgttctcagttcggattgtaggctgcaactcgcctacatgaagctggagtcgctagtat

SEQ ID NO: 47 - DNA, 1232 bp, Neobacillus niacini
  source 1..1232: mol_type = other DNA
acacgtgggcaacctgcctgtaagactgggataacttcgggaaaccggagctaataccggataatccttttcctctcatgaggaaaagctgaaagtcggtttcggctgacacttacagatgggcccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagcgatgaaggccttcgggtcgtaaagctctgttgttagggaagaacaagtatcggagtaactgccggtaccttgacggtacctaaccagaaagccacggctaactacgtgccagcagccgcggtaatacgtaggtggcaagcgttgtccggaattattgggcgtaaagcgcgcgcaggcggtcctttaagtctgatgtgaaagcccacggctcaaccgtggagggtcattggaaactgggggacttgagtgcagaagaggaaagcggaattccacgtgtagcggtgaaatgcgtagagatgtggaggaacaccagtggcgaaggcggctttctggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgacactcctagagataggactttccccttcgggggacagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggatggtacaaagggctgcgaaaccgcgaggtttagccaatcccataaaaccattctcagttcggattgtaggctgcaactcgcctacatgaagccgga

SEQ ID NO: 48 - DNA, 1525 bp, Streptomyces eurythermus
  source 1..1525: mol_type = other DNA
acggagagtttgatcctggctcaggacgaacgctggcggcgtgcttaacacatgcaagtcgaacgatgaacctccttcgggaggggattagtggcgaacgggtgagtaacacgtgggcaatctgccctgcactctgggacaagccctggaaacggggtctaataccggatacgacacgctcaggcatctgatgcgtgtggaaagctccggcggtgcaggatgagcccgcggcctatcagcttgttggtgaggtaacggctcaccaaggcgacgacgggtagccggcctgagagggcgaccggccacactgggactgagacacggcccagactcctacgggaggcagcagtggggaatattgcacaatgggcgcaagcctgatgcagcgacgccgcgtgagggatgacggccttcgggttgtaaacctctttcagcagggaagaagcgaaagtgacggtacctgcagaagaagcgccggctaactacgtgccagcagccgcggtaatacgtagggcgcaagcgttgtccggaattattgggcgtaaagagctcgtaggcggcttgtcgcgtcggttgtgaaagcccggggcttaaccccgggtctgcagtcgatacgggcaggctagagttcggtaggggagatcggaattcctggtgtagcggtgaaatgcgcagatatcaggaggaacaccggtggcgaaggcggatctctgggccgatactgacgctgaggagcgaaagcgtggggagcgaacaggattagataccctggtagtccacgccgtaaacggtgggcactaggtgtgggcaacattccacgttgtccgtgccgcagctaacgcattaagtgccccgcctggggagtacggccgcaaggctaaaactcaaaggaattgacgggggcccgcacaagcggcggagcatgtggcttaattcgacgcaacgcgaagaaccttaccaaggcttgacatacaccggaaacatccagagatgggtgcccccttgtggtcggtgtacaggtggtgcatggctgtcgtcagctcgtgtcgtgagatgttgggttaagtcccgcaacgagcgcaacccttgtcccgtgttgccagcaggcccttgtggtgctggggactcacgggagaccgccggggtcaactcggaggaaggtggggacgacgtcaagtcatcatgccccttatgtcttgggctgcacacgtgctacaatggccggtacaatgagctgcgataccgtgaggtggagcgaatctcaaaaagccggtctcagttcggattggggtctgcaactcgaccccatgaagtcggagtcgctagtaatcgcagatcagcattgctgcggtgaatacgttcccgggccttgtacacaccgcccgtcacgtcacgaaagtcggtaacacccgaagccggtggcccaaccccttgtgggagggagctgtcgaaggtgggactggcgattgggacgaagtcgtaacaaggtagccgtaccggaaggtgcggctggatcacctccttt

SEQ ID NO: 49 - DNA, 1079 bp, unidentified
  source 1..1079: mol_type = other DNA
ttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaacccttgatcttagttgccatcattaagttgggcactctaaggtgactgccggtgacaaaccggaggaaggtggggatgacgtcaaatcatcatgccccttatgacctgggctacacacgtgctacaatggacggtacaaagagctgcaagaccgcgaggtggagctaatctcataaaaccgttctca

SEQ ID NO: 50 - DNA, 1299 bp, Bacillus proteolyticus
  source 1..1299: mol_type = other DNA
aatacatgcaagtcgagcgaatggattaagagcttgctcttatgaagttagcggcggacgggtgagtaacacgtgggtaacctgcccataagactgggataactccgggaaaccggggctaataccggataacattttgaactgcatggttcgaaattgaaaggcggcttcggctgtcacttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagtacggccgcaaggctgaaactcaaaggaattgacgggggcccgcacaagcggtggagcatgtggtttaattcgaagcaacgcgaagaaccttaccaggtcttgacatcctctgaaaaccctagagatagggcttctccttcgggagcagagtgacaggtggtgcatggttgtcgtcagctcgtgtcgtgagatgttgggttaagtcccgcaacgagcgcaacccttgatcttagttgccatcattaagttgggcactctaaggtgactgccggtgacaaaccggaggaaggtggggatgacgtcaaatcatcatgccccttatgacctgggctacacacgtgctacaatggacggtacaaagagctgcaagaccgcgaggtggagctaatctcataaaaccgttctcagttcggattgtaggctgcaactcgcctacatgaagctgga

SEQ ID NO: 51 - DNA, 1049 bp, Arthrobacter pokkalii
  source 1..1049: mol_type = other DNA
tcagcttgttggtggggtaatggcctaccaaggcgacgacgggtagccggcctgagagggtgaccggccacactgggactgagacacggcccagactcctacgggaggcagcagtggggaatattgcacaatgggcgcaagcctgatgcagcgacgccgcgtgagggatgacggccttcgggttgtaaacctctttcagtagggaagaagcgaaagtgacggtacctgcagaagaagcgccggctaactacgtgccagcagccgcggtaatacgtagggcgcaagcgttatccggaattattgggcgtaaagagctcgtaggcggtttgtcgcgtctgccgtgaaagtccggggctcaactccggatctgcggtgggtacgggcagactagagtgatgtaggggagactggaattcctggtgtagcggtgaaatgcgcagatatcaggaggaacaccgatggcgaaggcaggtctctgggcattaactgacgctgaggagcgaaagcatggggagcgaacaggattagataccctggtagtccatgccgtaaacgttgggcactaggtgtgggggacattccacgttttccgcgccgtagctaacgcattaagtgccccgcctggggagtacggccgcaaggctaaaactcaaaggaattgacgggggcccgcacaagcggcggagcatgcggattaattcgatgcaacgcgaagaaccttaccaaggcttgacatgaaccagaccgccgcagaaatgtggtttcccctttggggttggtttacaggtggtgcatggttgtcgtcagctcgtgtcgtgagatgttgggttaagtcccgcaacgagcgcaaccctcgttctatgttgccagcacgtgatggtggggactcataggagactgccggggtcaactcggaggaaggtggggacgacgtcaaatcatcatgccccttatgtcttgggcttcacgcatgctacaatggccggtacaaagggttgcgatactgtgaggtggagctaatcccaaaaagccggtctcagttcggattg

SEQ ID NO: 52 - DNA, 1256 bp, Bacillus tequilensis
  source 1..1256: mol_type = other DNA
gatgttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaatggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctgga

SEQ ID NO: 53 - DNA, 1305 bp, Bacillus pumilus
  source 1..1305: mol_type = other DNA
taatacatgcaagtcgagcgaacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccataaatctgttctcagttcggatcgcagtctgcaactcgactgcgtgaagctggagtcgctag

SEQ ID NO: 54 - DNA, 1259 bp, Brevibacillus laterosporus
  source 1..1259: mol_type = other DNA
ttcggaccctagcggcggacgggtgagtaacacgtaggcaacctgcctgtaagactgggataacatagggaaacttatgctaataccggatagggttttgcttcgcctgaagcgaaacggaaagatggcgcaagctatcacttacagatgggcctgcggcgcattagctagttggtgaggtaatggctcaccaaggcgacgatgcgtagccgacctgagagggtgaccggccacactgggactgagacacggcccagactcctacgggaggcagcagtagggaattttccacaatggacgaaagtctgatggagcaacgccgcgtgaacgatgaaggctttcgggtcgtaaagttctgttgttagggaagaaacagtgctatttaaataaggtagcaccttgacggtacctaacgagaaagccacggctaactacgtgccagcagccgcggtaatacgtaggtggcaagcgttgtccggaattattgggcgtaaagcgcgcgcaggtggctatgtaagtctgatgttaaagcccgaggctcaacctcggttcgcattggaaactgtgtagcttgagtgcaggagaggaaagtggtattccacgtgtagcggtgaaatgcgtagagatgtggaggaacaccagtggcgaaggcgactttctggcctgtaactgacactgaggcgcgaaagcgtggggagcaaacaggattagataccctggtagtccacgccgtaaacgatgagtgctaggtgttaggggtttcaatacccttagtgccgcagctaacgcaataagcactccgcctggggagtacgctcgcaagagtgaaactcaaaggaattgacgggggcccgcacaagcggtggagcatgtggtttaattcgaagcaacgcgaagaaccttaccaggtcttgacatcccactgaccgctctagagatagagcttcccttcggggcagtggtgacaggtggtgcatggttgtcgtcagctcgtgtcgtgagatgttgggttaagtcccgcaacgagcgcaacccttatctttagttgccagcattcagttgggcactctagagagactgccgtcgacaagacggaggaaggcggggatgacgtcaaatcatcatgccccttatgacctgggctacacacgtgctacaatggttggtacaacgggatgctacttcgcgagaagatgctaatctcttaaaaccaatctcagttcggattgtaggctgcaactcgcctacatgaagtcgga

SEQ ID NO: 55 - DNA, 1309 bp, Bacillus pumilus
  source 1..1309: mol_type = other DNA
aatacatgcaagtcgagcgaacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccataaatctgttctcagttcggatcgcagtctgcaactcgactgcgtgaagctggagtcgctagtatcc

SEQ ID NO: 56 - DNA, 1299 bp, Staphylococcus epidermis
  source 1..1299: mol_type = other DNA
tatacatgcaagtcgagcgaacagacgaggagcttgctcctctgacgttagcggcggacgggtgagtaacacgtggataacctacctataagactgggataacttcgggaaaccggagctaataccggataatatattgaaccgcatggttcaatagtgaaagacggttttgctgtcacttatagatggatccgcgccgcattagctagttggtaaggtaacggcttaccaaggcaacgatgcgtagccgacctgagagggtgatcggccacactggaactgagacacggtccagactcctacgggaggcagcagtagggaatcttccgcaatgggcgaaagcctgacggagcaacgccgcgtgagtgatgaaggtcttcggatcgtaaaactctgttattagggaagaacaaatgtgtaagtaactatgcacgtcttgacggtacctaatcagaaagccacggctaactacgtgccagcagccgcggtaatacgtaggtggcaagcgttatccggaattattgggcgtaaagcgcgcgtaggcggttttttaagtctgatgtgaaagcccacggctcaaccgtggagggtcattggaaactggaaaacttgagtgcagaagaggaaagtggaattccatgtgtagcggtgaaatgcgcagagatatggaggaacaccagtggcgaaggcgactttctggtctgtaactgacgctgatgtgcgaaagcgtggggatcaaacaggattagataccctggtagtccacgccgtaaacgatgagtgctaagtgttagggggtttccgccccttagtgctgcagctaacgcattaagcactccgcctggggagtacgaccgcaaggttgaaactcaaaggaattgacggggacccgcacaagcggtggagcatgtggtttaattcgaagcaacgcgaagaaccttaccaaatcttgacatcctctgacccctctagagatagagttttccccttcgggggacagagtgacaggtggtgcatggttgtcgtcagctcgtgtcgtgagatgttgggttaagtcccgcaacgagcgcaacccttaagcttagttgccatcattaagttgggcactctaagttgactgccggtgacaaaccggaggaaggtggggatgacgtcaaatcatcatgccccttatgatttgggctacacacgtgctacaatggacaatacaaagggtagcgaaaccgcgaggtcaagcaaatcccataaagttgttctcagttcggattgtagtctgcaactcgactatatgaagctgga

SEQ ID NO: 57 - DNA, 1308 bp, Bacillus subtilis
  source 1..1308: mol_type = other DNA
aatacatgcaagtcgagcggacagatgggagcttgctcctgatgttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtatc